(19) United States
(12) Patent Application Publication
(10) Pub. No.: US 2015/0317589 A1
(43) Pub. Date: Nov. 5, 2015

(54) FORECASTING SYSTEM USING MACHINE LEARNING AND ENSEMBLE METHODS

(71) Applicant: The Trustees Of Columbia University In The City Of New York, New York, NY (US)

(72) Inventors: Roger N. Anderson, New York, NY (US); Albert Boulanger, New York, NY (US); Leon L. Wu, New York, NY (US); Viabhav Bhandari, New York, NY (US); Somnath Sarkar, New York, NY (US); Ashish Gagneja, Plainsboro, NJ (US)

(21) Appl. No.: 14/707,809

(22) Filed: May 8, 2015

Related U.S. Application Data
(63) Continuation of application No. PCT/US13/69762, filed on Nov. 12, 2013.
(60) Provisional application No. 61/724,714, filed on Nov. 9, 2012.
(60) Provisional application No. 61/755,885, filed on Jan. 23, 2013.

(51) Int. Cl. G06Q 10/06; G06N 7/00; G06N 5/04; G06N 99/00

(52) U.S. Cl. CPC G06Q 10/06315; G06N 99/005; G06N 7/005; G06N 5/04

(57) ABSTRACT

Techniques for determining forecast information for a resource using learning algorithms are disclosed. The techniques can include an ensemble of machine learning algorithms. The techniques can also use latent states to generate training data. The techniques can identify actions for managing the resource based on the forecast information. The resource can include energy usage in buildings, distribution facilities, and resources such as Electric Delivery Vehicles. The resource can also include forecasting package volume for businesses.

### CROSS-REFERENCE TO RELATED APPLICATIONS

This application is a continuation of International Patent Application Serial No. PCT/US13/069762, filed Nov. 12, 2013 and claims priority to U.S. Provisional Application Ser. No. 61/724,714, filed on Nov. 9, 2012 and U.S. Provisional Application Ser. No. 61/755,885, filed on Jan. 23, 2013, which are incorporated herein by reference in their entirety.

### BACKGROUND

The presently disclosed subject matter relates to techniques for management of distribution facilities including forecasting energy usage, vehicle recharge schedules, chargers (Electrical Vehicle Supply Equipment (EVSE)), and associated electric load to improve the efficiency of personnel and equipment and enhance Electric Delivery Vehicle (EDV) recharge schedules. Furthermore, the disclosed subject matter relates to techniques for management of office buildings including forecasting steam consumption usage and electric load usage to improve efficiency of personnel and equipment. Moreover, the disclosed subject matter relates to techniques for forecasting package volume of businesses to improve efficiency of personnel and equipment.

Distribution facilities of all kinds can have complex electrical load profiles, particularly relative office towers, manufacturing facilities, campuses or homes. Distribution facilities can be controlled by the work cycle, which often involves large spikes in electricity usage from industrial sized conveyor belts, fans for circulating clean air while loading and unloading delivery trucks in confined depot settings, and significant nighttime loads. Others can be generally daytime loads with highest loads in the day and lowest loads at night.

The cost of fossil fuels has increased considerably over past decades. Furthermore, the increasing awareness about the environmental impact of burning fossil fuels has generated interest in the search for cleaner and more sustainable sources of energy. The transportation sector relies on fossil fuels for significant energy requirements. Using Electric Delivery Vehicles (EDVs) to replace large fleets of gasoline/diesel engine vehicles, for example those used for public transportation, mail delivery etc. in large urban areas, can improve economics while reducing dependence on fossil fuels for transportation.

Industrial and residential buildings in dense urban environments, including distribution facilities and others often controlled by the work cycle, can use electrical delivery vehicles (EDVs) to move their products and employees more efficiently. Using EDVs on a large scale can necessitate managing the charging activity to avoid increasing the peak electric demand significantly, which, in turn, avoids overloading the existing electric distribution infrastructure. Improved techniques for management of such systems are needed.

### SUMMARY

The disclosed subject matter provides techniques for determining forecast information for a resource. In certain example embodiments, methods include receiving data related to the resource, defining one or more predictor variables from at least a portion of the data, generating the forecast information including optimized learning model parameters based at least in part on the predictor variables, and generating actions based on the forecast information.

In one aspect of the disclosed subject matter, techniques for determining forecast information for a resource are provided. An exemplary method can include providing a scheduler with the forecast information and the actions. The data related to the resource can be received from a database. In an exemplary embodiment, the data related to the resource includes one or more of weather forecast, economic indices, historical electric resource, actual weather data, incoming delivery package volumes, outgoing delivery package volumes, day of the week, or the like.

In another embodiment, the updated data is provided to the database, wherein the updated data includes one or more of building resources data, actual weather data, and Electric Delivery Vehicle (EDV) charging profile data. The generating optimized learning model parameters can include using machine learning and optimization techniques to generate the one or more optimized learning model parameters. The optimization techniques can include one or more of grid search, cross validation, or the like. In one embodiment, the machine learning forecasting models include one or more of Support Vector Machine Regression, neural networks and/or Bayesian additive regression trees, and the like.

In an exemplary embodiment, the forecast information relates to one or more of a building depot's electric resource forecast and a charging electric resource forecast. In another embodiment, determining the forecast information includes generating one or more statistical accuracy parameters. The one or more statistical parameters can include Mean Absolute Percentage Error for resource variability or Mean Squared Error for Electric Vehicles charging.

In one embodiment, data related to the resource is monitored. The monitoring can include determining if the resource is encountering errors, and/or transmitting alerts if the resource is encountering errors. In one embodiment, Support Vector Machine Regression is used to identify predictable electric resource spikes.

In another aspect of the disclosed subject matter, systems for determining forecast information for a distribution facility and one or more electrical delivery vehicles are provided. An example system can include a database to store data related to the resource, a memory, coupled to the database, and at least one processor that accesses the memory to implement any of the aforementioned methods.

The database can include a historical and relational database. In certain embodiments, the system is coupled to an optimizer.

In another aspect of the disclosed subject matter, exemplary methods for determining forecast information for a resource are provided. Certain methods can include receiving data related to the resource, generating the forecast information using an error weighted ensemble method, identifying one or more actions for the resource based at least in part on the forecast information, and providing the forecast information and the one or more actions.

In an exemplary embodiment, the generating of the forecast information can include identifying one or more trends in the data and clustering of the data into one or more clusters using a clustering detection models such as Support Vector Machines (SVM). In one embodiment, the clustering model can include an ensemble of SVM and Gaussian Mixture Model (GMM). In certain embodiments, determining the forecast information further includes assigning one or more weights to each of the one or more forecasting models. The forecasting models can include Hidden Markov Models (HMM), Viterbi, or the like, and, the forecast information and the one or more actions can be provided to a dynamic scheduler. In one embodiment, the forecasting models can include Viterbi states as covariates. In another exemplary embodiment, the exemplary method includes determining latent states from the forecasting models, and/or generating training data using the latent states.

The accompanying drawings, which are incorporated in and constitute part of this specification, are included to illustrate and provide a further understanding of the disclosed subject matter.

### BRIEF DESCRIPTION OF THE DRAWINGS

FIG. 1 illustrates an exemplary machine learning forecast system for a Support Vector Machines (SVM) Regression Model based implementation in accordance with the disclosed subject matter.

FIG. 2 illustrates a Machine Learning Forecasting System (MLFS) in accordance with an exemplary embodiment of the disclosed subject matter.

FIG. 3 is a flow graph of an exemplary method for generating forecast for a load in accordance with the disclosed subject matter.

FIG. 4 depicts an exemplary electric load database for a delivery depot in accordance with an embodiment of the disclosed subject matter.

FIG. 5 is an exemplary selection of covariates for input into a support vector machine regression for building load forecasting in accordance with an embodiment of the disclosed subject matter.

FIG. 6A and FIG. 6B illustrate the difference in prediction with using additional weather covariates for input into a support vector machine regression in accordance with an embodiment of the disclosed subject matter. FIG. 6A illustrates a graph with the humidex as the only weather covariate. FIG. 6B illustrates a graph with the 4 covariates: Atmospheric pressure, wind speed, sky clarity, and humidex.

FIG. 7 is a graph illustrating an exemplary plot of the forecasted load with respect to the actual load in accordance with an embodiment of the disclosed subject matter.

FIG. 8A depicts an exemplary cross-validation method in accordance with the disclosed subject matter.

FIG. 8B is a flowchart that illustrates the cross validation method in accordance with the disclosed subject matter.

FIG. 9A and FIG. 9B illustrate the use of other machine learning algorithms in accordance with an embodiment of the disclosed subject matter.

FIG. 10A, FIG. 10B, FIG. 10C, and FIG. 10D demonstrate the addition of covariates for historical package volumes in connection with the forecasting of packaging volumes from electrical load forecasts in accordance with an embodiment of the disclosed subject matter.

FIG. 11 is a graph of an exemplary method for predicting Electric Vehicle charging in accordance with the disclosed subject matter.

FIG. 12 displays exemplary covariates for input into an Electric Vehicle charging load forecaster in accordance with the disclosed subject matter.

FIG. 13A and FIG. 13B illustrate an exemplary Electric Vehicle charging forecast for an ensemble support vector machine regression model and corresponding MAPE errors when testing against actual data in accordance with the disclosed subject matter.

FIG. 14A is a graph that illustrates an exemplary prediction of a de-seasonalized SVR with respect to a SVR that is not de-seasonalized in accordance with the disclosed subject matter.

FIG. 14B is a graph that illustrates a comparison plot of errors of in a de-seasonalized SVR and an SVR that is not de-seasonalized using Mean Absolute Error (MAE).

FIG. 15 a flow graph of an exemplary method for improving the forecast using ensemble methods and unsupervised learning in accordance with the disclosed subject matter.

FIG. 16 is a 3-D graph that illustrates an experimental plot of the load data plotted against the humidex and the Weekday data in accordance with the disclosed subject matter.

FIG. 17 is a graph that illustrates an experimental plot of the MAPE for the hourly-optimized SVR model in accordance with the disclosed subject matter.

FIG. 18 is a graph illustrating an experimental plot comparing the error measures mean absolute percentage error (MAPE) and symmetric mean absolute percentage error (SMAPE) for the hourly-optimized SVR model in accordance with the disclosed subject matter.

FIG. 19 is a graph that illustrates an experimental plot of the Average Error by Day of the hourly-optimized SVR model in accordance with the disclosed subject matter.

FIG. 20 is a graph that illustrates an experimental plot of the root mean squared error (RMSE) for hourly-optimized SVR model in accordance with the disclosed subject matter.

FIG. 21 is a graph that illustrates an experimental plot of the mean squared error (MSE) for the hourly optimized SVR model in accordance with the disclosed subject matter.

FIG. 22 is a graph that illustrates an experimental plot of the Train Error/Test Error (MSE) with respect to Time-of-the-day for hourly optimized error in accordance with the disclosed subject matter.

FIG. 23 illustrates an example of an elbow plot that is used to identify the optimal number of clusters in accordance with the disclosed subject matter.

FIG. 24 is a 2-D a graph illustrating an experimental plot of the load with respect to humidex in accordance with the disclosed subject matter.

FIG. 25 is a 2-D a graph illustrating an experimental plot of the load with respect to the time of the day (in units of 15 minutes—thus there are 96 in a day) in accordance with the disclosed subject matter.

FIG. 26A is an elbow chart illustrating an experimental plot of the Akaike information criterion (AIC) to the number of clusters in accordance with the disclosed subject matter.

FIG. 26B is an elbow chart illustrating an experimental plot of the Bayesian information criterion (BIC) to the number of clusters in accordance with the disclosed subject matter.

FIG. 27A, FIG. 27B, FIG. 27C, and FIG. 27D are graphs illustrating an experimental plot of the load with respect to humidex and load with respect to Time-of-the-day, using 6 clusters, in accordance with the disclosed subject matter.

FIG. 28A, FIG. 28B, and FIG. 28C are graphs illustrating an experimental plot of the load with respect to Time-of-the-day, where the data are subdivided into 3 sets of two months each, in accordance with the disclosed subject matter.

FIG. 29 is a graph illustrating an experimental plot of the load with respect to the total time period of 6 months, which is color-coded with clusters obtained from fitted HMM model, in accordance with the disclosed subject matter.

FIG. 30 illustrates a graph illustrating an experimental plot of the load with respect to the time of the week in 15 minute intervals, in accordance with the disclosed subject matter.

FIG. 31 is a graph that illustrates an exemplary prediction for a day using HMM model, in accordance with the disclosed subject matter. Time on the X axis is in 15 minute intervals

FIG. 32 is a graph illustrating an experimental plot of the load with respect to the time of the day, for several models in accordance with the disclosed subject matter. Time on the X axis is in 15 minute intervals

FIG. 33A is an elbow chart illustrating an experimental plot of the Akaike information criterion (AIC) with respect to the number of clusters in the data, in accordance with the disclosed subject matter.

FIG. 33B is an elbow chart illustrating an experimental plot of the Bayesian information criterion (BIC) with respect to the number of clusters, in the data in accordance with the disclosed subject matter.

FIG. 34 is a graph color-coded with clusters illustrating an experimental plot of the load with respect to the time, in accordance with the disclosed subject matter.

FIG. 35 is a graph color coded with clusters obtained from the HMM fit illustrating an experimental plot of the load with respect to the time-of-the-day, in accordance with the disclosed subject matter.

FIG. 36 is a graph color coded with clusters obtained from the HMM fit illustrating an experimental plot of the load with respect to the humidex data, in accordance with the disclosed subject matter.

FIG. 37 is a graph that illustrates an experimental comparison plot of predictions from different models used in this exemplary application during the week of Nov. 11, 2012 to Nov. 17, 2012, in the data in accordance with the disclosed subject matter.

FIG. 38 is a graph that illustrates an experimental comparison plot of predictions from different models used in this exemplary application during the week of Nov. 18, 2012 to Nov. 24, 2012, in the data in accordance with the disclosed subject matter.

FIG. 39 is a graph that illustrates an experimental comparison plot of predictions from different models used in this exemplary application during the week of Nov. 25, 2012 to Dec. 1, 2012, in the data in accordance with the disclosed subject matter.

FIG. 40 is a graph that illustrates an experimental comparison plot of MAPE error for the different models from Nov. 11, 2012 to Dec. 1, 2012, in the data in accordance with the disclosed subject matter.

FIG. 41 is a graph that illustrates an experimental comparison plot of MAPE error for the different performing models from Nov. 11, 2012 to Dec. 1, 2012, in the data in accordance with the disclosed subject matter.

FIG. 42A is a graph that illustrates an exemplary plot of the steam load demand during the first two weeks of April 2013.

FIG. 42B is a graph that illustrates an exemplary plot of the humidex during the first two weeks of April 2013.

FIG. 42C is a graph that illustrates an exemplary plot of the steam load demand during weekdays (Monday-Thursday).

FIG. 42D is a graph that illustrates an exemplary plot of the humidex during weekdays (Monday-Thursday).

FIG. 42E is a graph that illustrates an experimental comparison plot of the steam prediction with respect to the actual data.

FIG. 42F is a graph that illustrates an experimental plot of the Root Mean Square Error (RMSE).

FIG. 43 is a graph that illustrates an experimental comparison plot of forecast using a combination of the Hidden Markov model (HMM) and the Support Vector Machine regression (SVR) model vs. SVR and actual.

FIG. 44 is a graph that illustrates an experimental comparison plot of the Mean Average Percent Error (MAPE) of the forecast from SVR model alone and a combination of the HMM and SVR model and the optimal ensemble ML solution.

FIG. 45 is a graph that illustrates an experimental comparison plot of forecast using a combination of the Gradient Boosted Regression Trees (GBR) and HMM model with respect to a SVR and HMM model, a SCR model, a GBR model, and actual data

FIG. 46 is a graph that illustrates an experimental comparison plot of the Mean Average Percent Error (MAPE) of the forecast from SVR model alone, GBR alone, a combination of the HMM and SVR model, and a combination of the GBR and the HMM model and the optimal ensemble ML solution.

FIG. 47A and FIG. 47B are graphs that illustrate an experimental snapshot of the training data on a particular day. FIG. 47A is a graph that illustrates the historical steam load based on latent states on Apr. 4, 2013. FIG. 47B is a graph that illustrates the historical humidex based on latent states on Apr. 4, 2013.

FIG. 48 is a graph that illustrates an experimental comparison plot of the AIC and BIC curves.

FIG. 49 is a graph that illustrates an experimental fitting HMM plotted using 11 hidden states.

FIG. 50 is a graph that illustrates an experimental fitting HMM plotted using 18 hidden states.

FIG. 51 is a graph that illustrates an experimental fitting HMM plotted using 23 hidden states.

FIG. 52 is a graph that illustrates an experimental unrolling the plot so that the full time span of the data is displayed of the 18 hidden states.

FIG. 53A is a graph that illustrates an experimental comparison prediction plot of the SVR model and the models based on the HMM states learned from the days that have similar latent state sequence and actual.

FIG. 53B is a graph that illustrates an experimental comparison error (RMSE) plot of the SVR model and the models based on the HMM states learned from the days that have similar latent state sequence.

FIG. 54 is a graph that illustrates an experimental plot of the actual vs. forecasted humidex during the first two weeks of April 2013.

FIG. 55 is a graph that illustrates an experimental comparison prediction plot of the actual data with respect to the forecast data from a Tree Ensemble model with latent states covariates and an HMM model.

FIG. 56 is a graph that illustrates an experimental comparison error (RMSE) plot of the Tree Ensemble model with latent states covariates and an HMM model.

FIG. 57 is a graph that illustrates an experimental comparison prediction plot of the actual data with respect to the forecast data from a Tree Ensemble and a HMM model an hourly prediction.

FIG. 58 is a graph that illustrates an experimental comparison error (RMSE) plot of the Tree Ensemble model an hourly prediction.

FIG. 59 is a graph that illustrates an experimental comparison prediction plot of the actual data with respect to the forecast data from a Tree Ensemble with latent state covariates and number of day cross-validation.

FIG. 60 is a graph that illustrates an experimental comparison error (RMSE) plot of the Tree Ensemble with latent state covariates and number of day cross-validation.

FIG. 61 is a graph that illustrates an experimental comparison prediction plot of the actual data with respect to the forecast data from a Tree Ensemble with hourly prediction, latent state covariates & HMM.

FIG. 62 is a graph that illustrates an experimental comparison error (RMSE) plot of the Tree Ensemble with hourly prediction, latent state covariates & HMM.

FIG. 63 is a graph that illustrates an experimental fitted HMM plotted using 7 states.

FIG. 64 is a graph that illustrates an experimental plot that is a zoomed in view of FIG. 63 for the first two weeks of April.

FIG. 65 is a graph that illustrates an experimental fitted HMM plotted using 11 states.

FIG. 66 is a graph that illustrates an experimental plot that is a zoomed in view of FIG. 65 for the first two weeks of April.

FIG. 67 is a graph that illustrates an experimental fitted HMM plotted using 22 states.

FIG. 68 is a graph that illustrates an experimental plot that is a zoomed in view of FIG. 67 for the first two weeks of April.

FIG. 69 is a graph that illustrates an experimental comparison elbow plot of the AIC and BIC curves.

FIG. 70 illustrates an exemplary computer system suitable for implementing embodiments of the present disclosure.

### DETAILED DESCRIPTION

The disclosed subject matter provides techniques for management of distribution facilities including the management of electric distribution vehicle charging. The subject matter disclosed herein includes techniques to forecast the energy usage of such distribution facilities and improve efficiency of personnel and equipment, forecast package volumes that drive electricity patterns, forecast electric vehicle recharge schedules, and simulate and predict electric and package volumes for the facility day-ahead, week-ahead and month-ahead.

For purposes of example, and not limitation, the disclosed subject matter can be used in connection with a package delivery facility that routinely processes, e.g., 8000 to 10000 packages per day and that uses Electric Delivery Vehicles (EDVs). The disclosed subject matter can include a feedback loop that scores the statistical accuracy of its predictions so that the system learns from its errors, which are therefore minimized over time. The forecasting system can be built into a commercial battery recharge optimizer so that future expected package volume and weather forecasts can successfully optimize the time windows allocated for EDV recharge. In addition, the system can be used as a simulator, in that it can scale to hundreds of theoretical EDVs at this exemplary facility to identify how electric loads can be predicted and minimized, therefore requiring less new capital equipment from the utility since added supply is no longer expected from the utility as the depot expands from 10% to 100% EDVs in the near future.

Reference will now be made in detail to the various exemplary embodiments of the disclosed subject matter, exemplary embodiments of which are illustrated in the accompanying drawings. The system and corresponding method of the disclosed subject matter will be described in conjunction with the detailed description of the system.

### Machine Learning Forecasting System Architecture

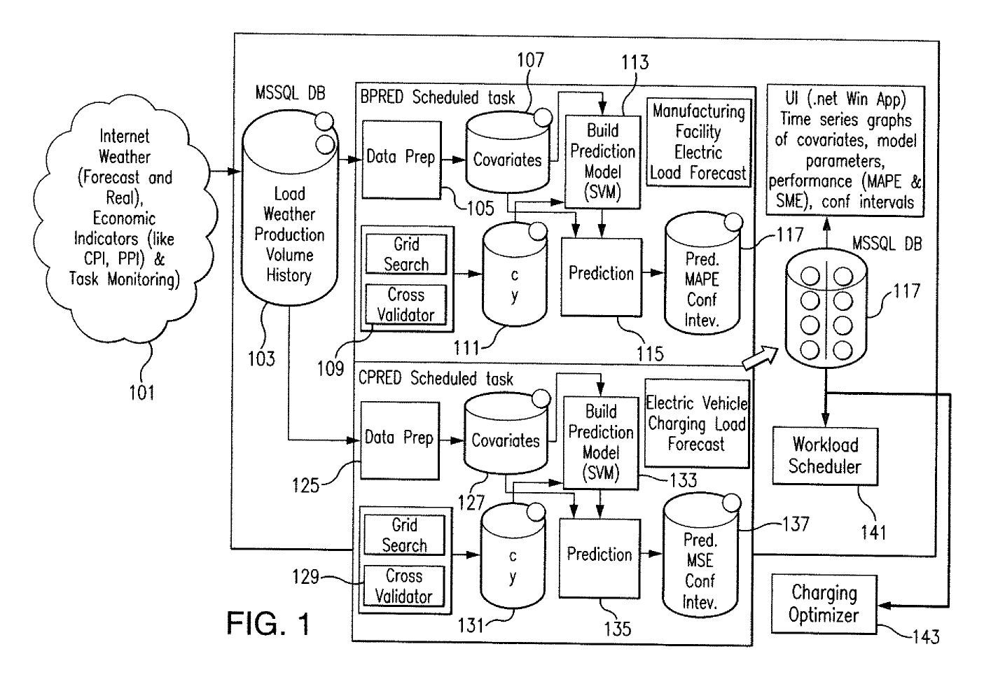

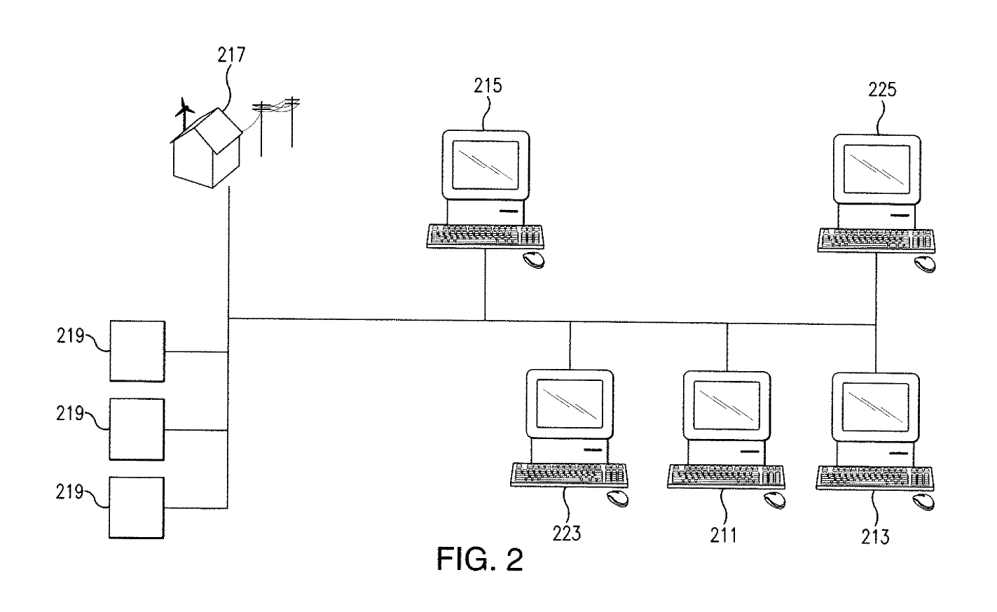

For purpose of illustration, and not limitation, description will now be made to an exemplary embodiment of the MLFS in accordance with the disclosed subject matter. FIG. 1 illustrates an exemplary MLFS. FIG. 2 illustrates the architecture of an exemplary MLFS. With reference to FIG. 1 and FIG. 2, the system can include, but is not limited to, a database 103, a MLFS 213, a workload scheduler 141, a distribution facility 217, and one or more EDVs 219. It is understood that the workload scheduler 141 can include a dynamic scheduler 141. It is also understood that the system can include an optimizer 143 that receives forecast information or actions and manages the load based on the forecast information or actions. The commercial battery recharge optimizer 143 that can optimize the resources, for example the charging of multiple EDVs in a resource constrained center. The system can also include a simulation system 223. The simulation system 223 can demonstrate the effectiveness of the electric vehicles for the fleet, the reliable grid connections, and provides opportunity to evaluate EV use in the fleet delivery applications. The system may also include a control center 225. Generally, the MLFS 213 can predict the usage of a resource, including package volume, electric load, charging load, and the like, using one or more machine learning techniques. For example, the MLFS 213 can forecast building electric load and charging load associated with a distribution facility 217, and the techniques disclosed herein can provide for efficient charging schedules (e.g., such that peak electric load arising from operations does not coincide with peak electric load arising from charging).

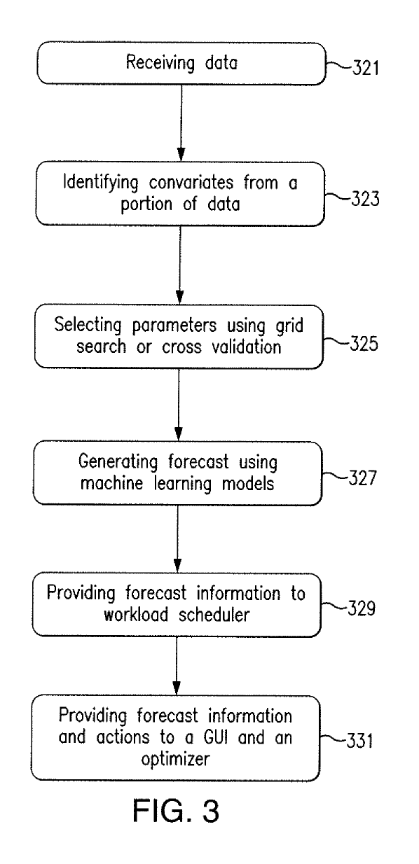

FIG. 3 is a flowchart that illustrates an exemplary method to generate the forecast for a facility 217 and one or more EDVs 219. As disclosed herein, the MLFS 213 can use an ensemble learning algorithms to simultaneously solve for future forecasts such as for package volume, building electric load 115 for a facility 217, and the optimal timing and magnitude of charging 135 for a fleet of EDVs 219.

With reference to FIG. 1A, FIG. 1B, FIG. 2, and FIG. 3, data is gathered into a historical and relational database 103 of information from the internet 101, related to nearby weather forecasts and the latest forecasts for economic indices such as CPI and PPI (321). The data can also include data related to one or more chargers (EVSE). The internet 101 can also monitor task progress and send alerts if the system is encountering computational or hardware trouble. The database 103 can also store historical electric loads, actual weather outcomes, delivery package volumes, both incoming and outgoing. In task 3, the data can be cleaned and prepared as covariates 107, 127 for the Machine Learning (323). It can be understood that covariates 107, 127 can also be known as predictor variables. As seen in FIG. 1A and FIG. 1B, the covariates 107 of an electric load forecast can be different than the covariates 127 of a charging load forecast. In task 4, grid search and cross validation techniques 109, 129 can be used to select the proper c and gamma parameters 111, 132 for the current forecasting conditions (325). It can be understood that the parameters 111, 132 can also be known as optimized learning model parameters. It can be understood that these techniques 109, 129 can also be referred to as optimization techniques. As seen in FIG. 1A and FIG. 1B, the grid search and cross validation techniques 109 of an electric load forecast can be different than the grid search and cross validation techniques 129 of a charging load forecast. As seen in FIG. 1A and FIG. 1B, the proper c and gamma parameters 111 of an electric load forecast can be different than the proper c and gamma parameters 132 of a charging load forecast. In task 5 algorithms, such as Support Vector Machine Regression and other machine learning algorithms 113, 133 can be used to output predictions. It can be understood that these algorithms 113, 133 can also be known as forecasting models. As seen in FIG. 1A and FIG. 1B, the algorithm models of an electric load forecast 113 can be different than the algorithm models 133 of a charging load forecast. The algorithms output predictions for electric load forecast 115 and a charging electric load forecast 135.115(327). In both outputs, statistical parameters, such as the Mean Absolute Percentage Error (MAPE) 117 for load variability and Mean Square Error (MSE) 137 for EDV charging, can be output as well. It can be understood that statistical parameters such as MAPE, MSE, or the like can also be known as error measures. Finally outputs can be entered into the relational database 103 or 117, along with statistics updates, actual weather, building loads, and EDV charging profiles, and time series graphing displays can be created and conveyed to the facility management's workload scheduler 141 along with recommended actions for EDV 219 charging optimization systems (329). In an exemplary embodiment, the final outputs such as the recommended actions and the forecast information can be provided to a GUI, charging optimizer 143, and the workload scheduler (215).

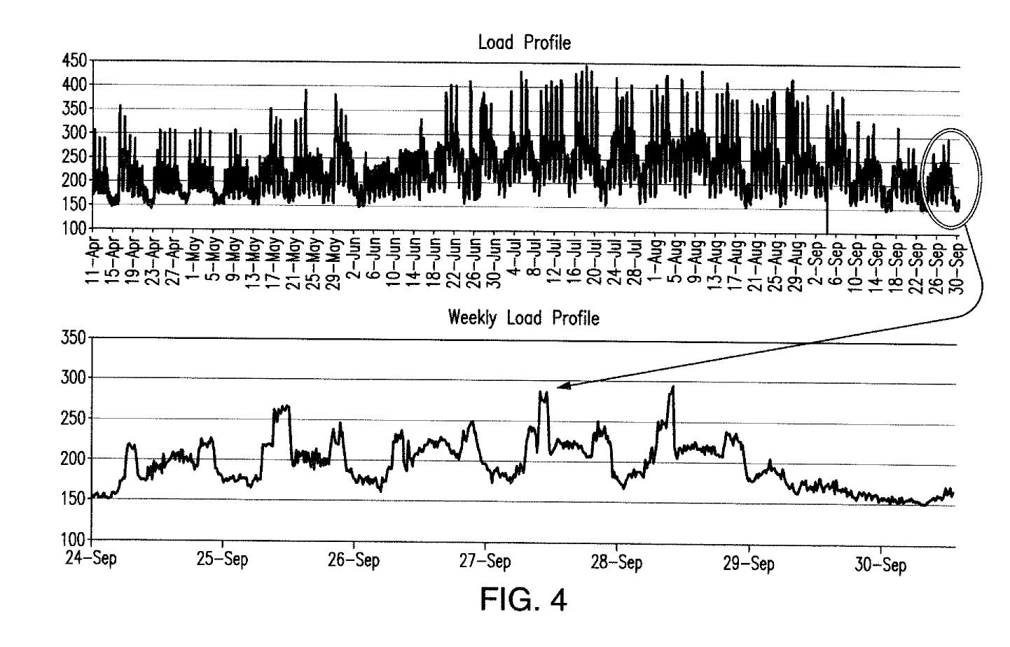

In an exemplary embodiment, concept drift can be accounted for in the MLFS 213 by using an ensemble of ML and statistical algorithms simultaneously. Mean Average Percentage Error (MAPE) can be used to measure the accuracy of predictions and select, for example, the ML building model that is performing better than the others and Mean Squared Error (MSE) for the charging model. The better performing algorithm can be selected, for example, based upon yesterday's forecasting success as judged by statistics sampled at a frequency of every 15 minutes. Furthermore, a calendar of holidays and observed weather data (temperature and dew point—sources such as: Central Park NOAA observation data via the Weather Underground) can be maintained by the database 103. An exemplary electric load database 103 for a delivery depot is presented in FIG. 4.

### Forecasting Using Support Vector Machine Regression

In an exemplary embodiment, a SVM model 113, 133 for building load and the charging load can use 8 or more covariates 107, 127 as data inputs. Since there can be a cyclical component in the load profile covariates 107, 127 such as previous day load, previous week load, previous day average, previous week average, time-of-the-day, and day-of-the-week can be incorporated. Furthermore, to account for the Heating, Ventilation, and Air-conditioning (HVAC) load, a heat index called humidex—a forecast or historical index composite of temperature and dew point—can be included as a covariate. For package volume forecasting, economic indicators such as CPI and/or PPI can be added. As an initial approach to model package volume (as well as aiding in predicting building electrical load), a covariate 107, 127 with discrete sets of values for different kinds of holidays/weekends can be included.

### Covariate Selection

As a measure of the relative importance of each covariate 107, 127, the correlation coefficient of each with the electric load can be computed. Further statistical significance of each covariate 107, 127 can then be measured, taking in account the issue of multi-co-linearity. Table 1 presents an example of correlation coefficients used to measure correlation between covariates 107, 127 and electric load the MLFS 213 is predicting.

TABLE 1

| Covariates | Correlation value with the load value |
|---|---|
| Previous week load | 0.73 |
| Previous day load | 0.68 |
| Previous day average | 0.53 |
| Previous week average | 0.50 |
| Humidex | 0.48 |
| Holiday | 0.34 |
| Hour of the day | 0.17 |
| Day of the week | 0.12 |

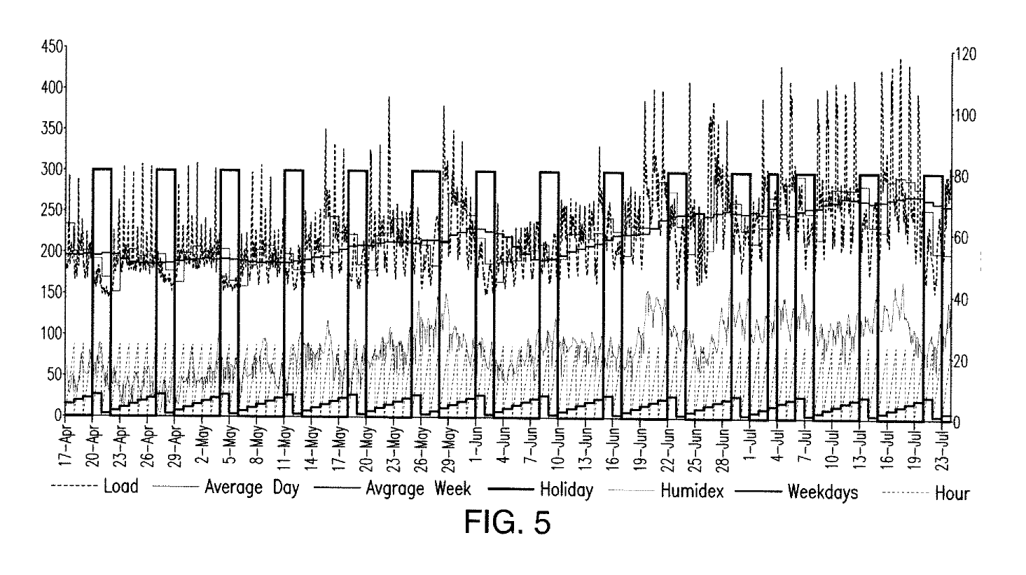

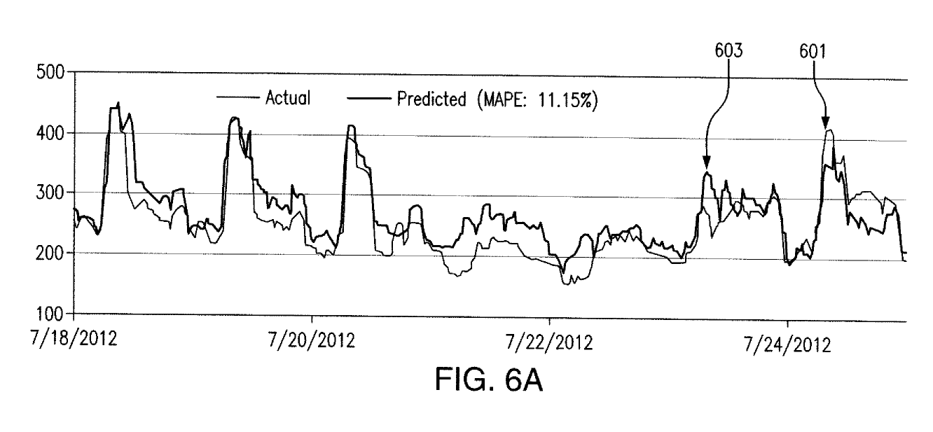

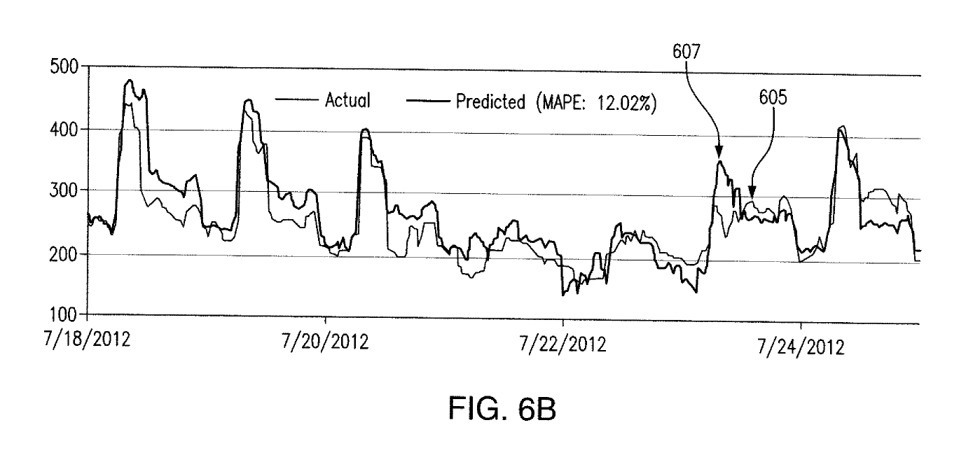

FIG. 5 is an exemplary selection of Covariates 107, 127 for input into the SVR for Building Load Forecasting 115 and charging load forecasting 135. FIG. 5 illustrates an example of covariate 107, 127 selection for input into the SVR 113, 133 for Building Load Forecasting 115. In certain embodiments, additional weather covariates 107, 127 such as atmospheric pressure, sky clarity, and wind speed can be included to account for their effect on load forecasting. However, in an example embodiment, these additional covariates 107, 127 did not improve the predictive capability of the system disclosed herein, as illustrated by example in FIG. 6A, FIG. 6B. FIG. 6A. FIG. 6A, FIG. 6B. FIG. 6A illustrate a graph of an exemplary prediction (603) with the humidex as the only weather covariate 107, 127 with respect to the actual data (601). FIG. 6B illustrates a graph of an exemplary prediction (607) with the 4 covariates 107, 127: Atmospheric pressure, wind speed, sky clarity, and humidex with respect to the actual data (605). In this example, the 4 covariates are used as variable weather parameters for data inputs into the MLFS 213 forecasting module.

### Measure of Error

MAPE is Mean Absolute Percentage Error can be based on the absolute value. As such, under-prediction and over-prediction can be assigned the same error value if both are equidistant from the actual. Other measures such as Mean Square Error, Root Mean Square Error or Mean Absolute Error can also be computed. Accordingly, in certain exemplary embodiments, MAPE 117 can be used as a measure of error to capture the timings of the electrical peak usage and the general building load profile, while Mean Square Error (MSE) 137 can be used in connection with EDV 219 charging load optimization.

### Support Vector Machine Regression

In an exemplary embodiment, a SVM model 113, 133 for building load 115 can use 8 or more covariates 107, 127. Kernels can be used in this exemplary SVM model 113, 133 to project the data into the infinite dimensional feature space, which can improve results. Examples of kernels include, but are not limited to, linear, Radial Basis Function, homogenous or inhomogeneous polynomials, hyperbolic tangents and tree. To capture the unpredictable electrical load spikes, additional SVM learning techniques can be added. The load spikes can be when the electric load often spikes up by more than 100 percent. Load spikes can occur during the operation of, for example, large conveyor belts, exhaust fans (time and duration of occurrence and magnitude) during the busy package volumeing and unloading hours, or the like.

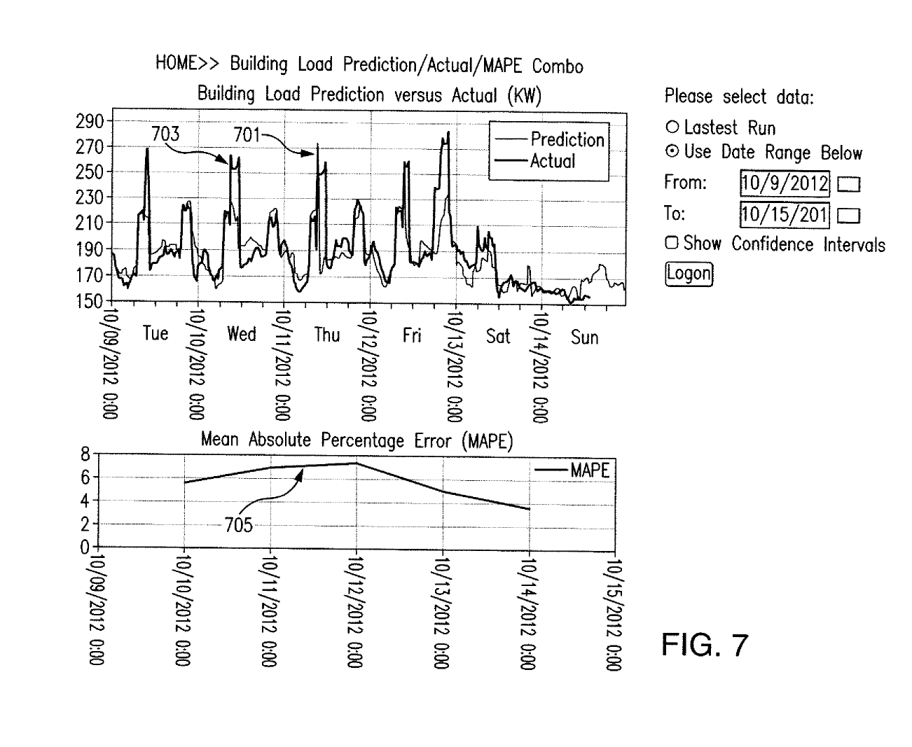

FIG. 7 is a graph illustrating an exemplary plot of the forecasted building load (703) with respect to the actual load (701) and a graph of the corresponding MAPE error measure (705). FIG. 7 further illustrates an exemplary online visualization tool created to view the different SVM regression models.

In an exemplary embodiment, for Distribution Facility 217 electric load prediction 115 and EDV 219 charging prediction 135, SVM can provide a statistically robust model for prediction. SVM can be used both for regression and classification. Using a kernel function, the data can be projected to higher dimensions, where the algorithm finds a linear classifier. For nonlinear regression, the Gaussian Radial Basis function kernel can be versatile since its feature space is a Hilbert space of infinite dimensions. However, the effectiveness of SVM can depend on, for example, the selection of kernel, the kernel's parameters, and soft margin parameter.

Accordingly, in an example embodiment, the additional features disclosed can provide enhanced prediction. For example, grid search points can be exponentially distanced to search for the optimal values quickly. Furthermore, finer search between grid points can also be implemented, but at the cost of increased computational expense. Optimization for error margin c in the disclosed SVM model can also be undertaken in certain embodiments, but such techniques can sometimes not improve the predictions significantly.

In another example, grid search can be a computationally expensive algorithm to discover the optimized values. The effect of ‘Cost’ (c) and ‘Gamma’ on prediction can be more than “Epsilon.” Limited set values for cost and gamma can be explored and default value of epsilon can be used. The use of hourly prediction can substantially reduce the space complexity of the model and lead to faster results. In another example embodiment, the hourly algorithm can be easily parallelized. In certain embodiments, the performance of the hourly model can likely be unaffected by spikes in the electric load of distribution facilities 217 or fleets of EDVs 219.

### Cross Validation

For purposes of illustration, and not limitation, in an exemplary embodiment taking the same set of optimized parameters for the whole day can lead to inferior predictions. As such, an hourly-optimized model can be used. In the hourly-optimized model for example, 24 different SVM models can be formulated corresponding to each hour of the day. In certain embodiments, grid search with exponential distance between the grids can be used to find the optimal values of the parameters in the SVM model. In time series data, a customized cross-validation algorithm can be implemented. The training data can be partitioned into two sets: all available data except the latest week is used to train the SVM model and the “left out” week is used to validate the predictions. The process can be repeated for every week, rolling forward an hour at a time. Minimization of an error metric (such as MAPE for building load, or MSE for charging load) can be used as the objective. For example, in connection with building load, minimizing MAPE can be used as the objective and the MAPE corresponding to each week's predictions can be stored. These MAPE values can then be averaged using exponentially decaying weights with the most recent week receiving the highest weight. The set of parameters corresponding to the minimum average MAPE can be selected as the optimal parameters for that hour. The whole process can be repeated for each hour of the day. These by-hour parameters can then be used to build the prediction model.

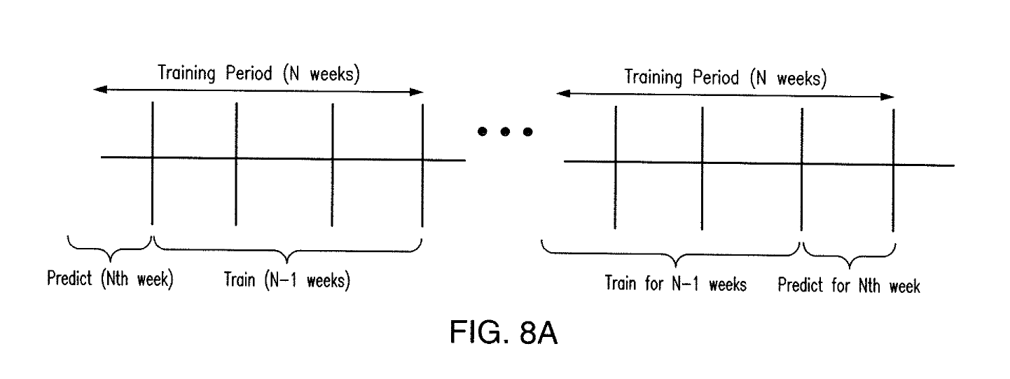

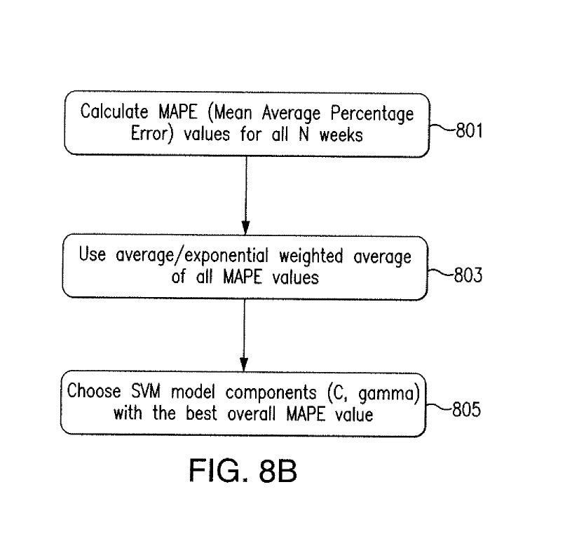

FIG. 8A illustrates an example of the Cross validation method 109, 129 disclosed herein and used in connection with an exemplary embodiment.

As depicted in FIG. 8A, the cross-validator has been designed as a separate module which runs once a day and computes the model parameters which provide, for example, the best prediction on the training data using k-folds methodology. The k for this module is one-week worth of contiguous observed load data, for example a charging load or a building load data. The SVM and Ensemble model builders can run once every 30 minutes and build new models using the optimized learning parameters computed by the most recent run of the cross-validator module.

FIG. 8B is a flowchart that illustrates the cross validation method depicted in FIG. 8A. As illustrated in FIG. 8B, the MAPE values are calculated for all the weeks, for example total N weeks (801). In an example embodiment, the average or the exponential weighted of all MAPE values can be calculated (803). SVM model components, for example cost (c) or gamma parameters, can then be chosen with different MAPE values (805), for example, the best overall MAPE values (805).

### Ensemble of Machine Learning Models

Seasonal changes in workload can exist for Distribution Facilities that also affect EDV charging patterns. In an exemplary embodiment, to continue, for example, accurate forecasting as this concept drift is occurring, the SVM learning algorithm can be supplemented with the simultaneous use of several other statistical algorithms that yield models that predict competing forecasts. In an exemplary embodiment, MAPE can be used from the previous to select the best model for each day. In an exemplary embodiment, the Machine Learning Forecasting Model 213 can run an ensemble of machine learning and statistical models and select the best performing model to use at each forecasting time interval. In another exemplary embodiment, the Machine Learning Forecasting Model 213 can apply a combining rule, such as a majority rule, to select a model.

Some of the exemplary statistical methods that can be used in the ensemble are described below, in connection with building load and charging load prediction, for purpose of illustration and not limitation.

### Neural Network

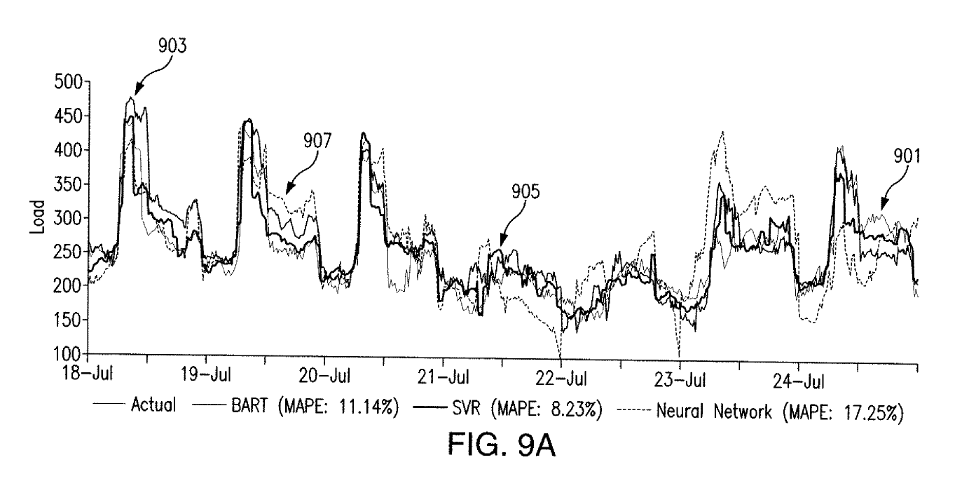

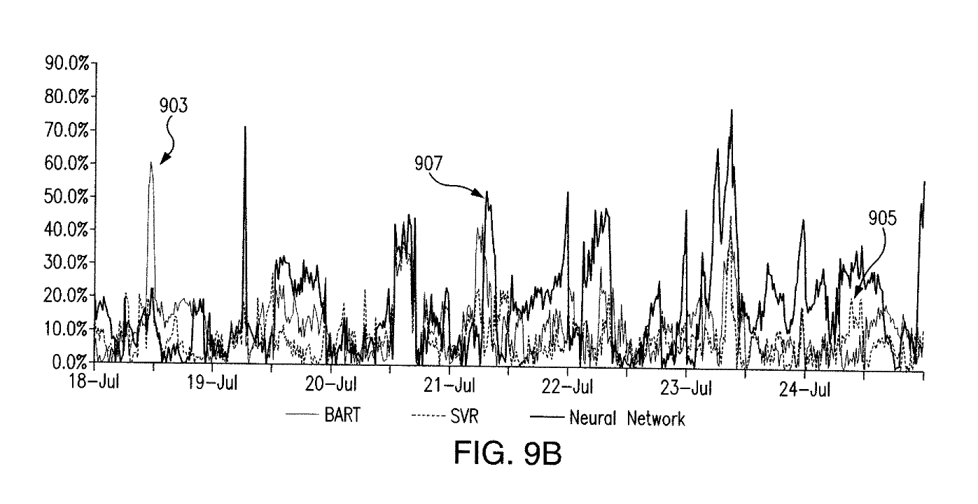

Being much like a black-box model, traditional neural network results can be difficult to analyze. The opaque nature of these networks can make it very hard to determine how a network of neurons is solving the Machine Learning problem. They can be difficult to troubleshoot when they don't forecast well, and when they do work, they can suffer from over-fitting. Neural Networks are compared for purpose of illustration with SVM results in FIG. 9A and FIG. 9B below.

### Bayesian Additive Regression Trees (BART)

BART is a Bayesian ensemble method that can be used to learn a regression relationship between a variable of interest y and p potential predictors x₁, x₂, . . . xₚ. An exemplary MLFS 213 can use BART to model the conditional distribution of y given x by a sum of random basis elements plus a noise distribution. Based on random regression trees, BART can produce a predictive distribution for y at any x (in or out of sample) that automatically adjusts for the uncertainty at each x. In an example embodiment, BART can do this for nonlinear relationships, even those hidden within a large number of irrelevant predictors.

BART's basis is a Regression Tree Model, which uses a decision tree to map observations about an item to conclusions about its target value. Let T denote the tree structure including the decision rules. Let M={μ₁, μ₂, . . . , μ_{b}} denote the set of bottom node μ's. Let g(x; Θ)=(T; M) be a regression tree function that assigns a μ value to x. The BART Model, seen in equation (1) is:

f(x|.)=g(x;T₁,M₁)+g(x;T₂,M₂)+ . . . +g(x;Tₘ,Mₘ)+σ*z,z˜N(0,1). (1)

Therefore f(x|.) is the sum of all the corresponding μ's at each bottom node for all the trees.

BART approximates the unknown form of f(x₁, x₂, . . . , xₚ)=E[Y|x₁, x₂, . . . , xₚ] by a “sum-of-trees” model that is coupled with a regularization prior to constrain each tree to be a weak learner. Essentially in accordance with the disclosed subject matter, it is desired to fit the model in equation (2)

Yᵢ=f(Xᵢ)+eᵢ. (2)

In an exemplary embodiment, BART can require an iterative simulation procedure, the Metropolis-Hastings (MH) algorithm, which is a Markov Chain Monte Carlo (MCMC) method for stochastic search of the posterior to generate regression trees. Draws from f|(x; y) are averaged to infer f. To get the draws, the following techniques can be employed: 1) put a prior on ‘f’, and 2) specify a Markov chain whose stationary distribution is the posterior of ‘f’.

Bayesian Additive Regression Tree (BART) is also an extremely versatile method as it can be based on ensemble learning where each tree constitutes a weak learner. It has a completely different approach to SVM and can perform quite well on noisy data. However, the model can have many parameters and finding the optimal set can be computationally expensive.

As disclosed herein, modeling experiments can rely on the Bayes Tree package publicly available in R. In one embodiment, a prior can be imposed over all the parameters of the sum-of-trees model, namely, (T₁,M₁), . . . , (Tₘ, M) and σ. These parameters can be in turn based on the following hyper-parameters:

1. α (base), β (power): Determines the tree depth.

2. k: Sets the prior probability on the function to be estimated to lie within a certain bound.

3. ν, q: Sets the error tolerance level. (Smaller tolerance level can lead to over-fitting.)

Other parameters include the number of trees, the number of iterations before burn-in, and the number of post burn-in iterations.

In a Markov Chain Monte Carlo process, it can be desired that the underlying distribution converge before taking independent and identically distributed (lid) samples from the distribution. So, the number of draws until convergence can be referred to as “burn-in.” The plots of successive draws and discard the initial samples (burn-in) can be monitored until the samples become stationary.

Grid Search can then be deployed to find the optimum set of parameters. Since there are large numbers of parameters, any effort to obtain an optimal parameter set can be computationally expensive. The following default parameters can be used to evaluate the BART model as disclosed herein: α=2.0; β=0.95; k=2; 600 trees; 2000 iterations before burn-in; 5000 iterations after burn-in. The BART results are compared with SVM and Neural Network results in FIG. 9A and FIG. 9B. FIG. 9A and FIG. 9B illustrates the ensemble of forecasting models. FIG. 9A illustrates a graph of the electric load. FIG. 9B illustrates a graph of the MAPE error measure for each model (in percentage).

### Distribution Facility Electric Load and Package Volume Forecasting

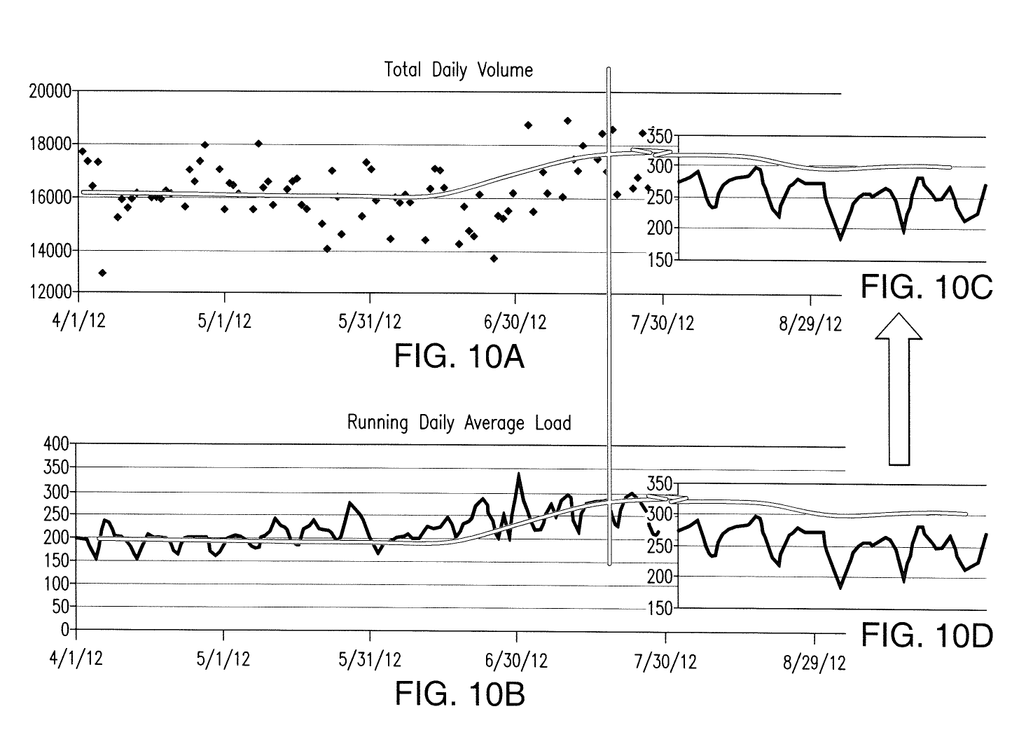

In an exemplary enablement, the disclosed subject matter can be employed in a large package delivery facility 217 that routinely processes, for example, 8000 to 10000 packages per day. Inputting an additional covariate 107, 127 for historical package volumes can allow the MLFS 213, as described herein, to forecast package volumes using existing covariates and other data such as data from economic indices (FIG. 10A, FIG. 10B, FIG. 10C, and FIG. 10D). FIG. 10A is a graph that illustrates an exemplary plot of the actual load. FIG. 10A illustrates an exemplary actual daily volume. FIG. 10B illustrates an exemplary manufacturing facility electric load forecast. FIG. 10A illustrates the actual total daily package volume in the exemplary embodiment. FIG. 10B illustrates the actual total building electric load in the exemplary embodiment. FIG. 10C illustrates the predicted package volume in the exemplary embodiment. FIG. 10D illustrates the predicted package volume in the exemplary embodiment.

With the commencement of conversion to EDVs 219, the control of recharging times and charging rates can be configured so that the charging load does not interfere with equipment, such as conveyor belts and/or air quality equipment that keep workers safe and deliveries on time. Work processing peak loads can occur in the morning, afternoon, and around midnight. Duration of these load spikes can depend on factors such as, for example, the package volume, which in this embodiment can be held constant at a continuous flow of packages so that excessive load results in longer duration spikes in electricity consumption rather than in higher spikes in electric load. As disclosed herein in connection with this exemplary embodiment, the MLFS 213 can use Support Vector Machine Regression (SVM) or ensembles of other machine learning and statistical algorithms 113, 133 to predict the day-ahead electric load of the facility 217 using past histories of load for that day, hour, and weather prediction. It can use a feedback loop that scores the statistical accuracy of its predictions against the actual building load. In certain embodiments, the MLFS 213 can learn from its errors, which can be minimized over time. In an example embodiment, the MLFS 213 can then predict the forecast of package volumes for the next day, week, month, and season with one or more machine learning models.

In connection with certain embodiments, load data can include load for a building/distribution facility 217 or charging facility 217. Such load data can be measured by a power meter and provided to the system disclosed herein. Furthermore, power grid data can be provided to the system, for example from external utility companies. Additionally or alternatively, utility data can be provided by an independent system operator, ISO, or other building operators or utility customers nearby to provide geographical and/or electrical circuit diversity. Accordingly, coordination and constraints regarding power grid data can be used in connection with the techniques disclosed herein.

### Distribution Facility Package Volume Forecasting

In another exemplary embodiment, the package volume of a distribution facility 217 can be predicted by the MLFS 213, with package volume forecasts looking out successive times, such as 1 day ahead, 7 days, 30 days, 60 days, etc. which can have decreasing accuracy, and correspondingly, increasing error estimates. The MLFS 213 can be configured to predict upcoming package volumes for the facility 217 based upon past histories of that past day of the week, similar weather, and proximity to any upcoming holidays, if any. Using economic indicators as covariates 107, 127, the MLFS can 213 create models where the package volume is affected by changes in economic indicators, for example, economic indices such as Producer Price Index (PPI) and Consumer Price Index (CPI), which the Machine Learning ensemble can use to forecast distribution package volumes for the facility in addition to electric load and EDV 219 charging load, which can be responsive to these package volumes. The package volume can be forecast into the future so that scheduling and staffing decisions can be anticipated. Such forecasts can, however, be made with decreasing accuracy for increasingly long intervals. That is to say, conversely, as the scheduling day becomes approaches, the MLFS 213 can become increasingly accurate. Furthermore, with repeated feedback, the MLFS 213 can become even more accurate over all intervals, and particularly for the longer prediction intervals. Leaner, more efficient scheduling and staffing plans can provide for money-saving opportunities in addition to the energy efficiency gains provided by the subject matter disclosed herein.

### Electric Delivery Vehicle Charging Load Forecasting

In another exemplary embodiment, the MLFS 213 disclosed herein can be built into a commercial battery recharge optimization system so that, for example, tomorrow's expected package volume and weather forecasts can be used to successfully optimize the time windows allocated for EDV 219 fleet recharge and intensities of power to the batteries in each vehicle. Peak load spikes can be avoided since they can draw penalties from the utility.

As noted above, using EDVs 219 on a large scale can necessitate managing the charging activity to avoid increasing the peak electric demand significantly, which, in turn, can avoid overloading the existing electric distribution infrastructure. In an example embodiment, in order to manage, one can model the charging load. To predict the charging load at manufacturing facilities that utilize EDVs, the MLFS disclosed herein can forecast the timing and totality of EDV charging loads per day.

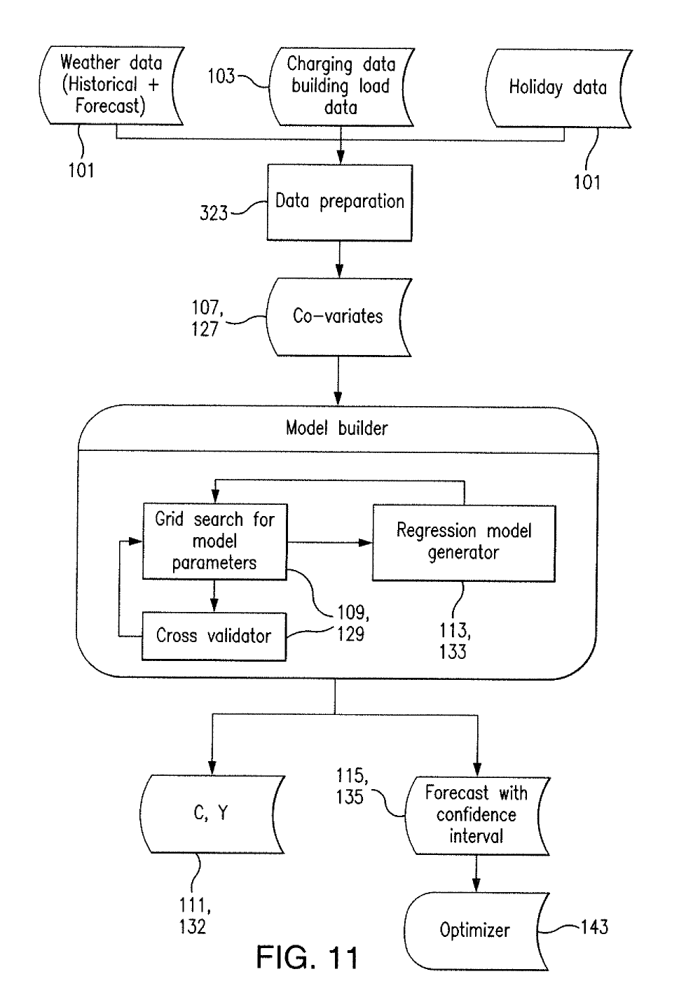

The baseline charging infrastructure can include commercially available vehicle charging units networked into the facility 217 to intranet along with a local PC running the charging and ML Forecasting Systems. The joint system can accomplish basic EDV charging and will record event parameters including charge time, vehicle ID, and kWh consumed. An exemplary depiction of the software architecture of the EDV charging module if the MLFS 213 is show in FIG. 11. In an exemplary embodiment, as depicted in FIG. 11, weather data (for example, historical or forecast information), holiday data can be obtained from the internet 101 or other sources such as a database 103. Additionally, charging data from the interne 101 or database 103, or other sources can be used. The data can then be prepared (323) and covariates 107, 127 can be determined. A model is then built (207, 113, 133) which can include, but is not limited to, grid searching for model parameters, generating regression models, and cross-validation techniques. Learning parameters (111, 132) are then calculated and forecast with a confidence interval is then generated (135). The learning parameters can be (re)optimized once a day.

EDV Charging Sub-System Architecture within the MLFS

In an exemplary embodiment, a system for EDV charging within the MLFS 213 can include two components: 1) a commercial data acquisition and historian software database 103 loaded onto a local PC at the facility 217 and/or at a remote server to collect and archive data as well as provide the proper visualization screens for each project member to view status and historical trends, and 2) a supervisory control and data acquisition (SCADA) system component can better understand the grid state as well as some of the finer details of the vehicle and depot states. This solution can help analyze the entire system state and provide recommended charge schedules, for example with an optimizer 143, for the vehicles meeting predetermined constraints, such as a fully charged vehicle by the required departure time and lowest electricity fuel cost.

The disclosed MLFS 213 can connect to the external control system in order to forecast the building load and charging load 24 hours in advance. The MLFS 213 can apply machine learning techniques on various feature datasets including electrical load, weather, holiday, and package volume to predict next day's building load, charging load, and building load minus charging load for electrical load and charging schedule optimization of the facility 217 and EDVs 219.

The charging load for EDVs 219 can depend on a number of factors. The time of day, day of the week and package volume can affect the energy demand most dramatically. Most of the charging activity can happen on weekdays after the EDVs come back in the evening. By including past charging load observations in the prediction, this weekly cycle of usage during late evenings and early mornings can be learned by the model and is used to predict charging load over the next 24 hours.

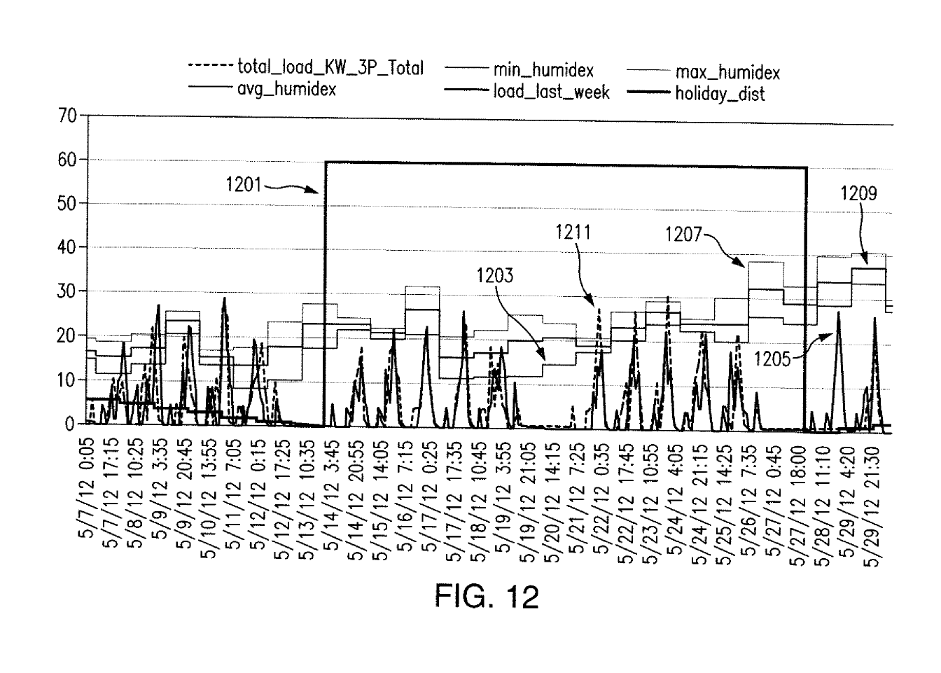

Another important factor in predicting charging load, for example, is the weather. On particularly hot days, more energy can be required to cool the EDV 219, and more energy goes into heating on very cold days. Similarly, humidity and the presence of precipitation can change the temperature perceived by the EDV operator, which affects the amount of energy required to regulate temperature and hence to charge the batteries. Past energy demand, temperature, and dew point temperature can be used in the creation of the computer model. FIG. 12 displays exemplary covariates 107, 127 for input into the EDV charging load forecaster. FIG. 12 further illustrates the charging load and covariates 107, 127 used for charging load forecast (max_humidex (1209), load_last_week (1205), min_humidex (1203), holiday_dist (1201), total_load_KW_{—}3P_Total (1211), avg_humidex (1209)).

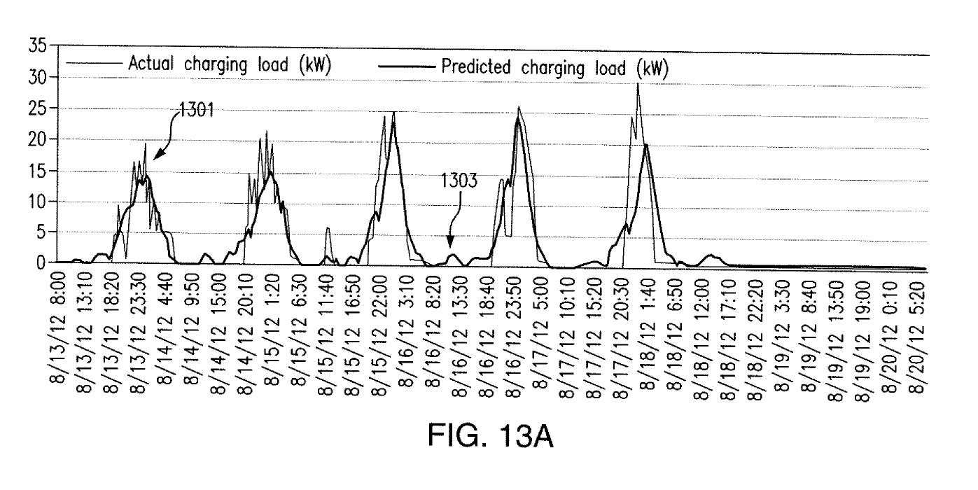

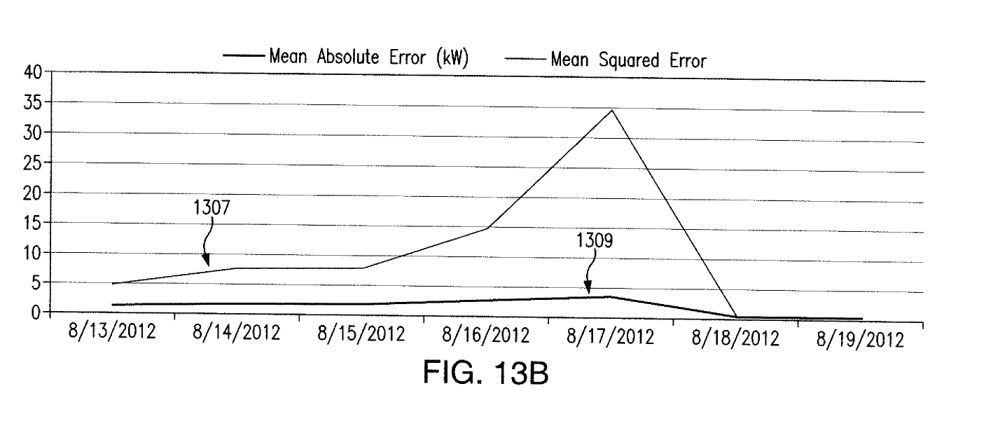

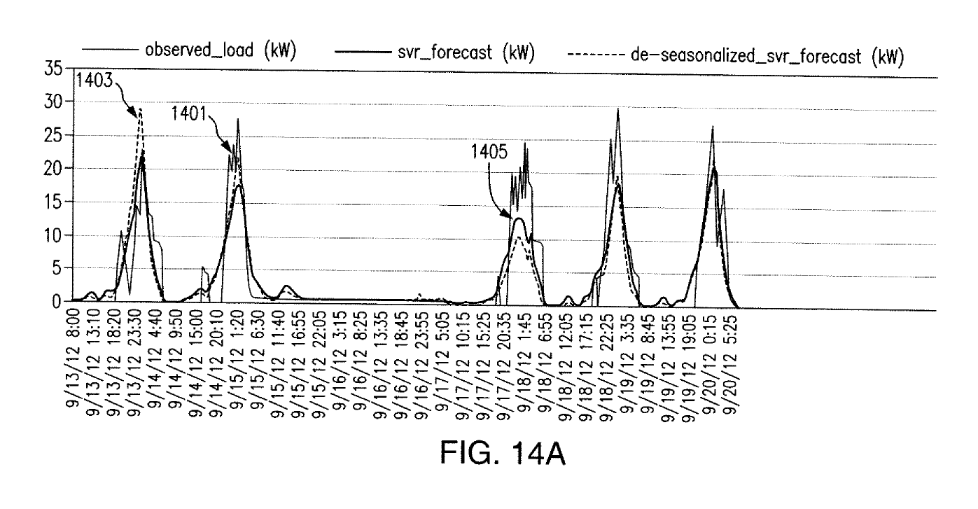

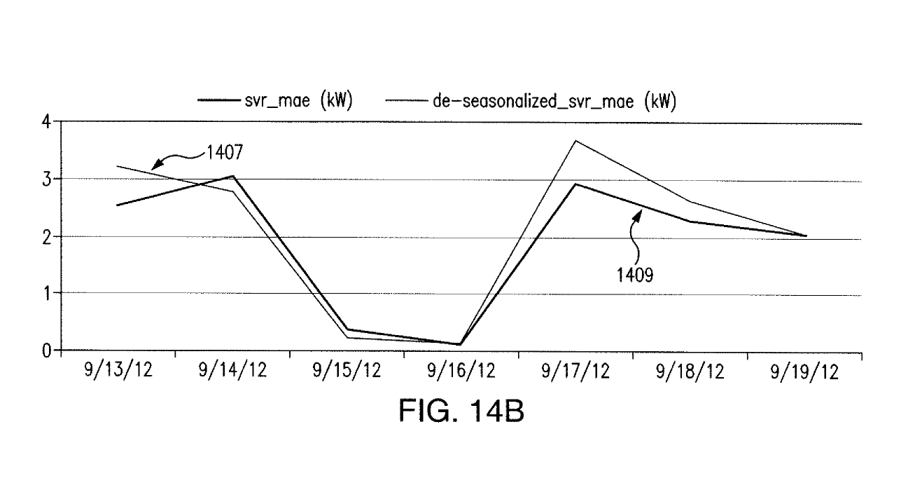

For purposes of illustration and not limitation, exemplary techniques for EDV 219 charging load forecasting will now be described. Each data point of past charging load is graphed against three sets of attributes: time of day and time of week related, weather-related and observed load: a day ago, a week ago and averaged over intervals of various lengths and recent trend based on the total daily energy usage for charging over the past few days. In this example, the observed weather at charging time does not have a direct effect on the charging load, but the weather experienced by the EDV operator during his/her route does. Within the MLFS 213, the SVM regression model can be used to find patterns in the historical EDV 219 charging data for the manufacturing facility 217. FIG. 13A and FIG. 13B shows an exemplary EDV 219 charging forecast (1303) for an ensemble SVM model and the MAPE errors when tested against actual data (1301). FIG. 13A illustrates an exemplary Electric Vehicle charging load forecast. FIG. 13B illustrates an exemplary Electric Vehicle charging load forecast percentage error (Mean Absolute Error (1309), Mean Squared Error (1307)). The SVM model can produce accurate prediction statistics when compared to actual results (FIG. 14A, FIG. 14B and Table 2). FIG. 14A is a graph that illustrates an exemplary prediction of a de-seasonalized SVR with respect to a SVR that is not de-seasonalized in accordance with the disclosed subject matter (observed load (1403), de-seasonalized_svr_forecast (1401), svr_forecast (1405)). FIG. 14B is a graph that illustrates a comparison plot of errors of in a de-seasonalized SVR and an SVR that is not de-seasonalized using Mean Absolute Error (MAE) (de-seasonalized_svr_mae (1409), svr_mae (1407)).

TABLE 2

| Covariate | Correlation value with observed load |
|---|---|
| Long term average load | 0.84 |
| Average load over last 4 weeks | 0.78 |
| Average load over last 3 weeks | 0.77 |
| Week ago load | 0.71 |

MLFS Simulator for Expansion of EDV Fleets within the Manufacturing Facility

In another exemplary embodiment, the MLFS 213 can be used as a simulator, in that it can compute the scaling to hundreds of theoretical EDVs 219 at the facility 217 described above or other differently sized depot facilities to identify how electric load can be predicted and minimized. For example, scaling from 10 EDVs in FIG. 14A and FIG. 14B to 100 EDVs can produce spikes comparable to the kilowatt spikes produced by the conveyor belts in FIG. 9A and FIG. 9B. Optimization of the occurrence of such EDV 219 charging spikes so that they do not add to the machinery and conveyor belt loads can require less new capital equipment from the utility since added supply is not necessarily needed from the utility as the depot expands from 10% to 100% EDV's in the near future. The computer-generated MLFS predictions can give reasonable initial estimates of future energy demand from charging of real EDVs 219. Ever more accurate results can be likely achieved as multiple years of data are accumulated across varying seasonal cycles.

### Exemplary Method to Improve the Forecast of the MLFS

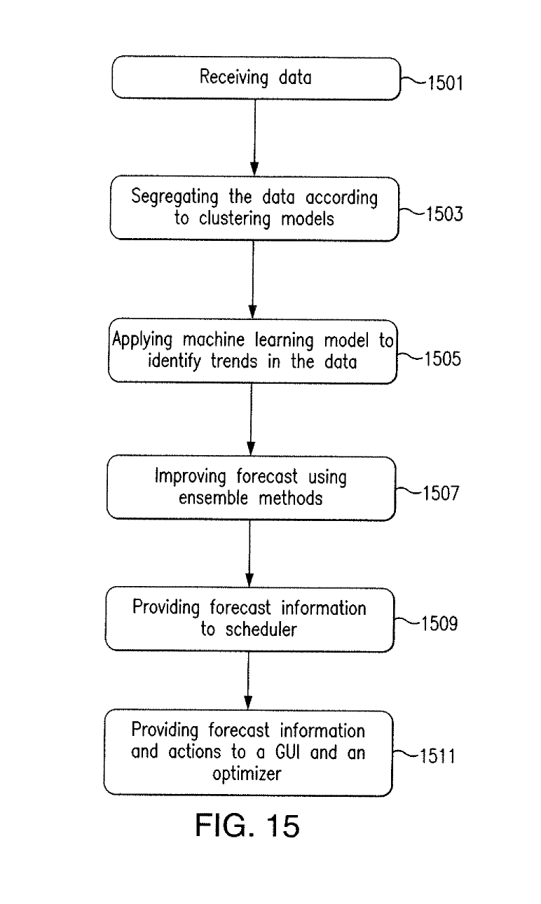

FIG. 15 is a flow graph that illustrates an exemplary method to improve forecasting using, for example, ensemble methods and unsupervised learning. In the exemplary embodiment, to deal with concept drift, different models can be used for different points in the data, for example, for different seasons, to improve the forecasting system. It can be understood that this exemplary method can be used to improve forecasting of the MLFS or any other system. With reference to FIG. 15, data related to the distribution facility 217 and the one or more EDVs 219 is received from a database 103 (1501). The database 103 can be, for example, a historical and relational database 103. The data can also include, but is not limited to, nearby weather forecasts, the latest forecasts for economic indices such as CPI and PPI, or the like.

### Segregating the Data

To prepare the data for identifying trends in the data, the data can be segregated into one or more clustering models (1503). Some examples of the clustering models include, but are not limited to, segregating the data using an hour-by-hour model, a Week clustering model, or the like. For example, the data can be segregated using an hour-by-hour model. The hour-by-hour model consists of data segregated for each hour of the day so that the variance in load during peak hours does not affect the prediction results for the rest of the day. In another example, the data can be segregated using a Week clustering model. This clustering model can also be understood as the Week (day) clustering model. In this model, the following days in the week can be combined together: (Monday-Tuesday), (Wednesday-Thursday-Friday), and (Saturday-Sunday). In another example, the data can be clustered using an Hourly and Week clustering model. In this model, the following days in the week are clustered together in separate models—with each hour of the day being a separate model: (Monday-Tuesday), (Wednesday-Thursday-Friday), and (Saturday-Sunday). In another example, the data can be clustered using a Week and States clustering model. In this model, the following days in the week are clustered together in separate models—with the Viterbi states used as covariates 107, 127 in the model: (Monday-Tuesday), (Wednesday-Thursday-Friday), and (Saturday-Sunday).

### Determining Trends in the Data

In an exemplary embodiment, the data is then analyzed to determine trends in the data (1505). In one example, after the data is segregated, different ML models can be used to identify trends in the data. It can be understood that the unsupervised learning models can be used to identify trends even if the data is not segregated. The different supervised learning models that can be used include, but are not limited to: Gaussian Mixture Models (GMM), Hidden Markov Model (HMM), Support Vector Machines (SVM), or the like such as Bayesian statistics and decision tree learning.

Gaussian Mixture Models

A Gaussian mixture model is a probabilistic model that assumes all the data points are generated from a mixture of a finite number of Gaussian distributions with unknown parameters. Mixture models can be understood as generalizing k-means clustering to incorporate information about the covariance structure of the data as well as the centers of the latent Gaussians. An implementation of the expectation-maximization (EM) algorithm can be used for fitting mixture-of-Gaussian models. The Bayesian Information Criterion can be computed to assess the number of clusters in the data.

Hidden Markov Models

A hidden Markov model (HMM) is a statistical Markov model in which the system being modeled is assumed to be a Markov process with unobserved (hidden) states. An HMM can be considered to be one of the simplest dynamic Bayesian networks. In simple Markov models (for example, like a Markov chain), the state can be directly visible to the observer. As such, the state transition probabilities are the only parameters. In a hidden Markov model, the state is likely not directly visible, but output, dependent on the state can be visible. Each state can have a probability distribution over the candidate output tokens. As such, the sequence of tokens generated by an HMM can provide some information about the sequence of states in the data.

### Improving Forecast Using Viterbi States or Compound Algorithm

Since data can change behavior over time, using only one ML model does not necessarily reveal significant information. The prediction model can provide bad forecasting results if the data changes from one trend to another, for example, from one seasonal period to another. As such, the use of only one supervised learning model is not necessarily the best predictor of forecast if there are independently changing inputs such as weather changes versus operational requirements, and then an ensemble of supervised learning models can be used to improve the forecast (1507). In one example embodiment, a compound algorithm can be used for better results and to reduce errors in the prediction. In this example, an Error Weighted Ensemble Algorithm can be used as the compound algorithm. In another example embodiment, Viterbi states can be used as covariates 107, 127 for better results and to reduce errors in the prediction. This improved forecast data can then be provided to the workload scheduler 141 along with recommended actions for EDV charging optimization systems (1509, 1511). In an exemplary embodiment, the final outputs such as the recommended actions and the forecast information can also be provided to a GUI.

Error Weighted Ensemble Algorithm (Online Learning)

In an exemplary embodiment, prediction algorithms can be used in situations where a sequence of predictions need to be made and the goal is to minimize the error in the predictions. An assumption can be made that there is one algorithm, out of pool of known algorithms, can perform well. However, selecting an algorithm that can perform well is not necessarily evident. In this exemplary method, a simple and effective method based on weighted means can be introduced for constructing a compound algorithm. In certain embodiments, the weights assigned to each algorithm in the pool can be inversely proportional to the error (either empirical or cross-validation). This method can be understood as the Error Weighted Ensemble Algorithm. The results from this method can then be compared to the results from other models and a simple mean of all the algorithms can be calculated.

To calculate the weighted means, the following equation (3) can be used:

$$\overline{X} = \frac{{ω}_{1} {X}_{1} + {ω}_{2} {X}_{2} + … + {ω}_{n} {X}_{n}}{{ω}_{1} + {ω}_{2} + … + {ω}_{n}} \qquad ( 3 )$$

Where: x_{i,t} is the predicted value from the ith model at time t and w_{i,t} is the weight of the model=exp(100−mape_{i,t-1}).

In an example embodiment, the weights can be taken on an exponential scale to distinguish one model from the other. In this example, if the MAPE values are observed to be very close to each other, then an exponential scale can be used to penalize the models performing badly and to observe the effect of the model's behavior in the ensemble.

In another exemplary embodiment, voting ensemble algorithm can be introduced for constructing a compound algorithm, as will be appreciated by those of ordinary skill in the art. In this example, each model in the compound algorithm can vote with a weight, for example an equal weight.

Viterbi Algorithm

The Viterbi alignment is a dynamic programming algorithm that can be used to find the most likely sequence of hidden states. It can be understood that the sequence of hidden states is also known as the Viterbi path. The sequence of hidden states can result in a sequence of observed events, especially in the context of Markov information sources and Hidden Markov Models. For example, in a Hidden Markov Model (HMM) with state space S, there can be initial probabilities πᵢ of being in state i and transition probabilities a(i,j) of transitioning from state i to state j. If the outputs y₁, . . . , y_{T} are observed, the most likely state sequence x₁, . . . , x_{T} that produces the observations is given by the recurrence relations in equation (4) and equation (5):

V_{1,k}=P(y₁|k)·πₖ (4)

V_{t,k}=P(yₜ|k)·max_{xεS}(a_{x,k}·V_{t-1 . . . x}) (5)

Where, V(t,k) is the probability of the most probable state sequence responsible for the first t observations that has k as its final state. The Viterbi path can be retrieved by saving the back pointers that remember which state x was used in equation (5).

If Ptr(k,t) is the function that returns the value of x used to compute v(t,k) if t>1, or k if t=1, then the following equations can be used to determine the most likely state sequence seen in equation (6) and equation (7):

χ_{T}=arg max_{xεS}(V_{T,x}) (6)

χₜ₋ₐ=Ptr(xₜ,t) (7)

The complexity of this algorithm can be given by O(T×|S|²)

### Examples

### 1) Improvement Over the Support Vector Machine Regression Model (SVR) Using Viterbi-States or an Error Weighted Ensemble Algorithm

For purpose of illustration and not limitation, exemplary application of the exemplary method of the disclosed subject matter will now be described. In this example application, experiments were conducted at the a distribution center building to illustrate the capability of the illustrated methods and systems described herein. The building has multiple sorting facilities with huge power-drawing conveyor belts and exhaust fans. As such, its power consumption patterns can be very different from a normal office building where HVAC is the dominant load. In the building, other exogenous factors such as package volume can play a crucial role in the building's power consumption patterns.

Various ML models were tested to forecast the load profile. Examples of the ML models that were tested include, Artificial Neural Networks (ANN), tree classification, Bayesian Additive Regression Trees (BART), Support Vector Regression (SVR) and time series methods such as variants of SARIMA. In these tested models, it was observed that the Mean Absolute Percentage Error (MAPE), which is a variance of error metric, can be large for the day-to-day variance. As such, the prediction model can be further improved. It can be understood that one of the contributors to the variance of error is change of trends in the data, for example, change in seasons. Therefore, a model that can incorporate concept drift and use different models during different seasons can outperform the current forecasting models.

### Data

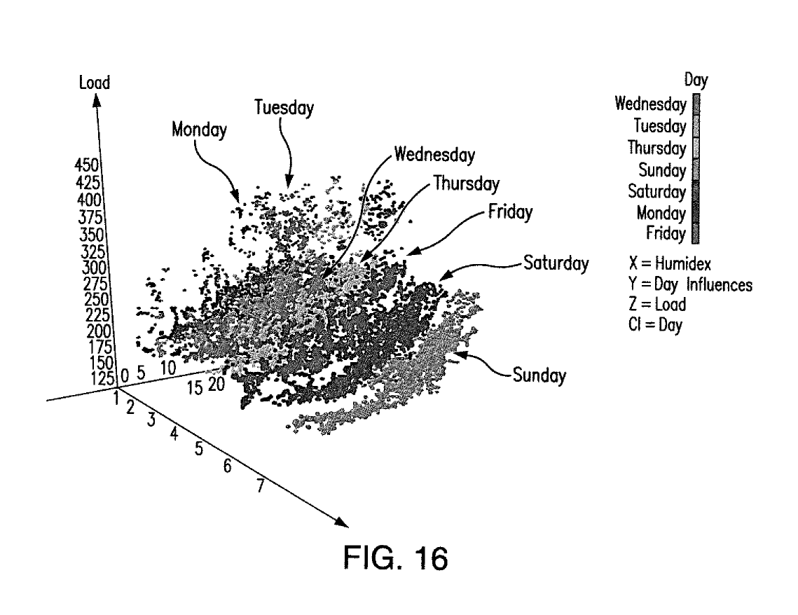

In this exemplary application, Electric load data for the building was used. The Electric load data for the building was sampled from April to December and sampled at a frequency of every 15 minutes. Additional data such as a calendar of holidays, observed weather data, a day-ahead weather forecast were provided as inputs into several different ML models to predict the electric load for the building the next day. The observed weather data consisted of data related to the temperature and the dew point. This data was obtained from Central Park National Oceanic and Atmospheric Administration (NOAA) via the Weather Underground. The day-ahead weather data was obtained from NOAA's National Digital Forecast Database via the Weather Underground. FIG. 16 is a 3-D graph that illustrates an experimental plot of the load data plotted against the humidex and the Weekday data.

### Clustering in Models

In this exemplary application, to utilize the clusters observed in HMMs, the supervised learning models were built after segregating the data using the following models. (1) An Hour-by-hour Clustering Model, where one model is generated for each hour of the day so that variance in load during peak hours does not affect the prediction results of the rest of the day. (2) A Week (day) Clustering Model—where the models were built after combining Mondays-Tuesdays, Wednesdays-Thursdays-Fridays & Saturdays-Sundays together.

### Hourly-Optimized SVR Prediction Model

Various ML models such as, for example, Artificial Neural Networks (ANN), tree classification, Bayesian Additive Regression Trees (BART), Support Vector Regression (SVR) and time series methods such as variants of SARIMA, can be deployed to forecast the load profile. In this exemplary application, each of these models was tested and the SVR model provided the best load forecasting results. The SVR model was selected after backtesting each model with the actual data. As illustrated in FIG. 9A and FIG. 9B, FIG. 9A illustrates an experimental comparison plot of forecasted electric load under the different ML models used (BART (903), SVR (905), Neural Network (907)) with respect to the actual data (901). FIG. 9B illustrates an experimental plot of the percentage error (MAPE) comparison under the different tested models in FIG. 9A. Since there is a cyclical component in the load profile, covariates 107, 127 such as previous day load, previous week load, previous day average, previous week average, time-of-the-day and day-of-the-week were incorporated. Additionally to account for the HVAC, an index called humidex (composite of temperature and dew point) was included as a covariate. As illustrated in FIG. 5, FIG. 5 illustrates an experimental plot of the electric load with all the covariates 107, 127 used in the supervised learning models. As FIG. 5 further illustrates, the covariates 107, 127 used in this example were the load, Average Day, Average Week, Holiday, humidex, Weekdays, and Hour.

There was a need to capture the time, duration, and magnitude of spikes caused by the operation of the large conveyor belts and exhaust fans in the load profile. These spikes occurred, for example, during the busy package volumeing and unloading hours. The electric load during these spikes can go up by, for example, more than 100 percent. In this exemplary application, an hourly-optimized model was used to capture these spikes in the load profile. In this model, 24 different SVR models, corresponding to each hour of the day, were formulated. Grid search with exponential distance between the grids was used to find values of the parameters in the SVR model. Due to the time series data, a customized cross-validation algorithm was implemented. The training data was segregated into two sets of data: one set of data consisted of all the available data during the training of the model except for the last week of data and the second set of data consisted of the last week of data to validate the prediction. This process was repeated for every week.

Mean Average Percentage Error (MAPE) was used to measure the accuracy of predictions. In this exemplary application, the data contained gaps. If the gap was substantially large, the data was ignored for the whole day. If the gap was small, the data was interpolated and used in the exemplary application. In the exemplary application, minimizing the MAPE value was used as the objective and the MAPE corresponding to each week's predictions was stored. These MAPE values were then averaged using exponentially decaying weights with the most recent week receiving the highest weight. The set of parameters corresponding to the minimum average MAPE were selected as the parameters for that hour. The whole process was repeated for each hour of the day. These parameters were then used to build the prediction model.

In this exemplary application, the above-described hourly-optimized SVR prediction model was used as the base model. The results obtained from new models were then compared to this model (with the assumption that this model was a good prediction model for the given data).

### Error Analysis of Current Model (Hourly-Optimized SVR)

In this example application, an extensive error analysis was performed to get insights on the performance of the hourly-optimized SVR model as well as the use of MAPE as the performance measure. This is because analysis has shown that all error measures show a similar trend as MAPE (on a different scale). Furthermore, MAPE can penalize outliers less than error measures such as MSE.

MAPE can be calculated using the following equation (8):

$$M = \frac{100 \%}{n} {\sum }_{t = 1}^{n} \vert \frac{{A}_{t} - {F}_{t}}{{A}_{t}} \vert \qquad ( 8 )$$

Where, Aᵢ is the actual value and Fᵢ is the forecast value.

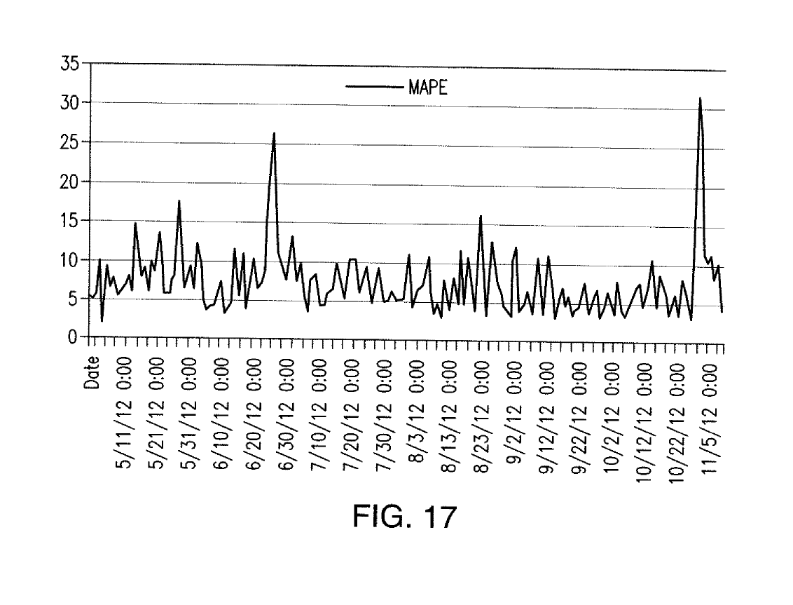

FIG. 17 is a graph that illustrates an experimental plot of the MAPE for the hourly-optimized SVR model.

MAPE can also be easier to comprehend than SMAPE, which ranges from about 0 to about 200 and RMSE, whose range scales with the data. SMAPE can be calculated using the following equation (9):

$$SMAPE = \frac{1}{n} {\sum }_{t = 1}^{n} \frac{\vert {A}_{t} - {F}_{t} \vert}{( {A}_{t} + {F}_{t} ) \text{/} 2} \qquad ( 9 )$$

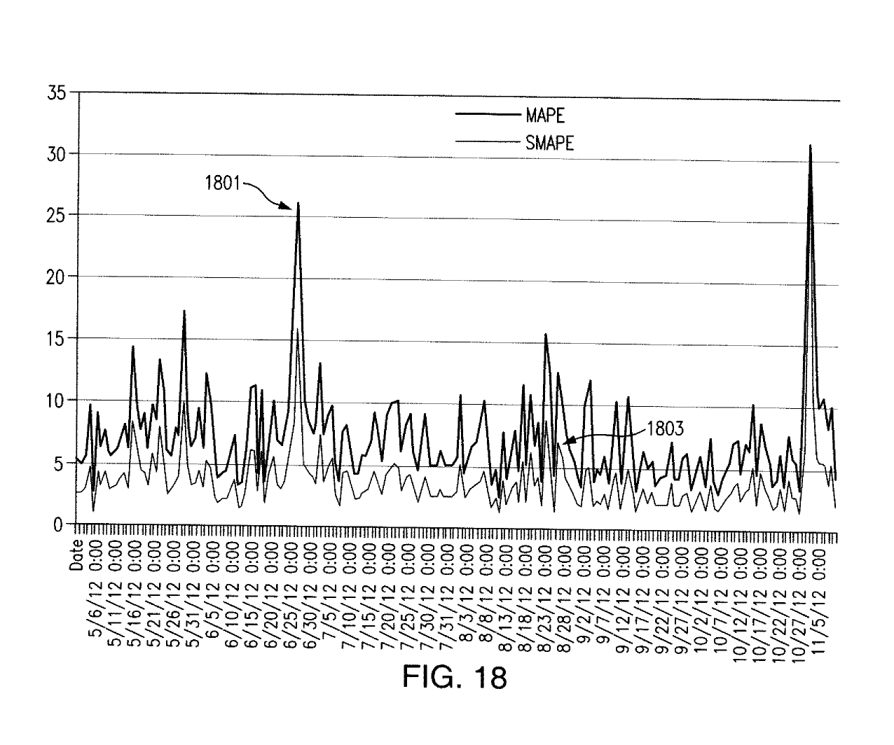

FIG. 18 is a graph illustrating an experimental plot of MAPE (1801) with respect to SMAPE (1803) for the hourly-optimized SVR model.

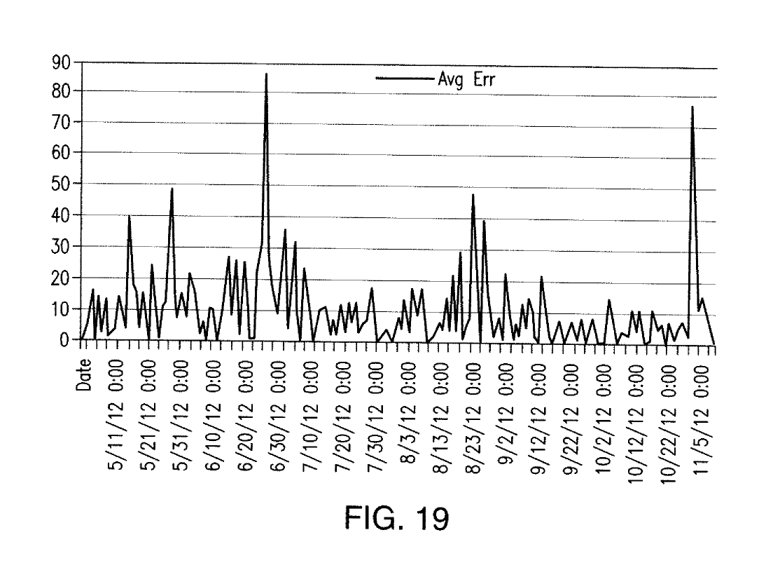

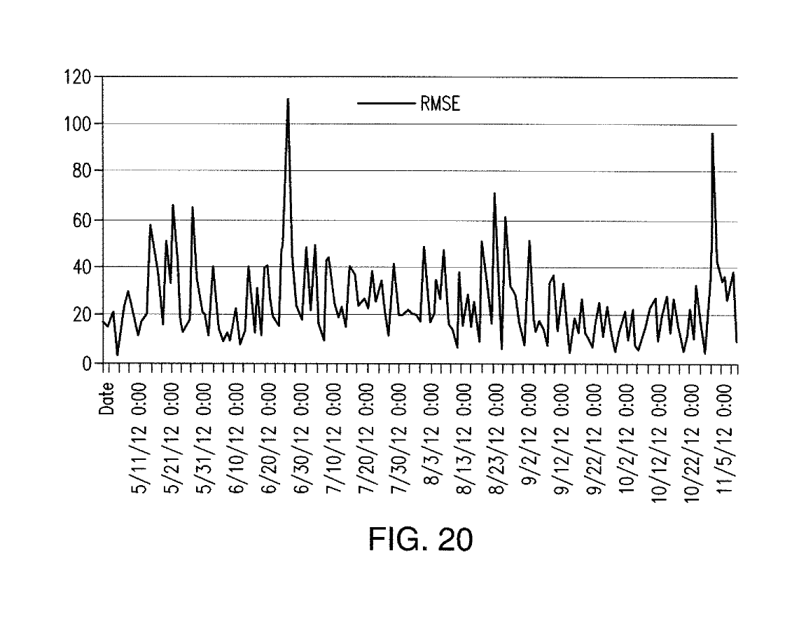

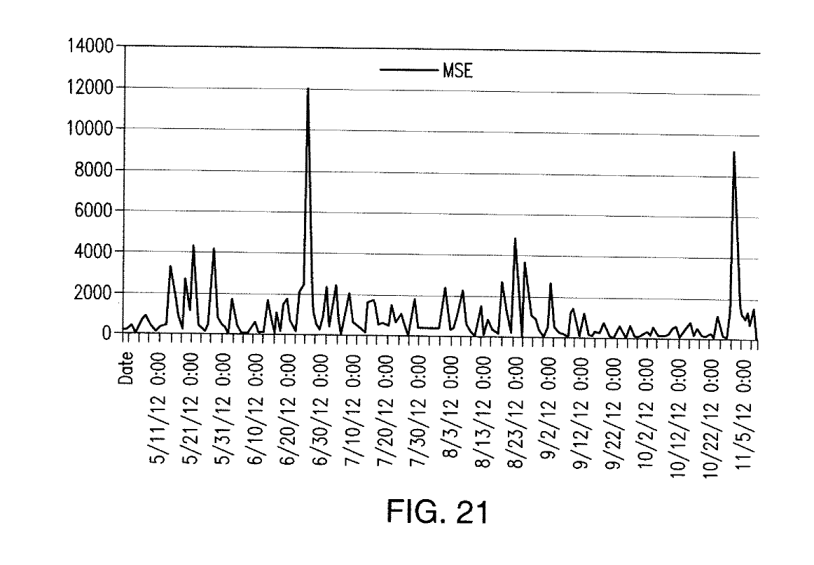

FIG. 19 is a graph that illustrates an experimental plot of the Average Error by Day of the hourly-optimized SVR. FIG. 20 is a graph that illustrates an experimental plot of the root mean squared error for hourly-optimized SVR. FIG. 21 is a graph that illustrates an experimental plot of the mean squared error for the hourly-optimized SVR. All the error plots seen in FIG. 17, FIG. 18, FIG. 19, FIG. 20, and FIG. 21 illustrate the same trend in the data. As seen in these graphs, there are no useful insights that could be used to improve the predictions further by looking at different error measures.

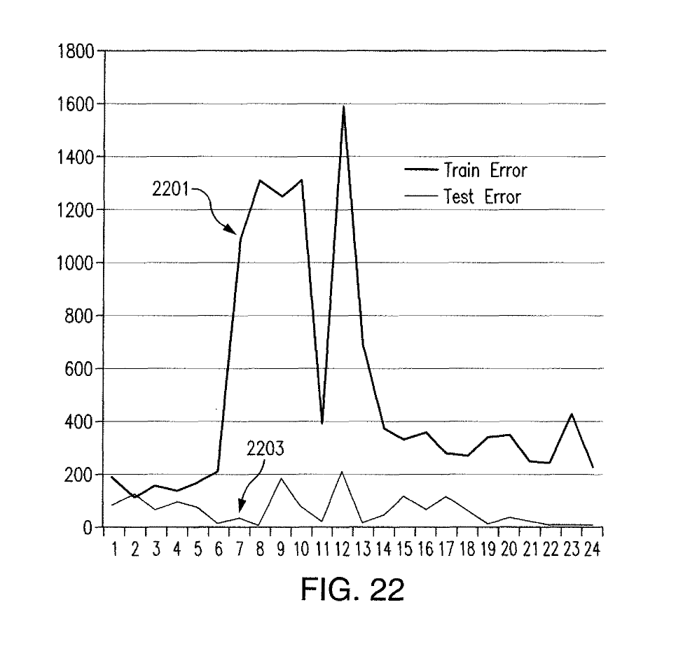

FIG. 22 is a graph that illustrates an experimental plot of the Train Error (2201) and Test Error (2203) (MSE) with respect to Time-of-the-day for hourly-optimized error. FIG. 22 illustrates that the training and testing errors are highly correlated in this data. The high training error can be due to larger number of samples in the training data. As seen in FIG. 22, the training error plot demonstrates that the model is not able to align with the data properly during certain hours of the day. This can imply that the estimation error is high and an improvement in the prediction can be obtained by using a learning model that aligns the target function with the training set more accurately.

### Analysis of Data

### Gaussian Mixture Models

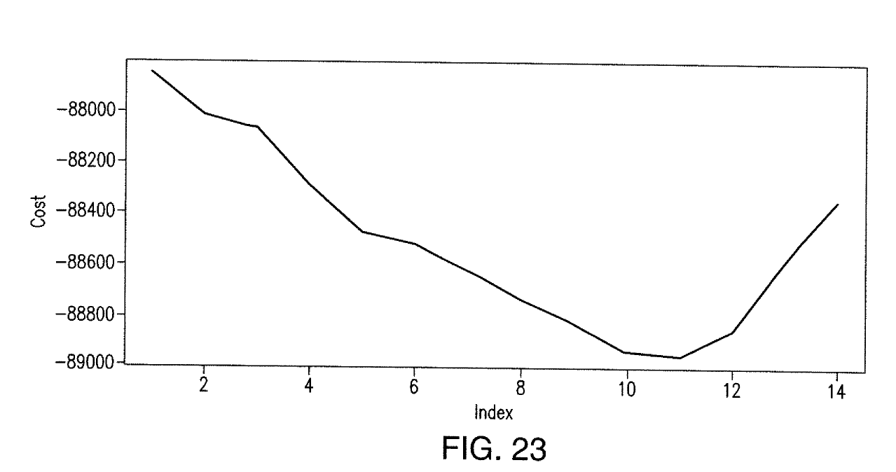

In the exemplary application, the first approach was to find trends in the data and use unsupervised learning to cluster it to better understand the data. In this application, Gaussian Mixture Models were used to cluster the data. First, a two-dimensional clustering based on load and humidex was performed. But, this two-dimensional clustering provided information only about the data and ignored the sequential aspect of the time series data. As such, to include the sequential aspect of the time series data, the first 96 points of load were combined to form one feature vector and elbow plots on these feature vectors were produced. FIG. 23 is an elbow plot of the Bayesian Information Criterion (BIC) with respect to the number of clusters. It can be understood that an elbow plot can be used to find the number of clusters while fitting GMMs. As seen in FIG. 23, the y-axis in the plot, corresponding to the BIC values, is based on the likelihood function. It is similar to the Akaike Information Criterion (AIC). The number of parameters can then be selected based on a sharp bend (elbow) in the curve.

FIG. 23 illustrates an example of an elbow plot that is used to identify the number of clusters. In this exemplary application, 10 clusters were identified. It can be understood that the elbow plot can change with respect to changes in, for example, the time frame, number of dimensions, or the like. There can also be multiple elbows in the plot. As such, selecting the number of clusters can be subjective to what is practical and applicable.

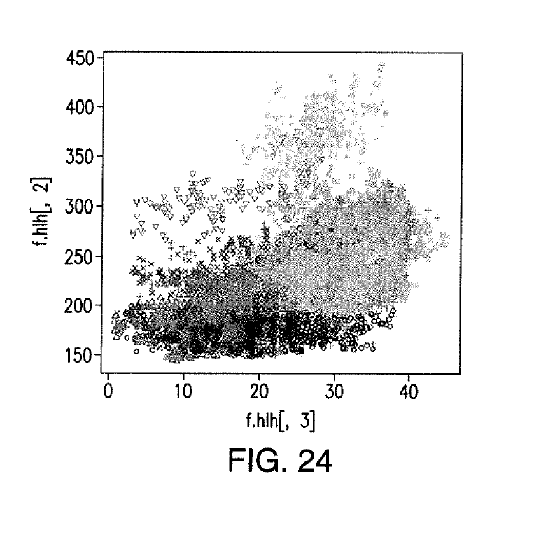

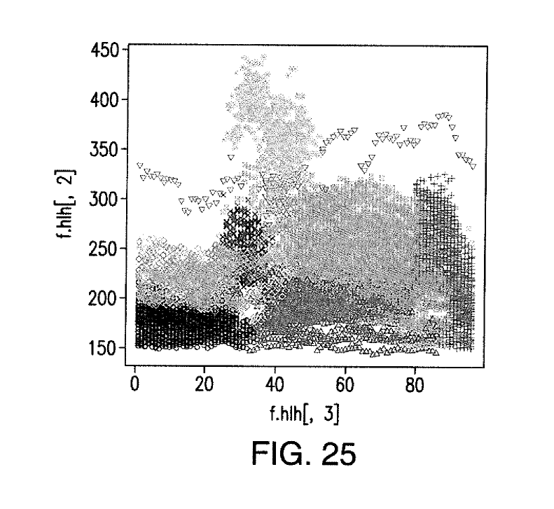

In this exemplary application, a repetitive trend in the electric load data was observed. A definitive correlation between humidex (a combination of temperature and dew-point) and load was also observed. As such, these three features (i.e. load, time of the day, and humidex) were combined and clustering was applied to the combination. FIG. 24 is a 2-D a graph illustrating an experimental plot of the load with respect to humidex. FIG. 25 is a 2-D a graph illustrating an experimental plot of the load with respect to the time of the day (in units of 15 minutes—thus there are 96 in a day). FIG. 24 and FIG. 25 illustrates that HMM can work fairly well on the data.

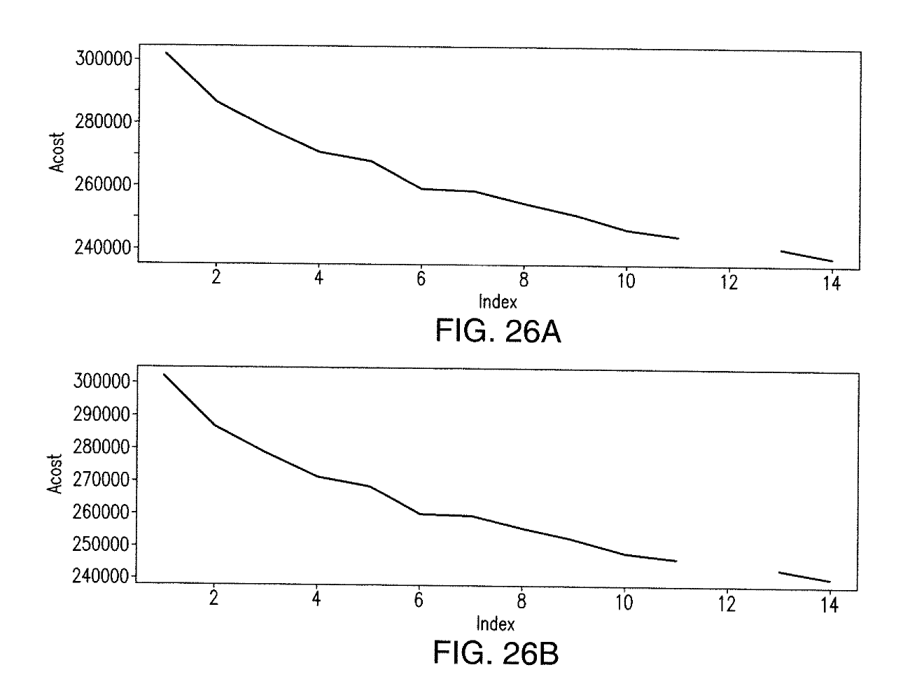

FIG. 26A is an elbow chart illustrating an experimental plot of the AIC to the number of clusters. FIG. 26B is an elbow chart illustrating an experimental plot of the BIC to the number of clusters. As seen in FIG. 26A and FIG. 26B, AIC or BIC cannot be calculated for the 12 number of clusters. It should be noted that as seen in FIG. 26A and FIG. 26B, an elbow is observed at the 6 number of clusters.

Therefore, as expected, fitting HMMs to the data gives results similar to GMMs. To further analyze trends in the data, six months data was sub-divided into three months each. Six clusters (as obtained from the knee in the elbow plot) were used.

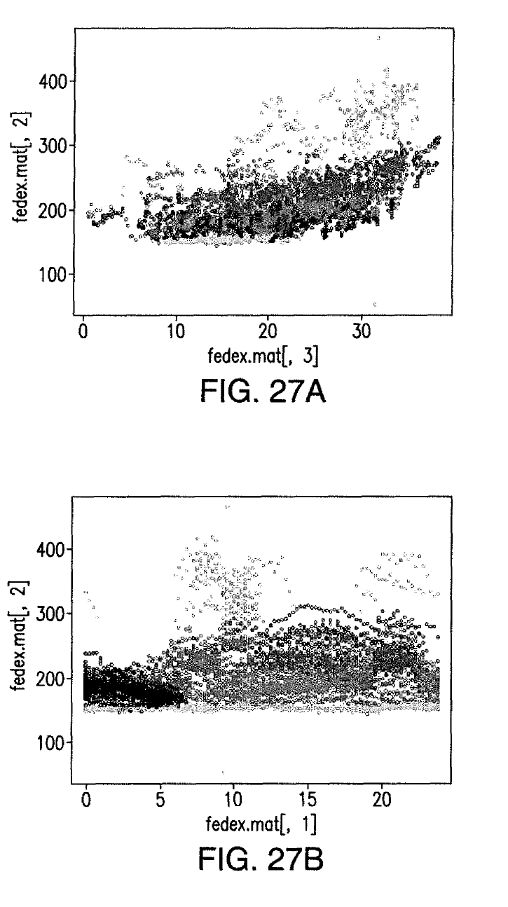

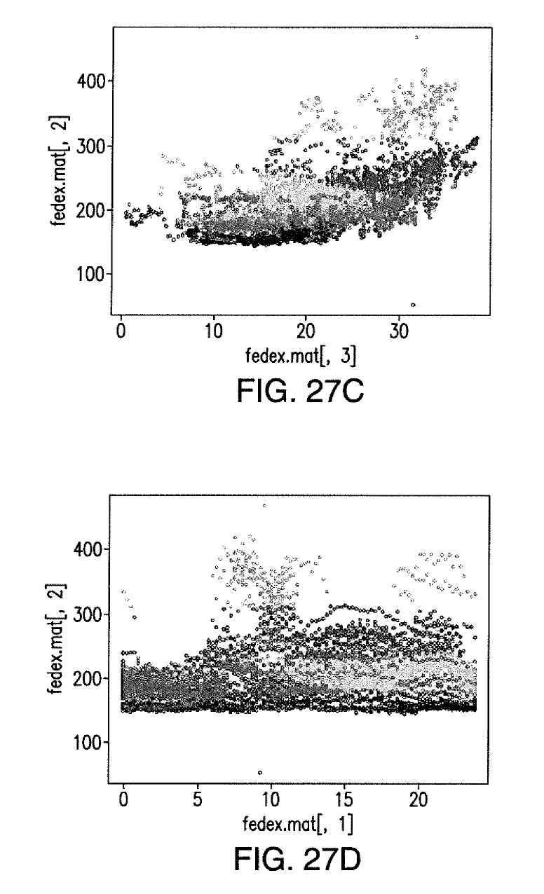

FIG. 27A, FIG. 27B, FIG. 27C, and FIG. 27D are graphs illustrating an experimental plot of the load with respect to humidex and load with respect to Time-of-the-day using 6 clusters. As seen in FIG. 27A, FIG. 27B, FIG. 27C, and FIG. 27D, the plots cluster the data together but don't reveal anything significant that can be used to improve the prediction. In this example, six months of data were sub-divided into three months each and the first three-months are seen in the top row and the second three-months are seen in the bottom row.

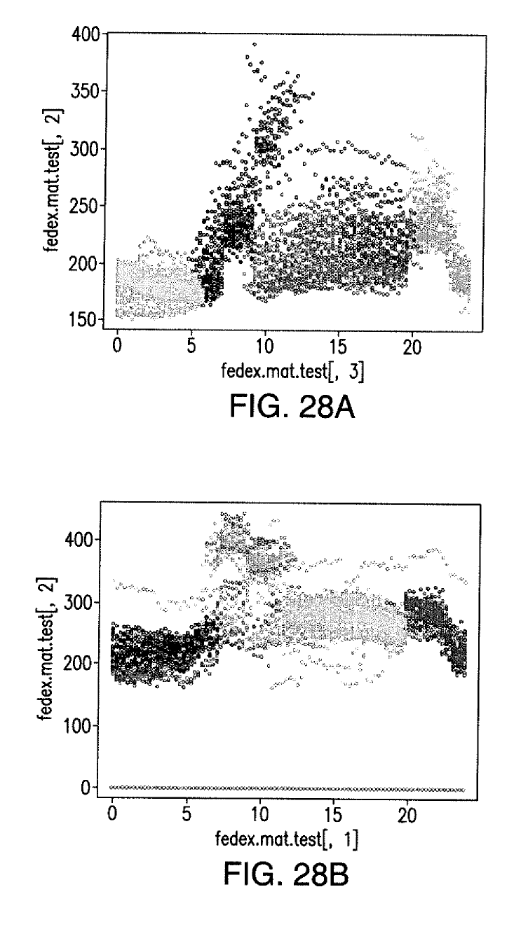

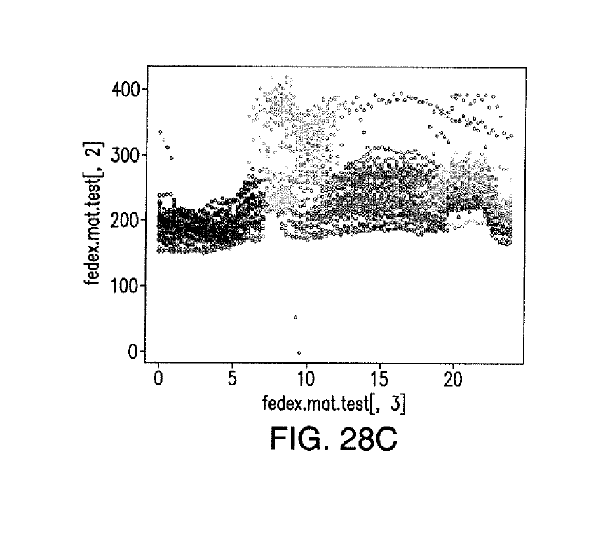

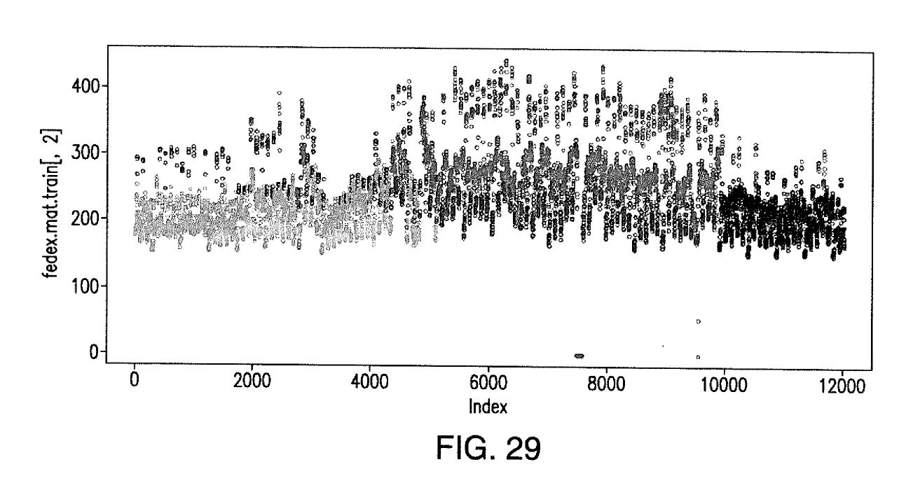

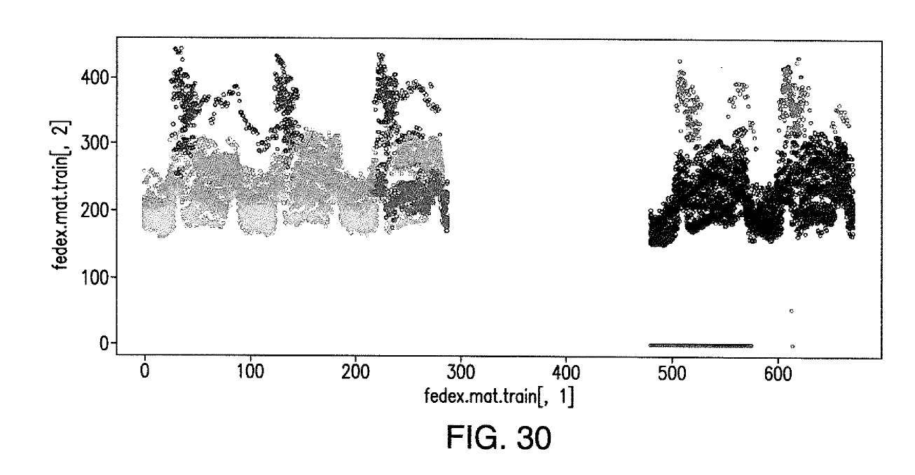

FIG. 28A, FIG. 28B, and FIG. 28C are graphs illustrating an experimental plot of the load with respect to Time-of-the-day where the data is subdivided into 3 sets of two months each. FIG. 29 is a graph illustrating an experimental plot of the load with respect to time, which is color-coded with clusters obtained from fitted HMM model. The data was obtained over a time period of 6 months. FIG. 29 illustrates 15 minute intervals for about four months. FIG. 30 illustrates a graph that plots the load with respect to the time of the week. In FIG. 30, the plot is color-coded with clusters obtained from the fitted HMM model. As it observed in FIG. 28A, FIG. 28B, FIG. 28C, FIG. 29, and FIG. 30, unrolling the data over the entire time period can reveal some useful insights. This can explain the change in behavior of the data over time. This also demonstrates the reason a prediction model can perform badly when it goes from one seasonal period to another. Analyzing FIG. 29 closely also demonstrates that there can be other time frames that can reveal some more information about the data. As such, fitting the HMMs with time-of-the week as one of the dimensions demonstrates clustering between weekdays. As further illustrated in FIG. 30, the blank area in the graph represents the weekends.

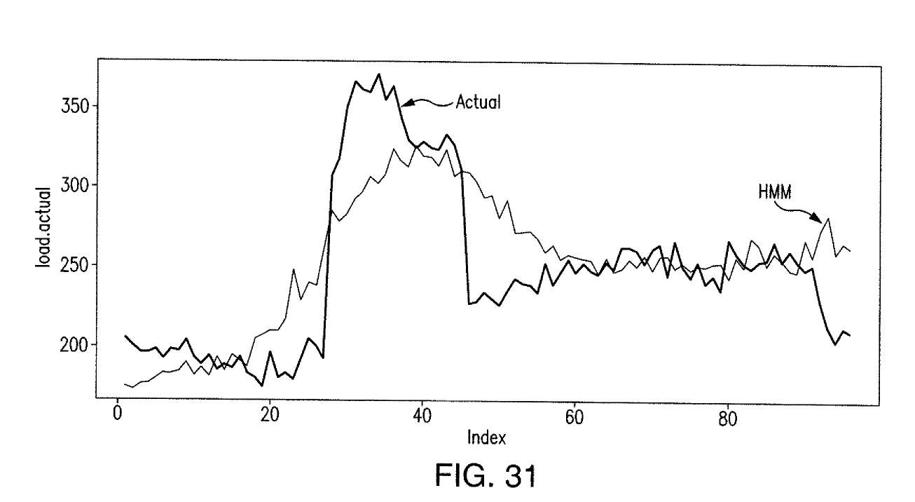

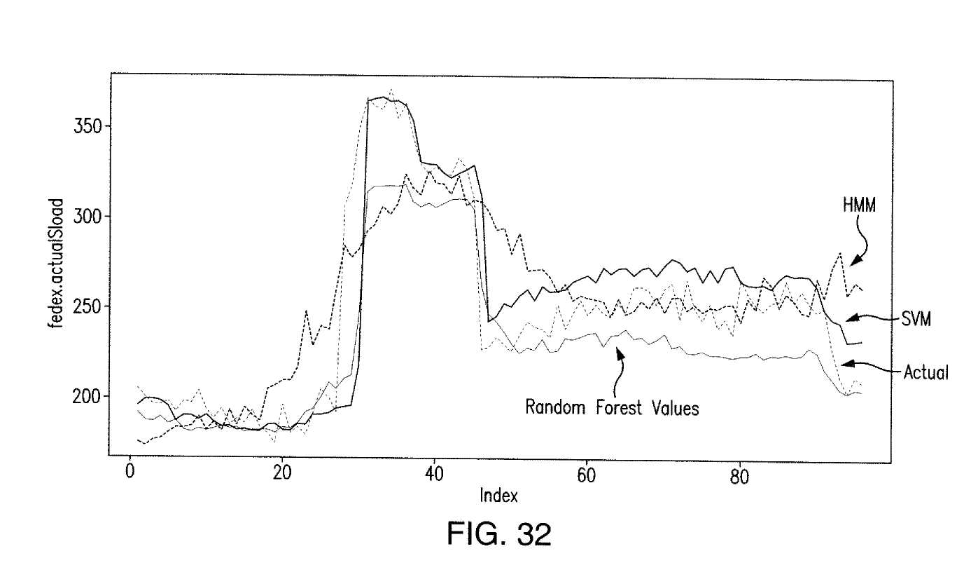

FIG. 31 is a graph that illustrates an exemplary prediction using HMM model. In FIG. 31, the load is plotted again the Time of the day. FIG. 32 is a graph illustrating an experimental plot of the load with respect to the time of the day.

Table 3 illustrates the MAPE errors observed in the data in the different models tested:

TABLE 3

| Model | MAPE Errors |
|---|---|
| Random Forest | 7.8% |
| SVM | 6.4% |
| HMM | 9.8% |

As seen in FIG. 31, FIG. 32, and Table 3, comparison of predictions from HMMs with other models can reveal that they are not necessarily the best predictors when used independently. Additionally, it can be understood from the analysis that Viterbi states can contain a significant amount of information. As such, creating a compound algorithm by blending HMMs with other algorithms can lead to better results. Additionally, using Viterbi states as covariates 107, 127 in the supervised learning algorithms can also lead to better results.

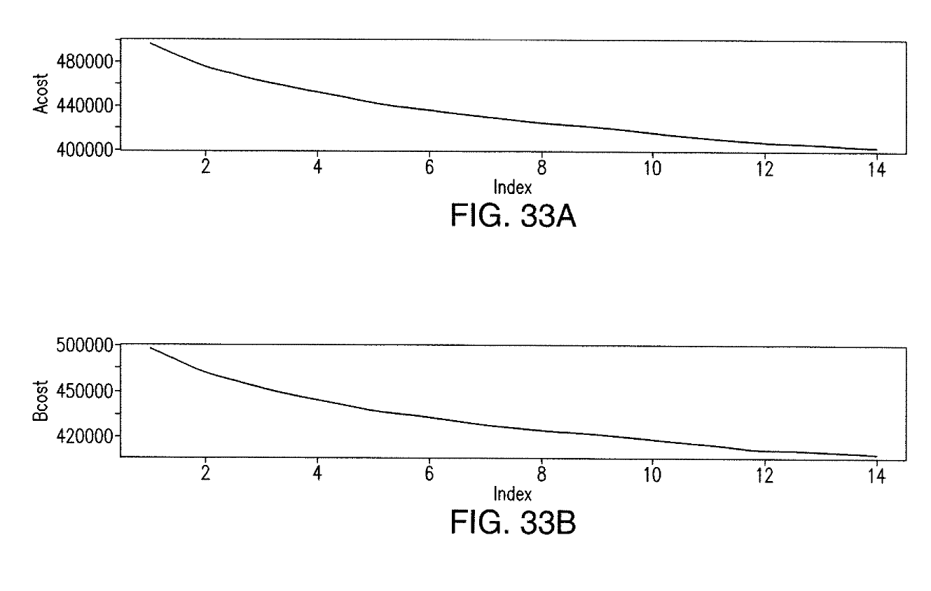

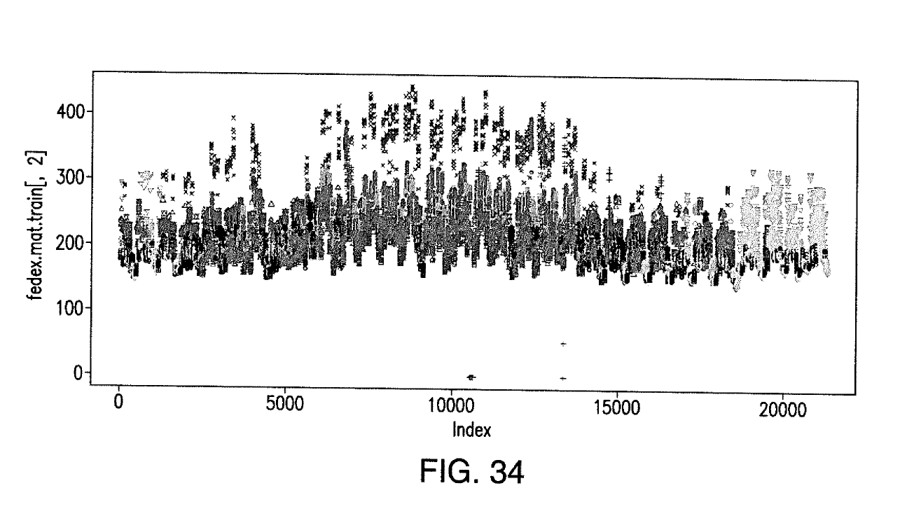

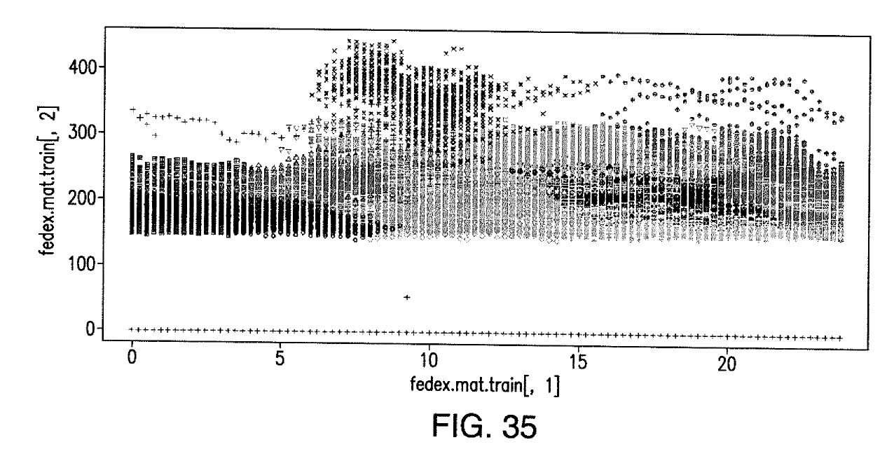

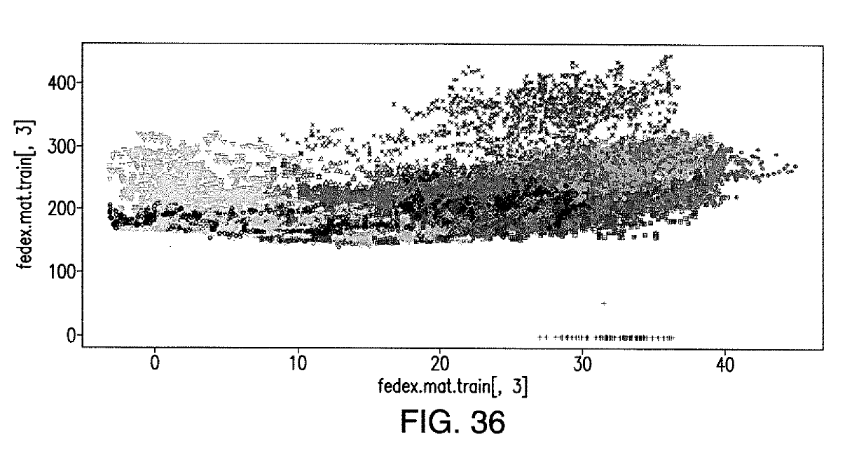

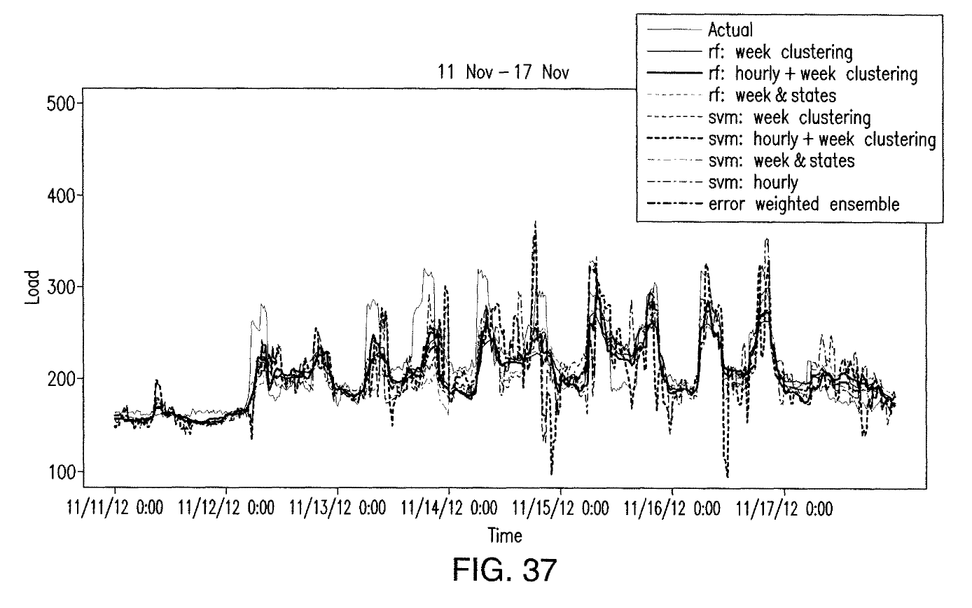

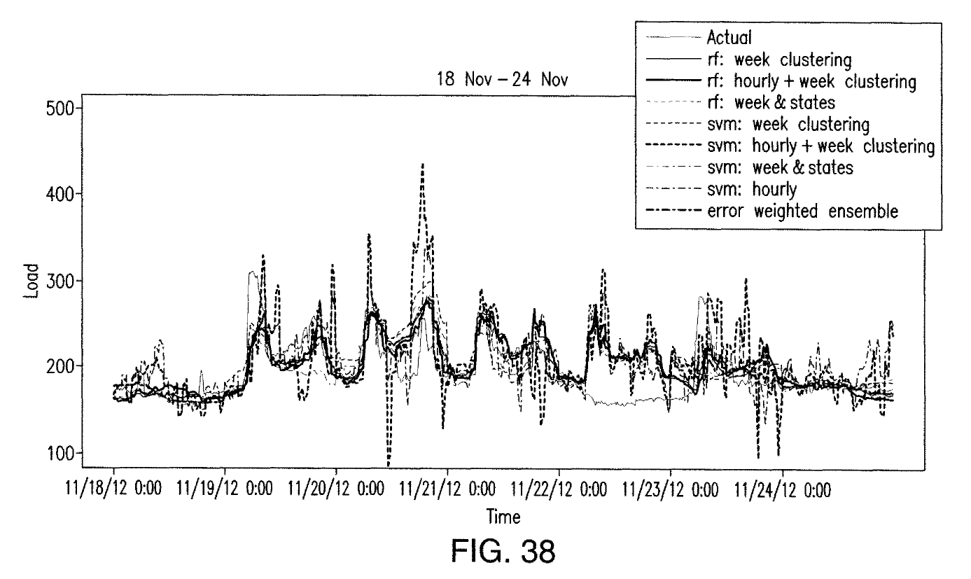

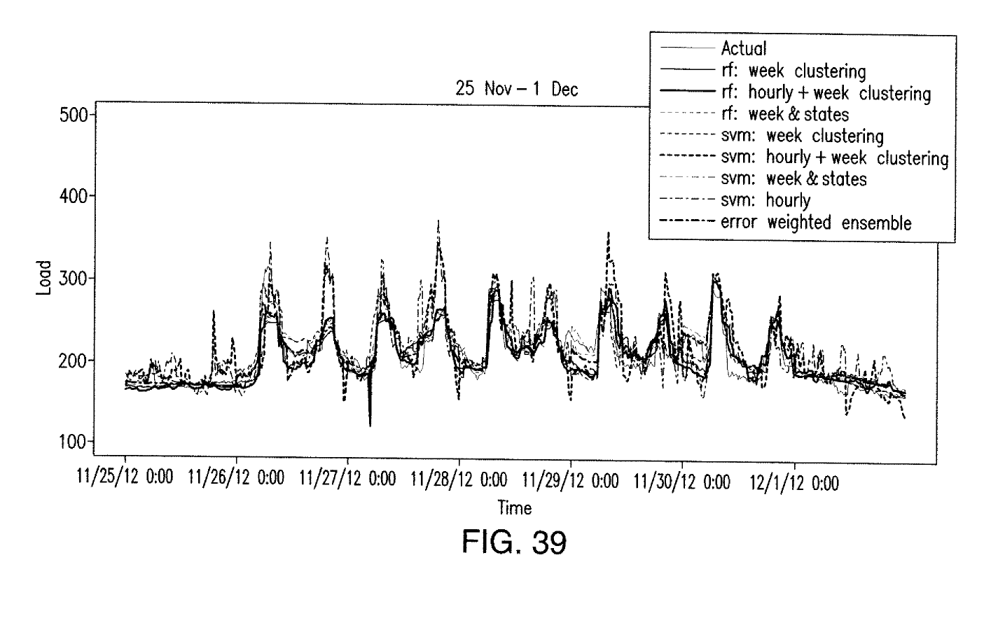

FIG. 33A is an elbow chart illustrating an experimental plot of the AIC with respect to the number of clusters in the data. The data used in FIG. 26A was different than the data used in FIG. 33A. FIG. 33B is an elbow chart illustrating an experimental plot of the BIC with respect to the number of clusters in the data. FIG. 34 is a graph illustrating an experimental plot of the load with respect to the time. The data used in FIG. 34 had different number of clusters and more number of states than the graph in FIG. 29. The graph is color coded with clusters that were obtained from the fitting of the HMM model. FIG. 35 is a graph illustrating an experimental plot of the load with respect to the time-of-the-day. The graph is color coded with clusters obtained from the HMM fit. FIG. 36 is a graph illustrating an experimental plot of the load with respect to the humidex data. The graph is color coded with clusters obtained from the HMM fit. FIG. 37 is a graph that illustrates an experimental comparison plot of predictions from different models used in this exemplary application during the week of Nov. 11, 2012 to Nov. 17, 2012. FIG. 38 is a graph that illustrates an experimental comparison plot of predictions from different models used in this exemplary application during the week of Nov. 18, 2012 to Nov. 24, 2012. FIG. 39 is a graph that illustrates an experimental comparison plot of predictions from different models used in this exemplary application during the week of Nov. 25, 2012 to Dec. 1, 2012. The different models used in the study included (1) an hourly clustered model with HMM fitting, (2) a Random forest regression with 500 trees and a week clustering, (3) a Random forest regression with 500 trees and a week clustering, (4) a Random forest regression with 500 trees, a week clustering and Viterbi states used as covariates 107, 127, (5) a Support Vector Regression with Week clustering, (6) a Support Vector Regression with hourly optimized hyper-parameters and Week clustering (with each hour of the day being a separate model), (7) a Support Vector Regression with Week clustering and Viterbi states used as covariates 107, 127, (8) an Error weighted ensemble, wherein the weights were assigned corresponding to the MAPE error from the previous day, and (9) an average ensemble, wherein the mean of all the predictions were calculated.

### Calculations for the Error Weighted Ensemble Algorithm

In the exemplary application, to calculate the weighted mean, MAPE errors of the previous day were used. In this exemplary application, the weights were taken on an exponential scale to distinguish one model from the other. Since the MAPE values observed were very close to each other, an exponential scale was used to penalize the bad performing models to a large extent and also to observe its effect in the ensemble.

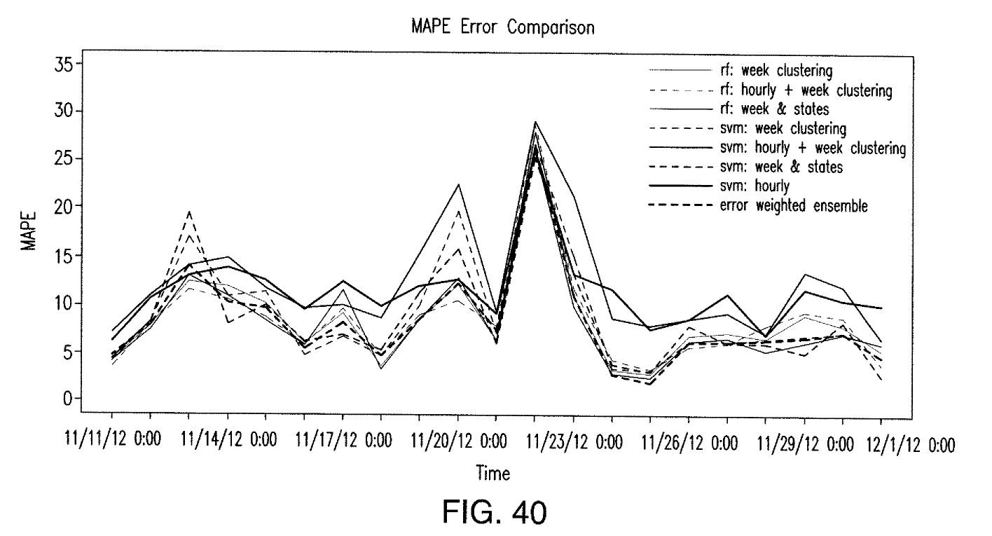

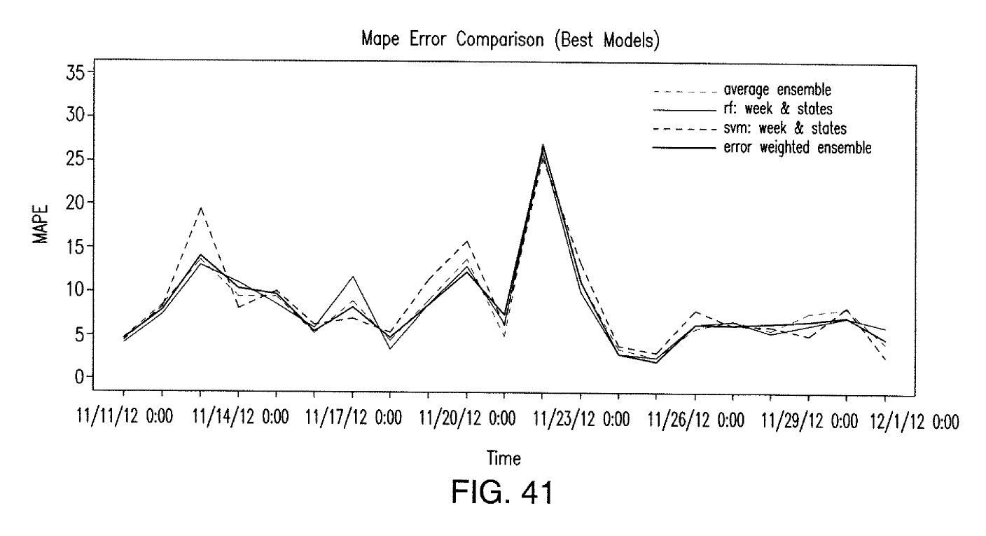

FIG. 40 is a graph that illustrates an experimental comparison plot of MAPE error for the different models and the base SVM hourly model from Nov. 11, 2012 to Dec. 1, 2012. FIG. 41 is a graph that illustrates an experimental comparison plot of MAPE error for the different performing models from Nov. 11, 2012 to Dec. 1, 2012. As seen in the FIG. 40 and FIG. 41. MAPE error plots that incorporate Viterbi-states & weekday clustering (obtained from HMMs) lead to significant performance improvement. FIG. 41 illustrates the error scores from the better performing models. The Error Weighted Ensemble Algorithm performs equally well.

### 2) Improvement Over the Support Vector Machine Regression (SVR) Model Using a SVR Model Along with a Hidden Markov Model (HMM) and Ensemble Regression Trees (GBR) Models

For purpose of illustration and not limitation, an exemplary application of the disclosed subject matter will now be described. In this example application, the improvement of performance over a Support Vector Machine regression (SVR) model was analyzed. A combination of an SVR model and a Hidden Markov Model (HMM) was tested and demonstrated an improvement over the SVR model. Additionally, a combination of Ensemble Regression Trees, such as a Gradient Boosted Regression Trees (GBR) model, with a HMM, and a SVR model was tested. This combination demonstrated improvement in prediction of forecasts. It can be understood that a GBR model can have similar performance to a Random Forest model since both models are tree based ensembles. As such, using an ensemble of ML algorithms, such as SVR, HMM, GBR, and the like can provide the power of ensemble machine learning to provide an improved forecast.

### Data

In this exemplary application, first the model was tested for the first two weeks of April 2013. To prepare the data, a Gaussian Hidden Markov Model (GHMM) was used to fit a time sequence of load and weather. Once the model was fitted, the load, weather, and time-of-day data were assigned to a specific latent state using the Viterbi algorithm. Then, by removing the load dimension from transition matrices, another GHMM model was obtained that contained only the weather data. In the HMM model, which contains multidimensional transition matrices, removing the load dimension can be understood as slicing off one dimension. The load data was removed from the model using an assumption that the variables are Gaussian and therefore independently and identically distributed (iid). The state sequence was predicted using a second GHMM model by (1) fitting weather forecast data and (2) applying Viterbi algorithm to it. The historical data was then scanned for similar state sequences. The load curves associated with the predicted state sequence were then used to choose the a Machine Learning algorithm, for example, a better Machine Learning algorithm. The same set of load curves were also used to train for prediction using the algorithm. This time period for data was chosen because there can be a transition in season and the humidex can hit an 80 degree mark.

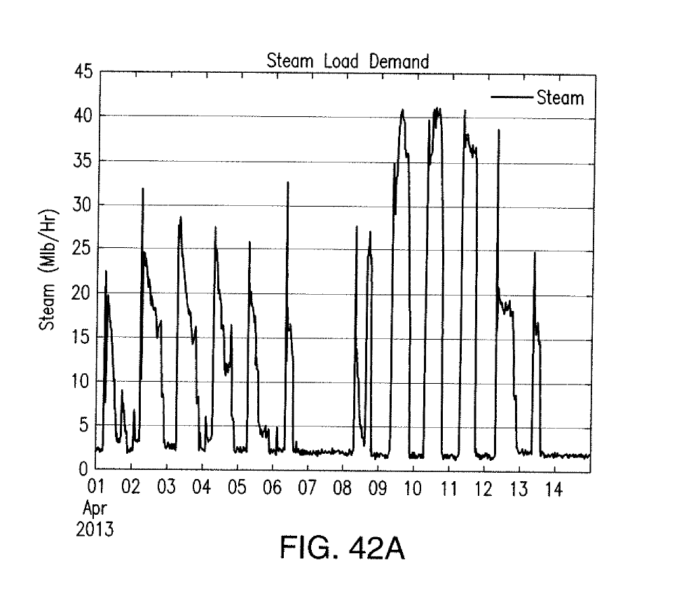

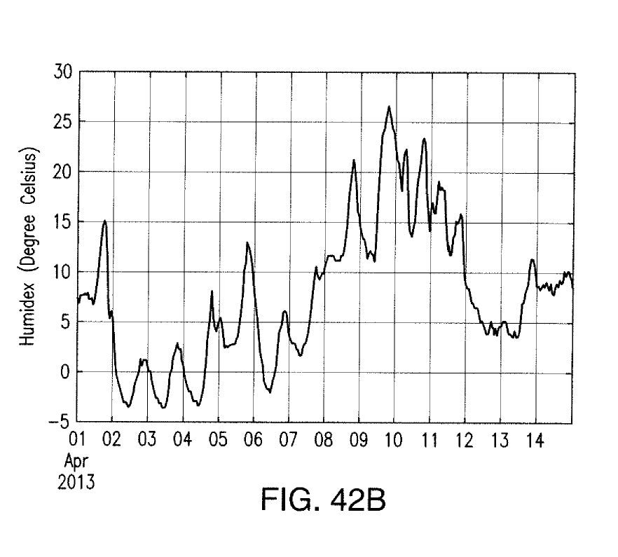

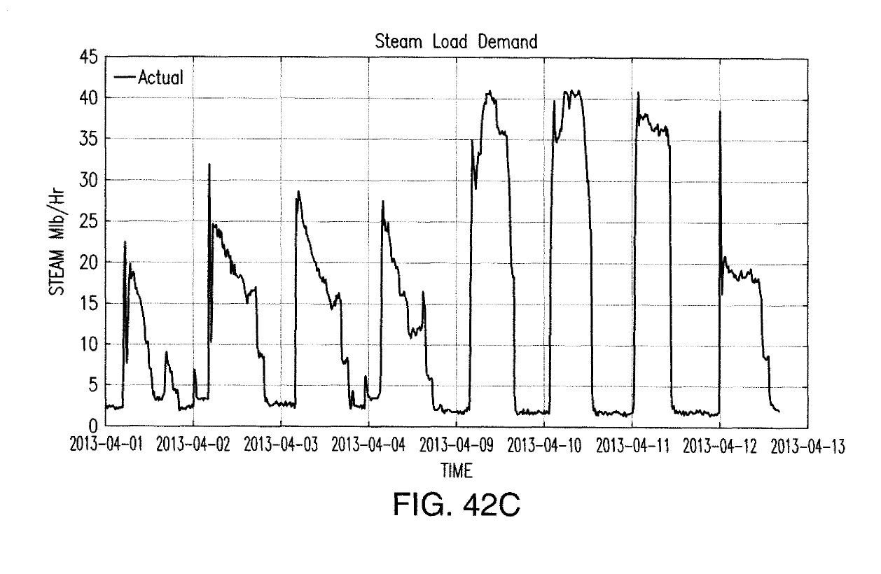

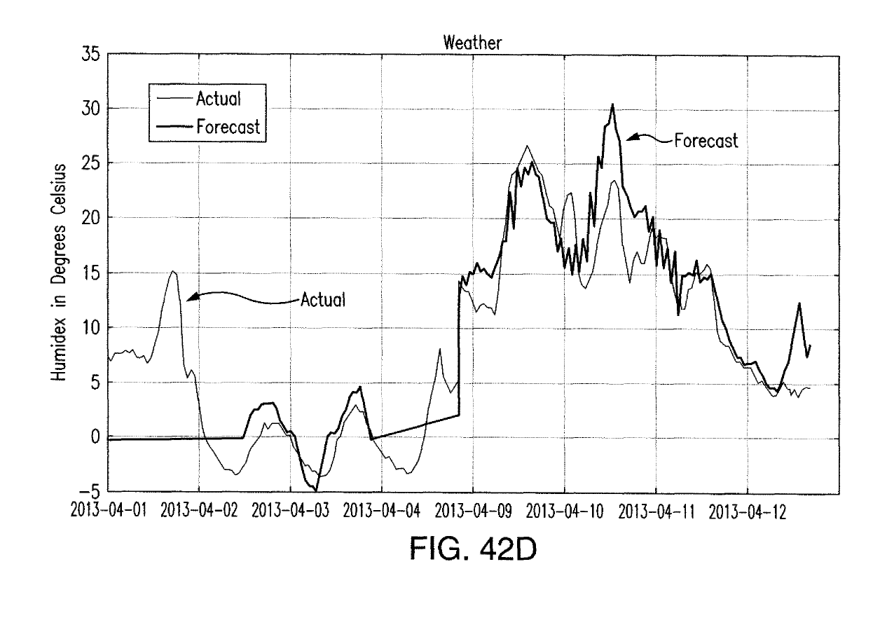

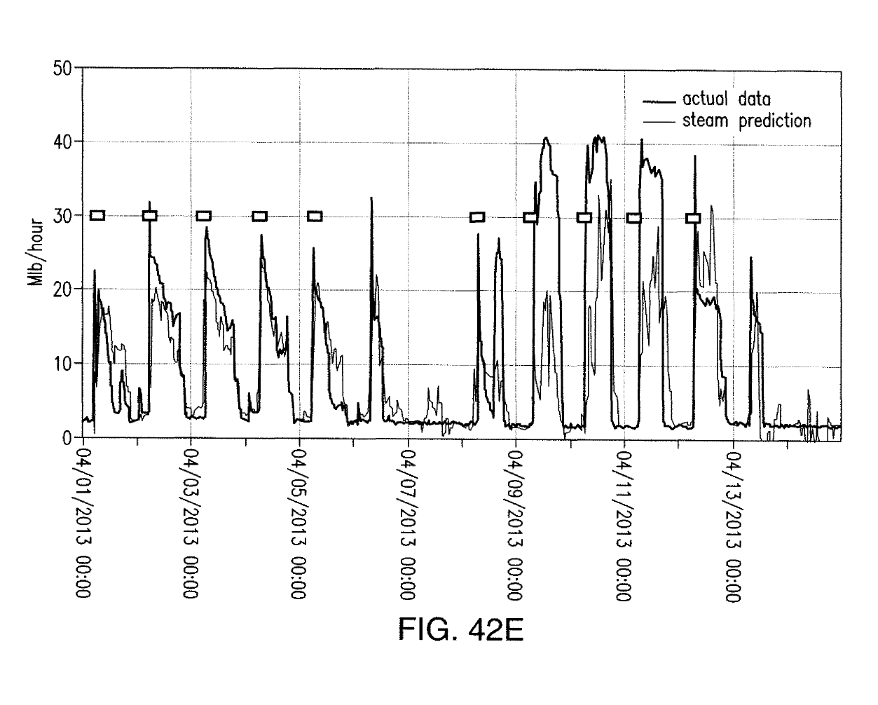

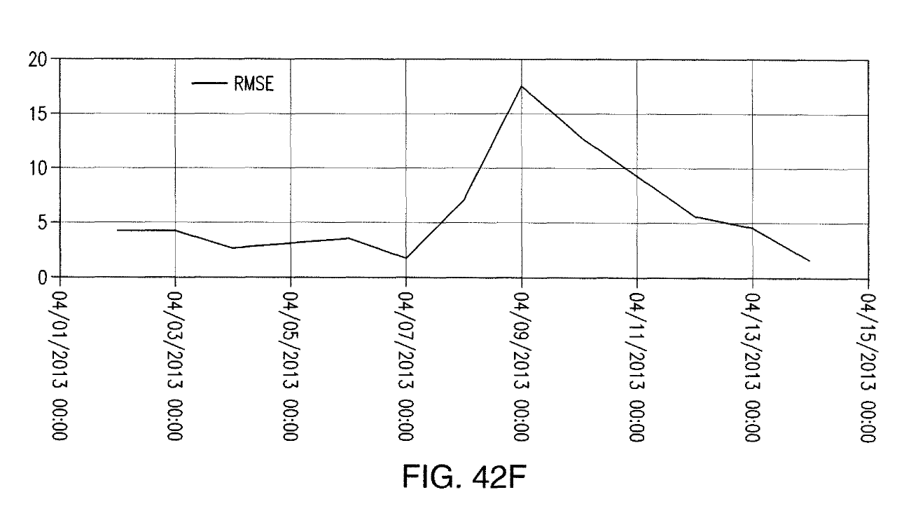

FIG. 42A is a graph that illustrates an exemplary plot of the steam load demand during the first two weeks of April 2013. FIG. 42B is a graph illustrating the change in weather during the time the data collected. As FIG. 42A and FIG. 42B illustrate there is a transition in the season as seen in the change in humidex value during the first two week of April 2013. As seen in FIG. 42A and FIG. 42B, there is a change in weather from Apr. 9, 2013 onwards—which can lead to a change in steam consumption pattern. This change can be attributed to cooling & air-conditioning in the building after it hits a certain temperature.

FIG. 42C is a graph that illustrates an exemplary plot of the steam load demand during weekdays (Monday-Thursday). In this exemplary application, the data from Friday was not included because the data from Fridays can be erratic. FIG. 42D is a graph that illustrates an exemplary plot of the weather during weekdays (Monday-Thursday). In this exemplary application, the graph only plots Weekdays (Monday-Thursday) because only weekday data was observed. As FIG. 42C and FIG. 42D further illustrate, the steam demand on April 9th and 10th was much higher, and these days are the first days of the season where cooling systems were deployed in the building.

### Analysis of Data

Prediction from Support Vector Regression (SVR) Model

Performance of the current machine learning system was guided by steam demand from the nearby recent days and/or weeks. This resulted in lower errors within a season, but higher errors when there was a change in the season or a sudden change in the weather conditions. FIG. 42E is a graph that illustrates an experimental comparison plot of the steam prediction with respect to the actual data. FIG. 42F is a graph that illustrates an experimental plot of the Root Mean Square Error (RMSE).

### Combination of Hidden Markov Model (HMM) and SVR Model

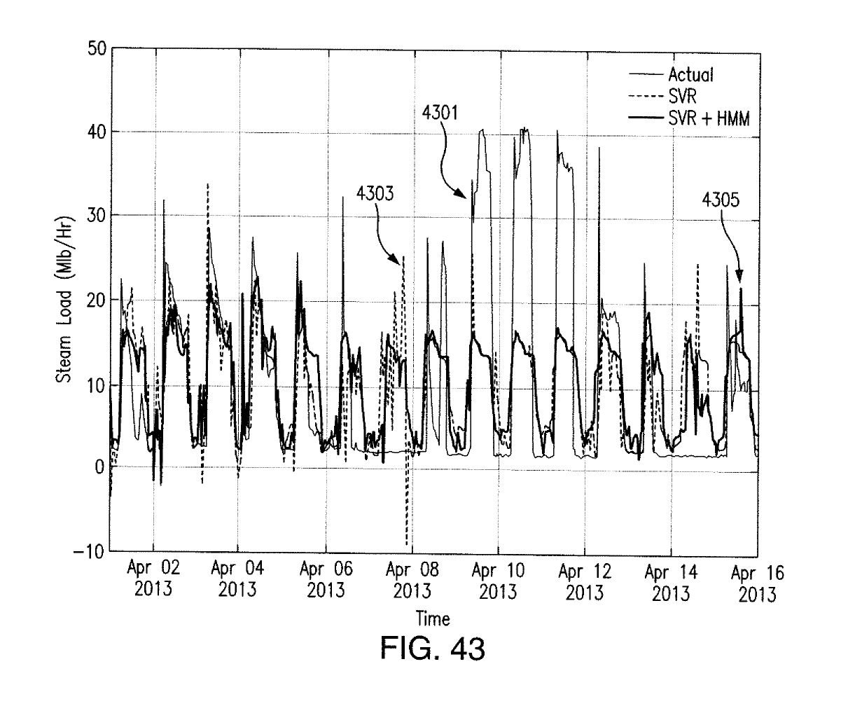

A combination of the HMM and SVR model was tested against the data collected. The combination of HMM and SVR did not appear to be able to forecast steam consumption from warm days. FIG. 43 is a graph that illustrates an experimental comparison plot forecast using a combination of the HMM and the SVR model (4305) with respect to the SVR model (4303) and actual (4301). As FIG. 43 illustrates the combination of the HMM and SVR model was not able to forecast the steam consumption from warm days at left to 3 days at right of center. FIG. 43 also illustrates the forecast of a combination of the HMM and SVR model is better than the forecast using an SVR model alone.

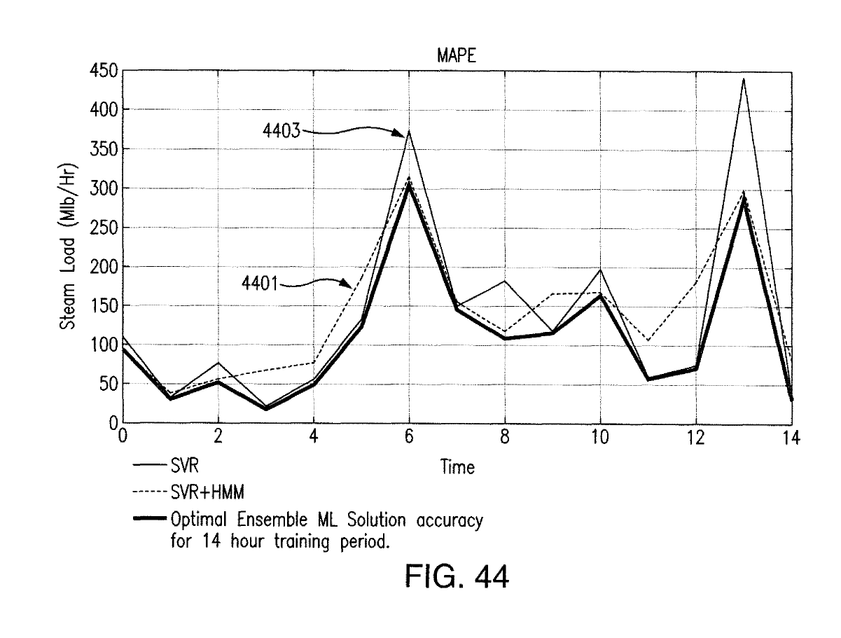

FIG. 44 is a graph that illustrates an experimental comparison of the improvement of a combination of HMM and SVR models (4401) over using an SVR model alone (4403). FIG. 44 is a plot of the Mean Average Percent Error (MAPE) of the forecast from SVR model alone and a combination of the HMM and SVR model and the optimal ensemble ML solution. FIG. 44 further illustrates that using predicted states to learn seasonal drift can lead to significant performance improvement. It can be understood that this exemplary application not only uses states as covariates, but also chooses the training data based on that. In this exemplary application, the ensemble relies on multiple models to forecast a better prediction. In another exemplary application, the ensemble can be chosen from multiple models using the predicted states.

### Combination of Gradient Boosted Regression Trees (GBR) and HMM Model

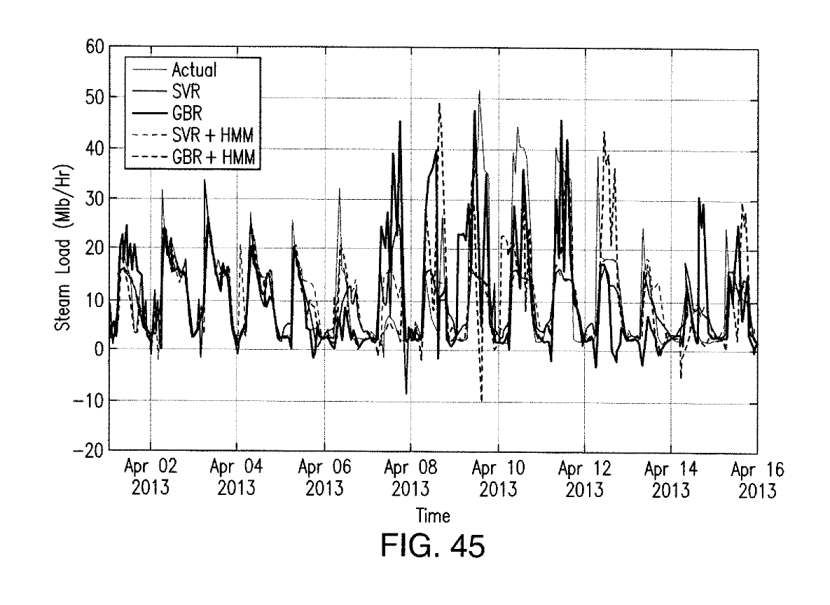

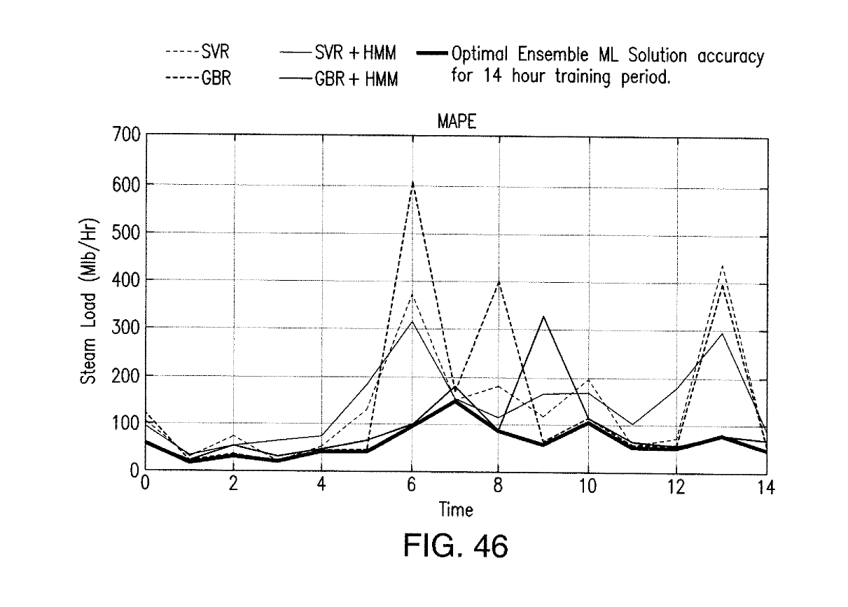

Since predicted states can help to learn seasonal drift and improve performance, Gradient Boosted Regression Trees (GBR) was tested along with HMMs. This combination demonstrated an improvement in the prediction accuracy. It can be understood that the ensemble of algorithms can be chosen from a combination of other machine learning models as well. Furthermore, the trade-off between training time and accuracy is non-trivial in this case. FIG. 45 is a graph that illustrates an experimental comparison plot of forecast using a combination of the Gradient Boosted Regression Trees (GBR) and HMM model with respect to a SVR and HMM model, a SCR model, a GBR model and the actual data. FIG. 46 is a graph that illustrates an experimental comparison plot of the Mean Average Percent Error (MAPE) of the forecast from SVR model alone, GBR alone, a combination of the HMM and SVR model, and a combination of the GBR and the HMM model and the optimal ensemble ML solution.

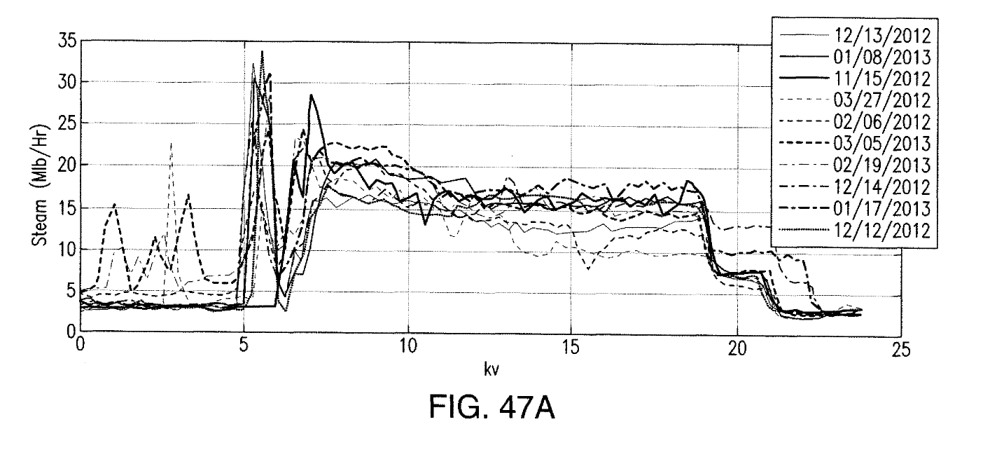

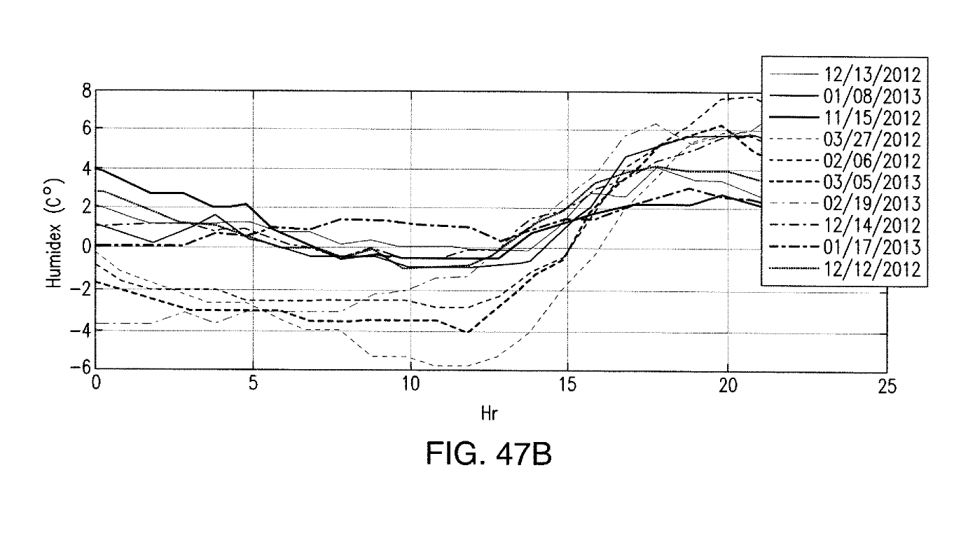

FIG. 47A and FIG. 47B are graphs that illustrate an experimental comparison of training data on Apr. 4, 2013. FIG. 47A is a graph that illustrates the historical steam load based on latent states on Apr. 4, 2013. FIG. 47B is a graph that illustrates the historical weather based on latent states on Apr. 4, 2013. As FIG. 47A and FIG. 47B illustrate, the hidden state model and predicting steam consumption for the given data can be identified. In this exemplary application, the latent states predicted from the HMM model as described above are used to generate the training data. FIG. 47A and FIG. 47B further illustrate that the output from the model that is a sequence of states predicted for next 24 hours was used to identify the days from the past that have similar sequence of states.

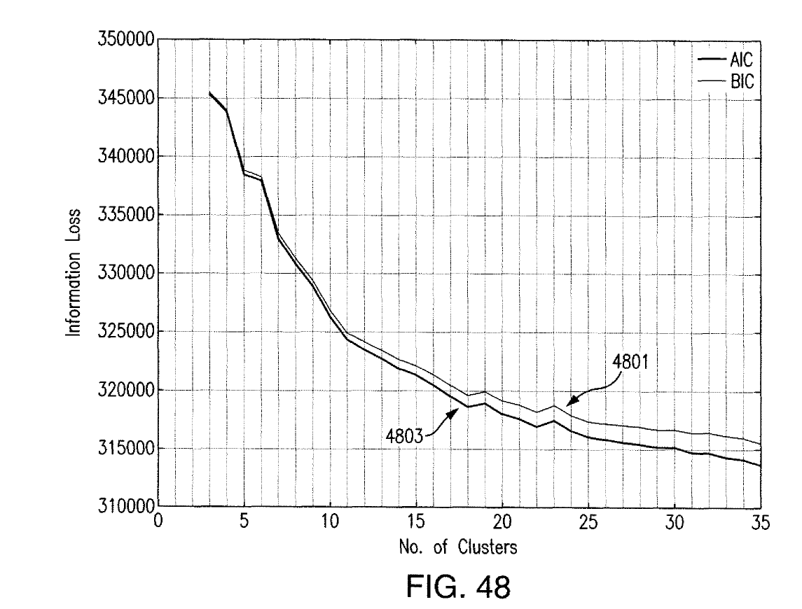

FIG. 48 is a graph that illustrates an experimental comparison plot of the AIC (4803) and BIC (4801) curves. The AIC and BIC can be used to define the information loss that occurs with added complexity to the model. By spotting elbows in this curve, the optimal number of clusters can be obtained. As FIG. 48 illustrates, there are multiple elbows in the graph and therefore there does not seem to be a single optimal number of clusters. The number of clusters that do stand out in FIG. 48 are 11, 18, and 23.

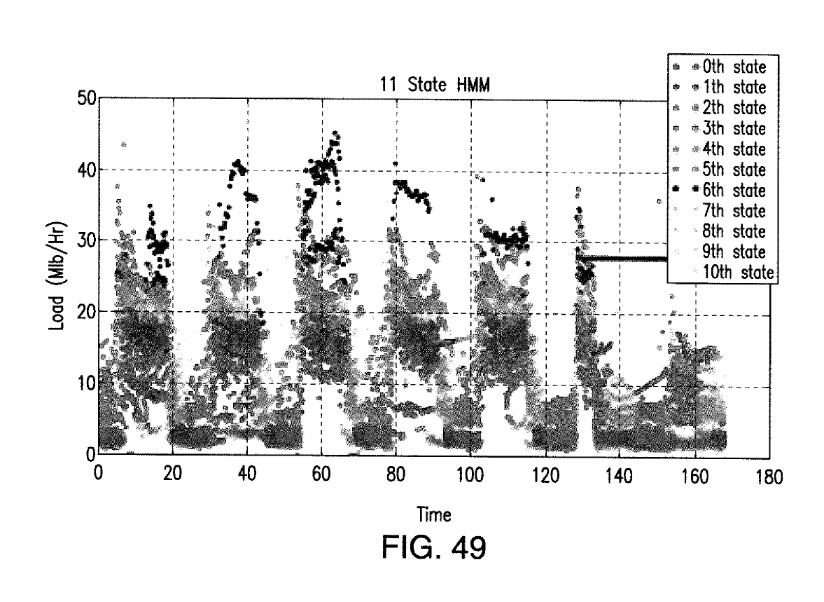

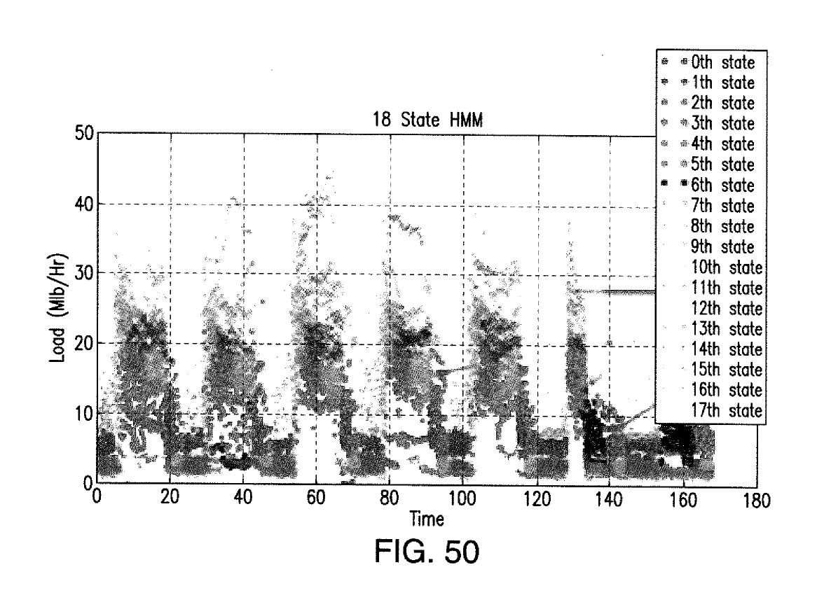

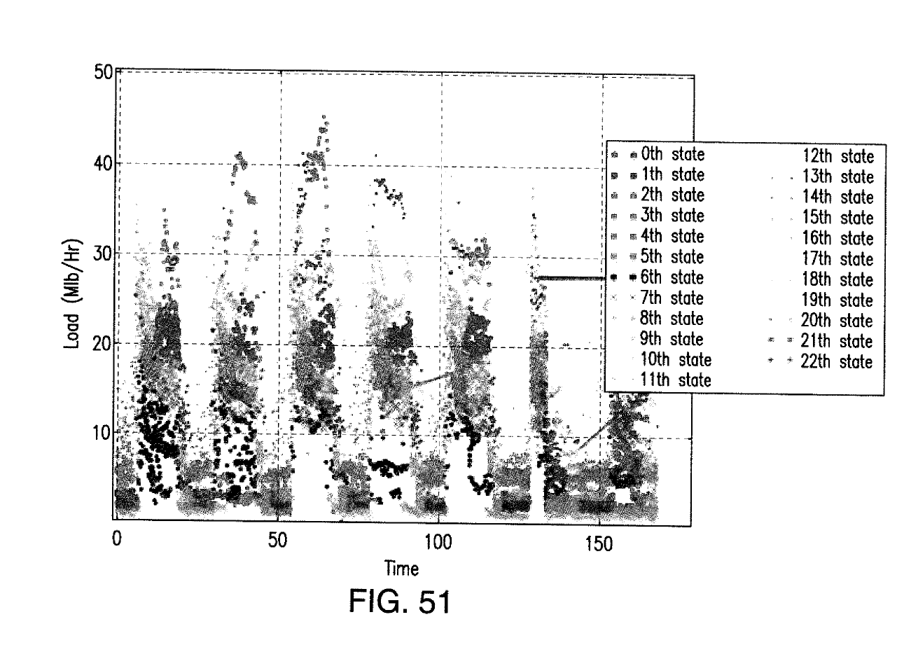

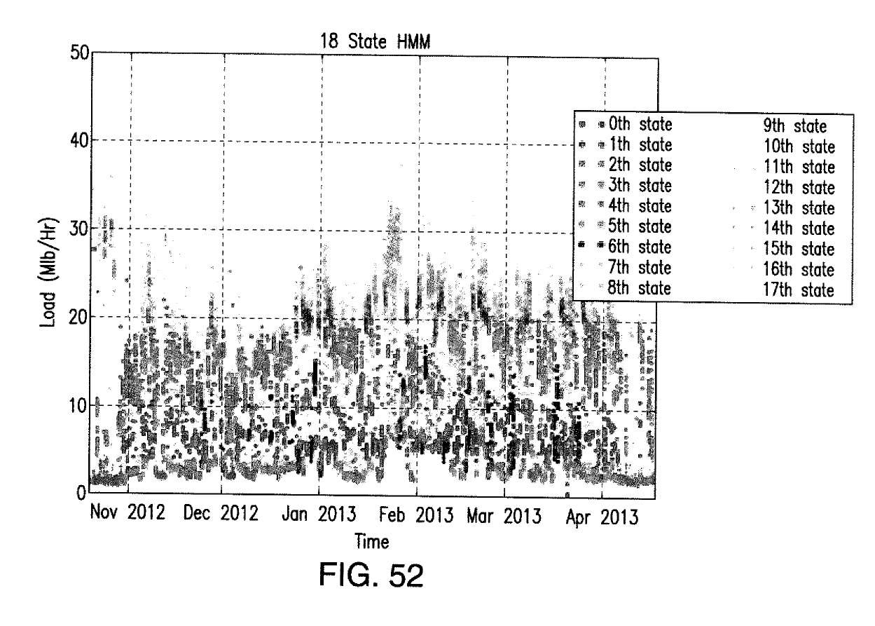

FIG. 49 is a graph that illustrates an experimental fitting HMM plotted using 11 hidden states. FIG. 50 is a graph that illustrates an experimental fitting HMM plotted using 18 hidden states. FIG. 51 is a graph that illustrates an experimental fitting HMM plotted using 23 hidden states. FIG. 52 is a graph that illustrates an experimental unrolling the plot of the 18 hidden states. As FIG. 52 illustrates, unrolling the 18 state plot so that the full time span of the data is displayed reveals useful structure and seasonality that can prove useful for better forecasting using an ensemble of machine learning models.

### Ensemble of ML Algorithms Based on Hidden Markov Model (HMM) States

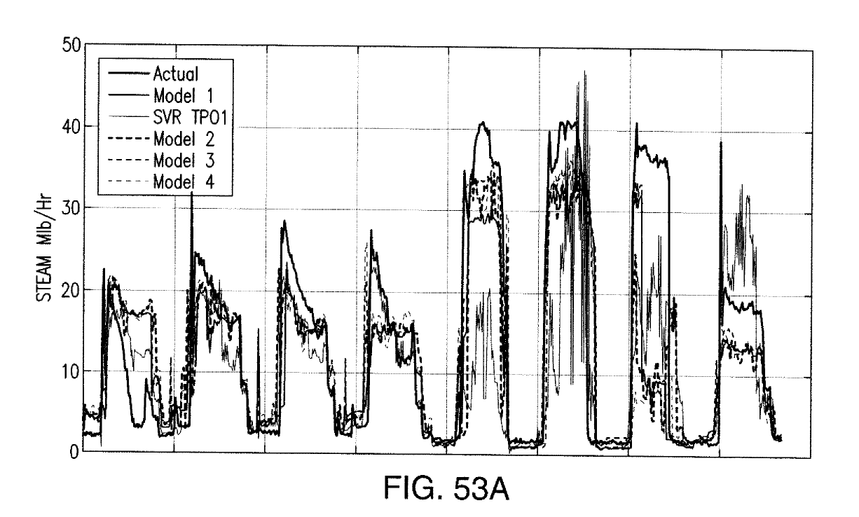

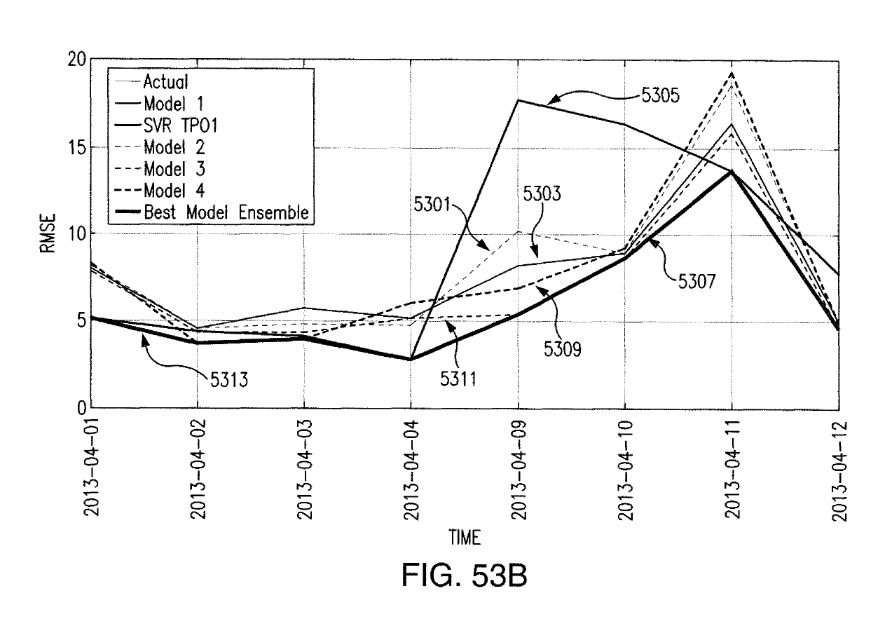

Unlike the SVR model, the models based on the HMM states learn from the days that have similar latent state sequence. These models are further described in detail below. This sequence can be obtained by fitting HMMs to each day and predicting the state-sequence for the next day. The ensemble can also choose a model, for example, the best model, from a set of models. FIG. 53A is a graph that illustrates an experimental comparison prediction plot of the SVR model and the models based on the HMM states learned from the days that have similar latent state sequence and actual. FIG. 53B is a graph that illustrates an experimental comparison error (RMSE) plot of the SVR model and the models based on the HMM states learned from the days that have similar latent state sequence (5301 (Model 2), 5303 (Model 1), 5305 (SVR TPO1), 5307 (Better Model Ensemble), 5309 (Model 4), 5311 (Model 3), and Actual (5313)).

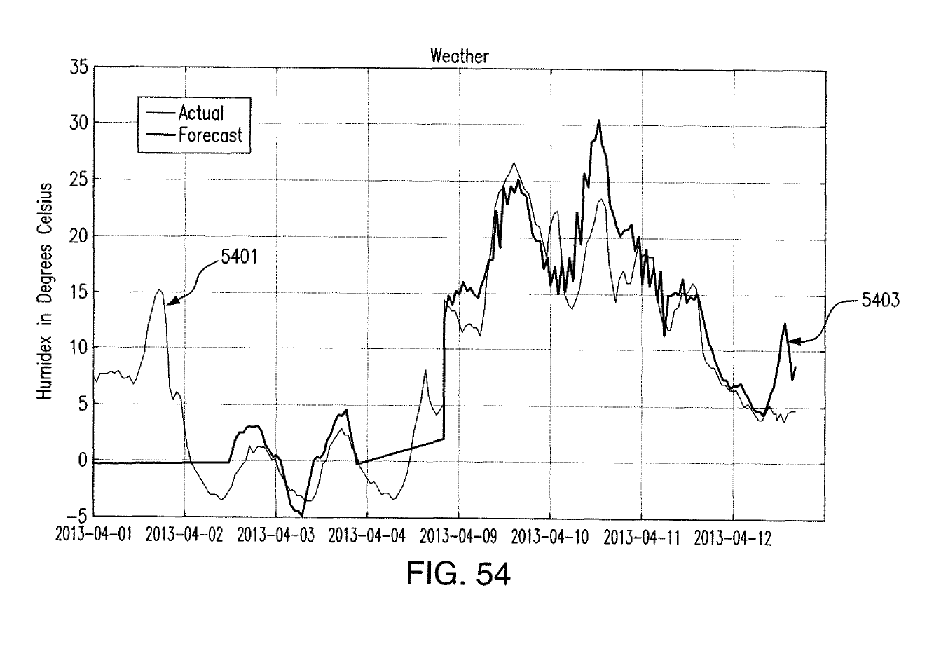

The Root Mean Square Error (RMSE) was significantly higher than the rest of the days using the ensemble model. This error can occur because the weather on April 11th is much cooler than April 9th or 10th. Therefore, a part of error can be either attributed to building engineers following the same pattern as the previous two days or some operational changes in the building that lead to unexpected steam demand. FIG. 54 is a graph that illustrates an experimental plot of the humidex during the first two week of April 2013. As FIG. 54 illustrates, there is a difference in the humidex forecast (5403) and the observed humidex (5401) on Apr. 10, 2013 and Apr. 11, 2013.

Model 1: Tree Ensemble with Latent State Covariates

Data used for training the model can be derived from predicted latent state sequence. An example for such training data is described below. Model 1 is a tree ensemble and the covariates include latent state sequence.

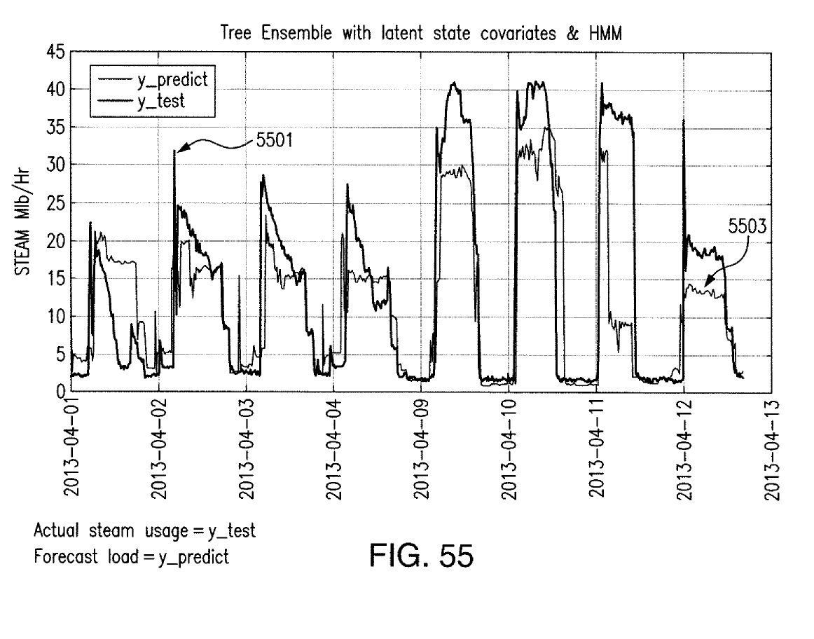

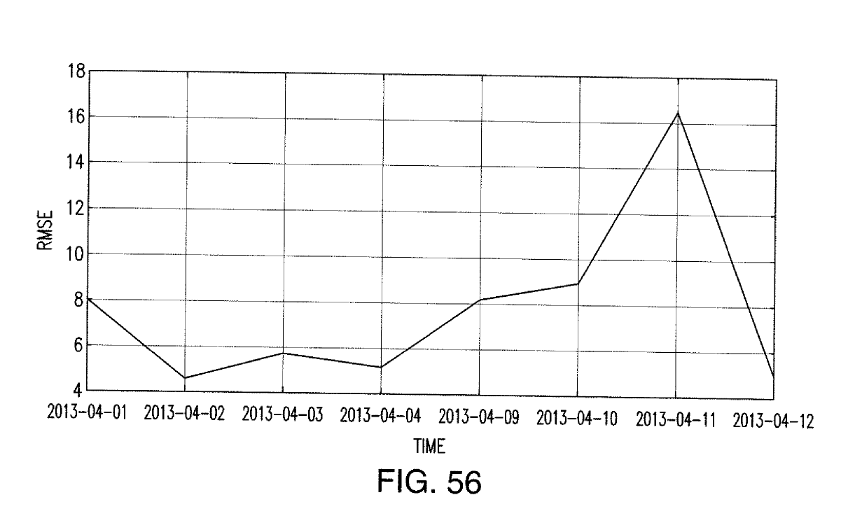

FIG. 55 is a graph that illustrates an experimental comparison prediction plot of the actual load (5501) with respect to the forecast data from the Tree Ensemble model with latent states covariates and an HMM model (5503). FIG. 56 is a graph that illustrates an experimental comparison error (RMSE) plot of the Tree=Ensemble model with latent states covariates and an HMM model.

Model 2: Tree Ensemble with Hourly Prediction

Model 2 is similar to Model 1. There are no latent state covariates in Model 2. Furthermore, model 2 is an hourly model i.e., there is a different model for every hour.

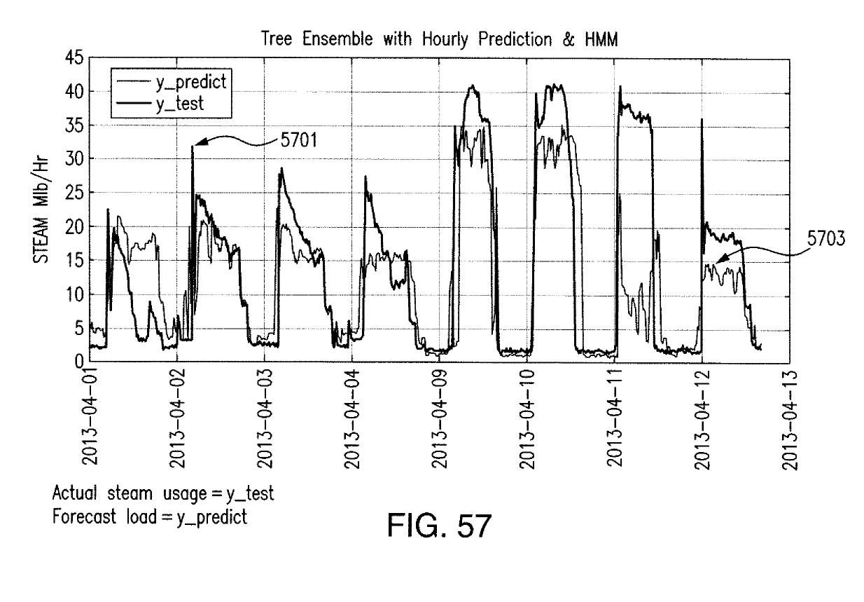

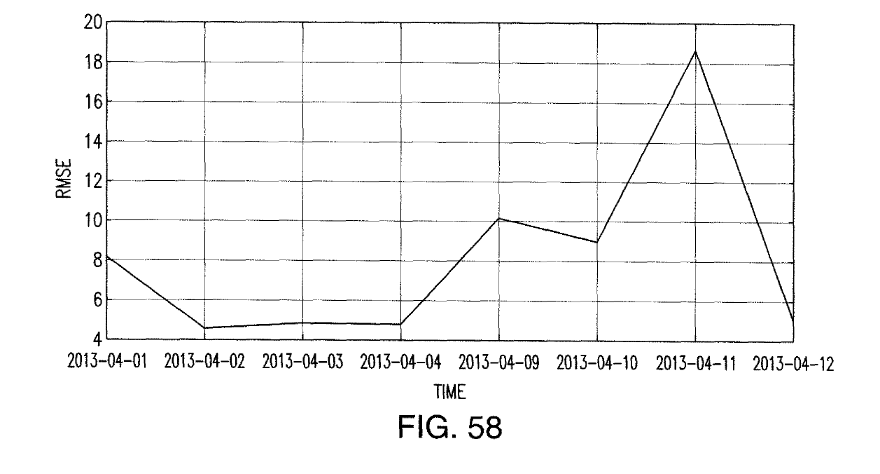

FIG. 57 is a graph that illustrates an experimental comparison prediction plot of the actual data (5701) with respect to the forecast data from a Tree Ensemble model an hourly prediction (5703). FIG. 58 is a graph that illustrates an experimental comparison error (RMSE) plot of the Tree Ensemble model an hourly prediction.

Model 3: Tree Ensemble with Latent State Covariates and Number of Day Cross-Validation

Model 3 is similar to Model 1. In Model 3, the number of days of training data used is cross-validated.

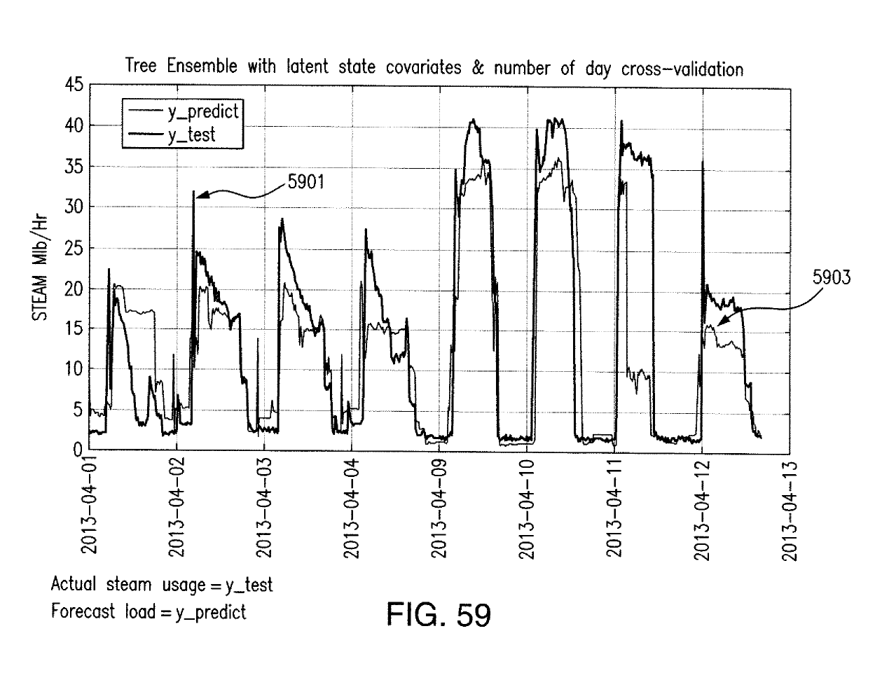

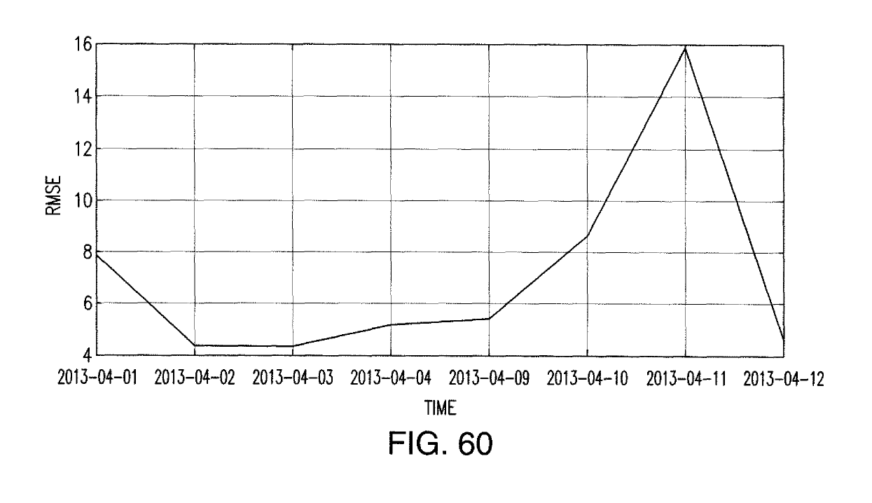

FIG. 59 is a graph that illustrates an experimental comparison prediction plot of the actual data (5901) with respect to the forecast data from a Tree Ensemble with latent state covariates and number of day cross-validation (5903). FIG. 60 is a graph that illustrates an experimental comparison error (RMSE) plot of the Tree Ensemble with latent state covariates and number of day cross-validation.

Model 4: Tree Ensemble with Hourly Prediction, Latent State Covariates & HMM

Model 3 is similar to Model 1. Model 4 creates a model for every hour of the day.

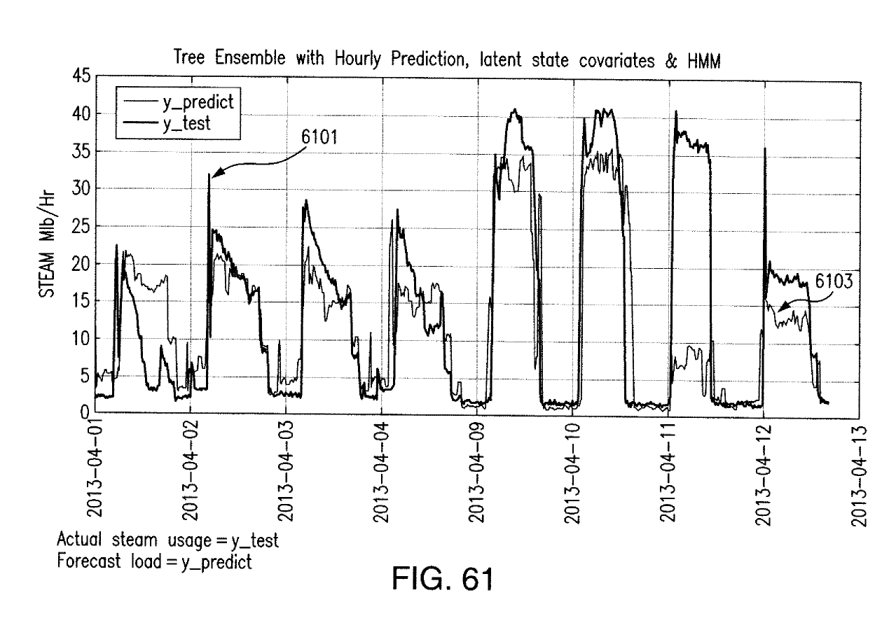

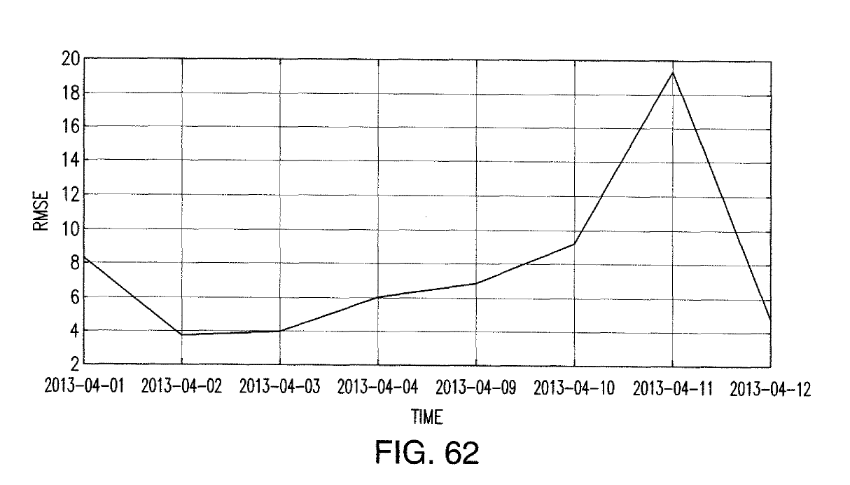

FIG. 61 is a graph that illustrates an experimental comparison prediction plot of the actual data (6101) with respect to the forecast data from a Tree Ensemble with hourly prediction, latent state covariates & HMM (6103). FIG. 62 is a graph that illustrates an experimental comparison error (RMSE) plot of the Tree Ensemble with hourly prediction, latent state covariates & HMM.

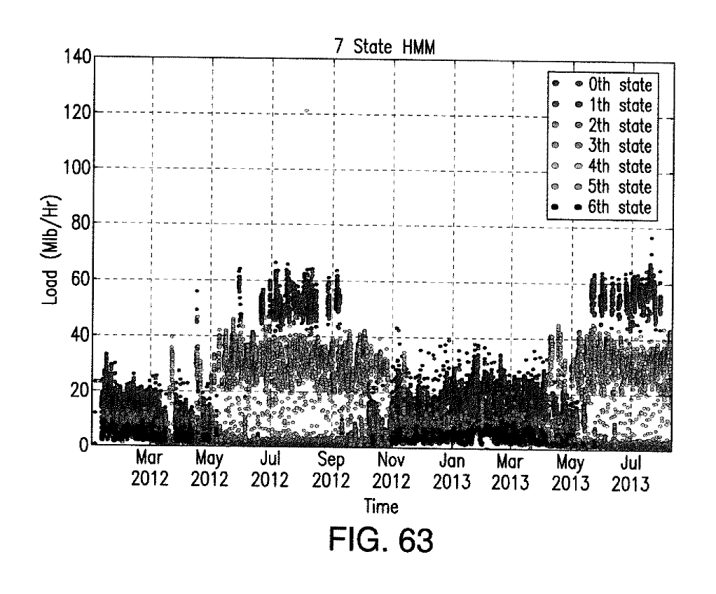

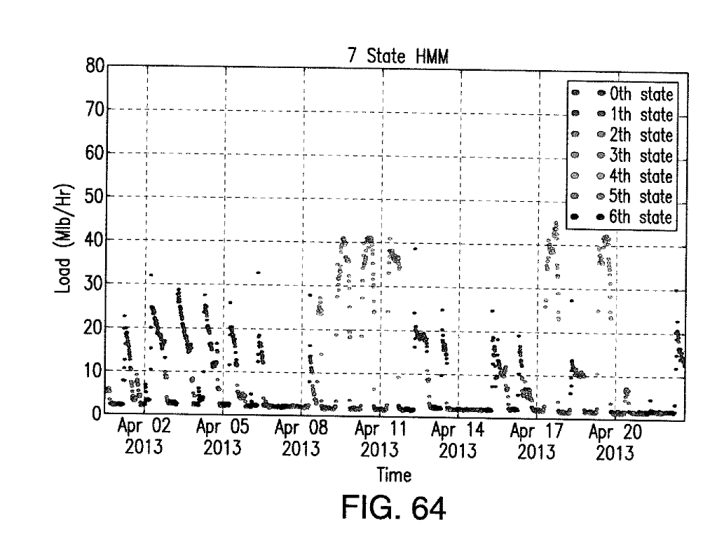

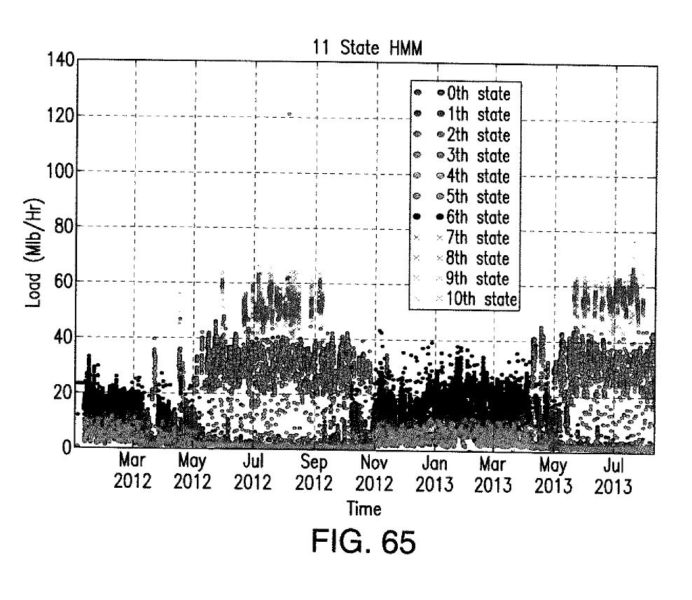

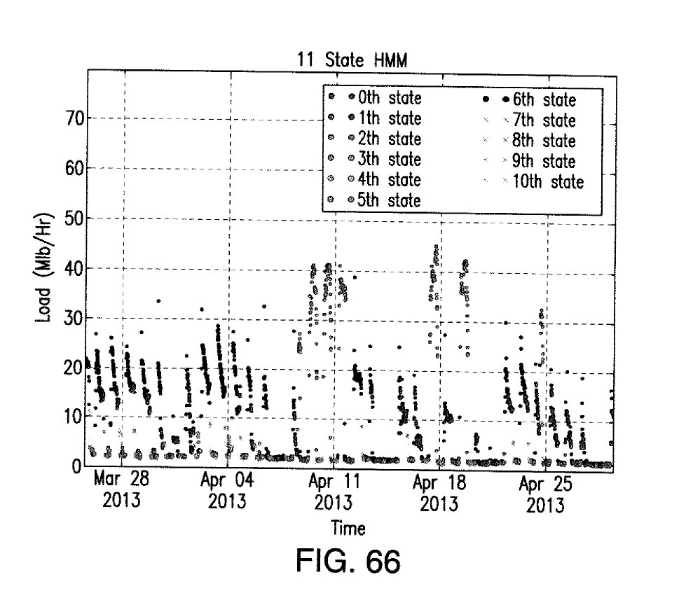

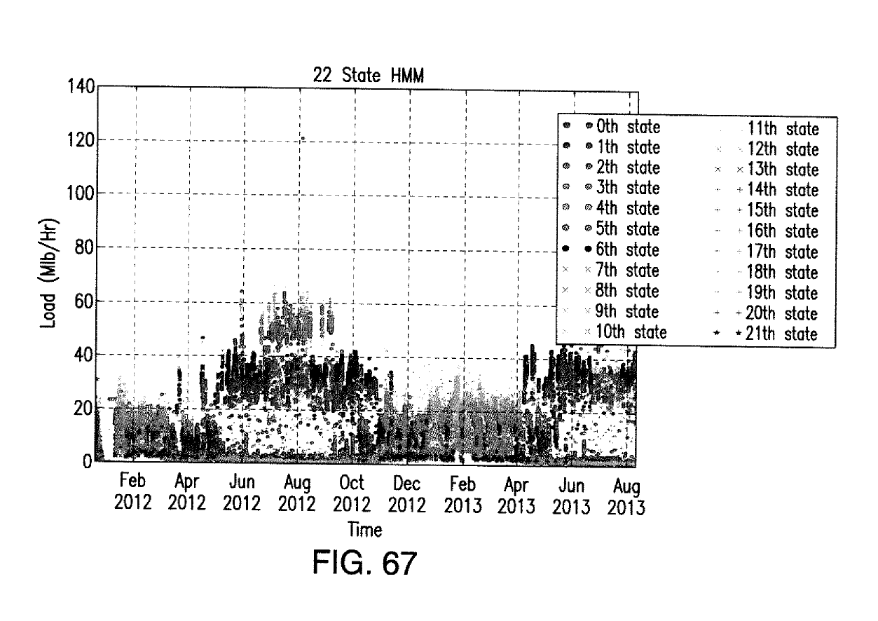

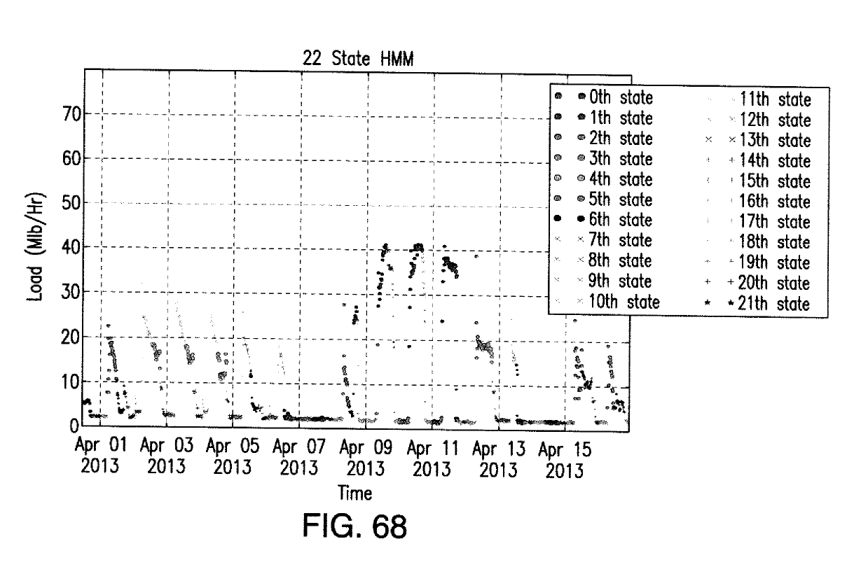

FIG. 63 is a graph that illustrates an experimental fitted HMM plotted using 7 states. FIG. 64 is a graph that illustrates an experimental plot that is a zoomed in view of FIG. 63 for the first two weeks of April. FIG. 65 is a graph that illustrates an experimental fitted HMM plotted using 11 states. FIG. 66 is a graph that illustrates an experimental plot that is a zoomed in view of FIG. 65 for the first two weeks of April. FIG. 67 is a graph that illustrates an experimental fitted HMM plotted using 22 states. FIG. 68 is a graph that illustrates an experimental plot that is a zoomed in view of FIG. 67 for the first two weeks of April.

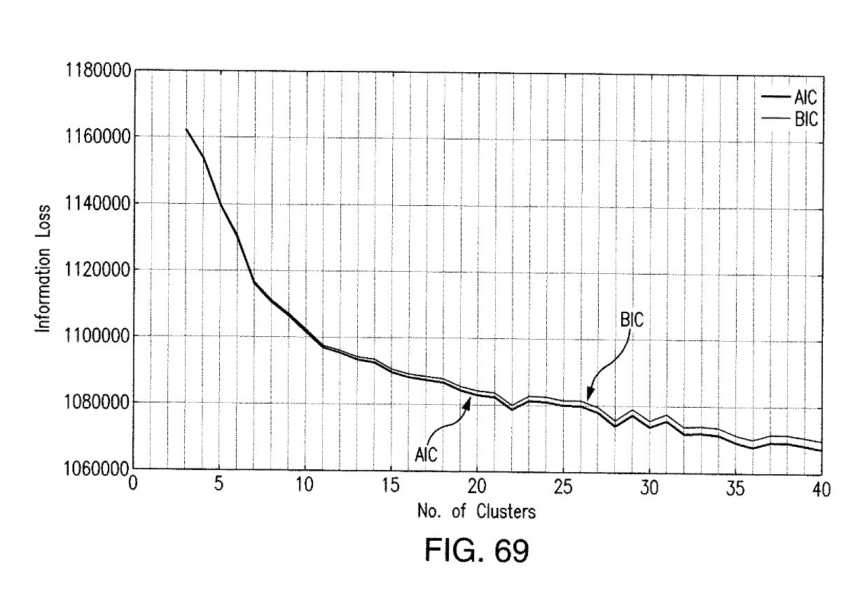

FIG. 69 is a graph that illustrates an experimental comparison elbow plot of the AIC and BIC curves. An elbow plot can be used to determine the number of latent states. The larger the number of states, the more information the model contains. However, the information gain can come at a computational cost. Optimal number of states can be obtained by looking at the elbow plot. The plot can depict the information loss for every number of states. The elbows are the points where the information gain is not substantial enough to increase the number of states. As FIG. 69 illustrates, there are multiple elbows in the plot above.

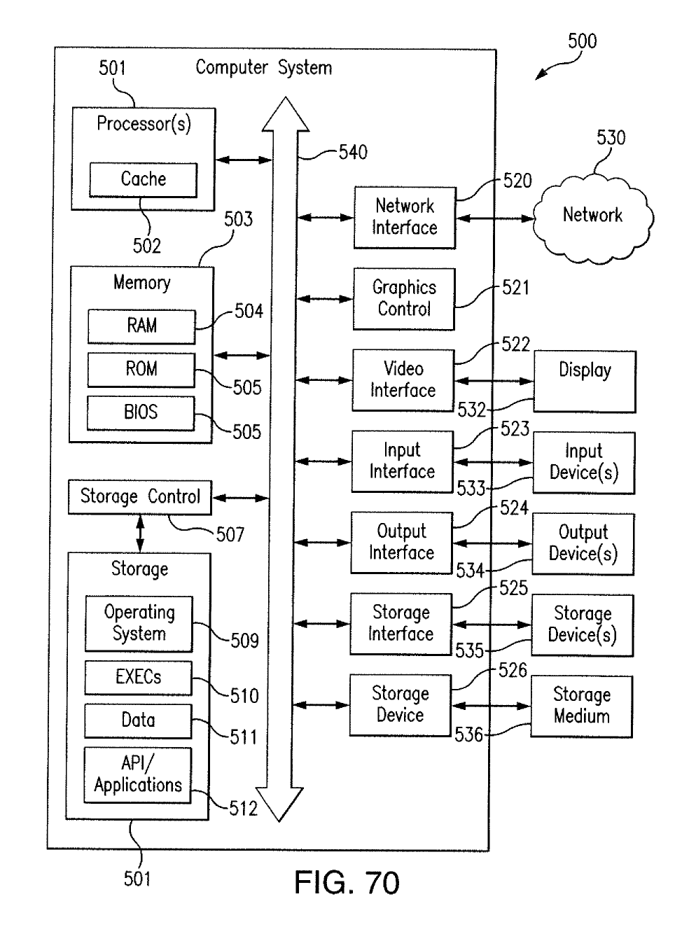

The methods for determining forecast information for a facility and one or more electrical vehicles described above can be implemented as computer software using computer-readable instructions and physically stored in computer-readable medium. The computer software can be encoded using any suitable computer languages. The software instructions can be executed on various types of computers. For example, FIG. 70 illustrates a computer system 500 suitable for implementing embodiments of the present disclosure.

The components shown in FIG. 70 for computer system 500 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. It can be understood that a computer system 500 can be incorporated in the MLFS 213 or the dynamic scheduler 141. Computer system 500 can have many physical forms including an integrated circuit, a printed circuit board, a small handheld device (such as a mobile telephone or PDA), a personal computer or a super computer.

Computer system 500 includes a display 532, one or more input devices 533 (e.g., keypad, keyboard, mouse, stylus, etc.), one or more output devices 534 (e.g., speaker), one or more storage devices 535, various types of storage medium 536.

The system bus 540 links a wide variety of subsystems. As understood by those skilled in the art, a “bus” refers to a plurality of digital signal lines serving a common function. The system bus 540 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 501 (also referred to as central processing units, or CPUs) optionally contain a cache memory unit 502 for temporary local storage of instructions, data, or computer addresses. Processor(s) 501 are coupled to storage devices including memory 503. Memory 503 includes random access memory (RAM) 504 and read-only memory (ROM) 505. As is well known in the art, ROM 505 acts to transfer data and instructions uni-directionally to the processor(s) 501, and RAM 504 is used typically to transfer data and instructions in a bi-directional manner. Both of these types of memories can include any suitable of the computer-readable media described below.

A fixed storage 508 is also coupled bi-directionally to the processor(s) 501, optionally via storage control unit 507. It provides additional data storage capacity and can also include any of the computer-readable media described below. Storage 508 can be used to store operating system 509, EXECs 510, application programs 512, data 511 and the like and is typically a secondary storage medium (such as a hard disk) that is slower than primary storage. It should be appreciated that the information retained within storage 508, can, in appropriate cases, be incorporated in standard fashion as virtual memory in memory 503.

Processor(s) 501 is also coupled to a variety of interfaces such as graphics control 521, video interface 522, input interface 523, output interface, storage interface, and these interfaces in turn are coupled to the appropriate devices. In general, an input/output device can be any of video displays, track balls, mice, keyboards, microphones, touch-sensitive displays, transducer card readers, magnetic or paper tape readers, tablets, styluses, voice or handwriting recognizers, biometrics readers, or other computers. Processor(s) 501 can be coupled to another computer or telecommunications network 530 using network interface 520. With such a network interface 520, it is contemplated that the CPU 501 can receive information from the network 530, or can output information to the network in the course of performing the above-described method. Furthermore, method embodiments of the present disclosure can execute solely upon CPU 501 or can execute over a network 530 such as the Internet in conjunction with a remote CPU 501 that shares a portion of the processing.

According to various embodiments, when in a network environment, i.e., when computer system 500 is connected to network 530, computer system 500 can communicate with other devices that are also connected to network 530.

Communications can be sent to and from computer system 500 via network interface 520. For example, incoming communications, such as a request or a response from another device, in the form of one or more packets, can be received from network 530 at network interface 520 and stored in selected sections in memory 503 for processing. Outgoing communications, such as a request or a response to another device, again in the form of one or more packets, can also be stored in selected sections in memory 503 and sent out to network 530 at network interface 520. Processor(s) 501 can access these communication packets stored in memory 503 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

As an example and not by way of limitation, the computer system having architecture 500 can provide functionality as a result of processor(s) 501 executing software embodied in one or more tangible, computer-readable media, such as memory 503. The software implementing various embodiments of the present disclosure can be stored in memory 503 and executed by processor(s) 501. A computer-readable medium can include one or more memory devices, according to particular needs. Memory 503 can read the software from one or more other computer-readable media, such as mass storage device(s) 535 or from one or more other sources via communication interface. The software can cause processor(s) 501 to execute particular processes or particular parts of particular processes described herein, including defining data structures stored in memory 503 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosed subject matter. It should also be noted that there are many alternative ways of implementing the methods and apparatuses of the disclosed subject matter

1. A method for determining forecast information for a resource, the method comprising:
receiving data related to the resource;
defining one or more predictor variables from at least a portion of the data;
generating the forecast information, including:
generating one or more optimized learning model parameters based at least in part on the one or more predictor variables;
using one or more forecasting models to generate the forecast information based at least in part on the one or more optimized learning model parameters; and
identifying one or more actions based at least in part on the forecast information.

2. The method of claim 1, wherein the resource includes at least one of package volume for a distribution facility, steam consumption for a building, and energy consumption for the building.

3. The method of claim 1, wherein the resource includes at least one of energy consumption for a distribution facility, one or more electrical delivery vehicles, and one or more chargers.

4. The method of claim 1, further comprising using the forecast information to schedule the one or more actions.

5. The method of claim 1, wherein the data includes one or more of data related to a distribution facility, data related to one or more electrical delivery vehicles comprise stored data, and data related to one or more chargers.

6. The method of claim 5, wherein the data is related to the distribution facility, one or more chargers, one or more electrical delivery vehicles, weather forecast, economic indices, historical electric resource, actual weather data, incoming delivery package volumes, and outgoing delivery package volumes.

7. The method of claim 5, further comprising providing updated data, wherein the updated data includes one or more of building resources data, actual weather data, electric vehicle charging profile data and data from the one or more chargers.

8. The method of claim 1, wherein generating the one or more optimized learning model parameters further comprises using one or more optimization techniques to generate the one or more optimized learning model parameters.

9. The method of claim 8, wherein the one or more optimization techniques include one or more of grid search and cross validation.

10. The method of claim 1, wherein the one or more forecasting models include one or more of Support Vector Machine Regression, neural networks and Bayesian additive regression trees, Artificial Neural Networks, time series models, Random forest regression, Gradient Boosted Regression Trees, Hidden Markov Model, Gaussian Hidden Markov Model, and Gaussian Mixture Model.

11. The method of claim 1, wherein the forecast information relates to of one or more of a building electric load forecast and a charging electric load forecast.

12. The method of claim 1, wherein the generating the forecast information further comprises generating one or more error measures.

13. The method of claim 12, wherein the one or more error measures include Mean Absolute Percentage Error for resource variability.

14. The method of claim 12, wherein the one or more error measures include Mean Squared Error for Electric Vehicles charging.

15. The method of claim 1, further comprising monitoring data.

16. The method of claim 15, wherein the monitoring further comprises determining if the data encounters errors.

17. The method of claim 15, wherein the monitoring further comprises transmitting alerts if the data encounters errors.

18. The method of claim 1, further comprising using Support Vector Machine Regression to identify resource spikes.

19. A system for determining forecast information for a resource, the system comprising:
a database to store data related to the resource,
a memory, coupled to the database, and at least one processor that accesses the memory, the memory having instructions which when executed, perform a method comprising:
receiving the data related to the resource;
defining one or more predictor variables from at least a portion of the data;
generating the forecast information, including:
generating one or more optimized learning model parameters based at least in part on the one or more predictor variables;
using one or more forecasting models to generate the forecast information based at least in part on the one or more optimized learning model parameters; and
identifying one or more actions based at least in part on the forecast information; and
a dynamic scheduler, coupled to the memory, configured to receive the forecast information and the one or more actions.

20. The system of claim 19, wherein the database comprises a historical and relational database.

21. The system of claim 19, wherein the system is coupled to an optimizer.

22. A method for determining forecast information for a resource, comprising:
receiving data related to the resource;
generating the forecast information using an error weighted ensemble method, including
determining the forecast information based at least in part on one or more forecasting models and the data; and
identifying one or more actions based at least in part on the forecast information.

23. The method of claim 22, wherein the generating the forecast information further comprises clustering the data into one or more clusters using a clustering model.

24. The method of claim 23, wherein the clustering model includes one or more of Gaussian Mixture Model and Support Vector Machine Regression Model.

25. The method of claim 22, wherein the determining the forecast information further comprises assigning one or more weights to each of the one or more forecasting models.

26. The method of claim 22, wherein the determining the forecast information further comprises assigning votes to each of the one or more forecasting models.

27. The method of claim 22, wherein the one or more forecasting models include one or more of Support Vector Machine Regression model, a Hidden Markov Model (HMM) and a Gradient Boosted Regression Trees model.

28. The method of claim 22, wherein the one or more forecasting models include one or more of Viterbi states as covariates.

29. The method of claim 22, further comprising determining one or more latent states from the one or more forecasting models.

30. The method of claim 29, further comprising generating training data using the one or more latent states.
